(19) United States
(12) Patent Application Publication
(10) Pub. No.: US 2026/0334506 A1
(43) Pub. Date: Oct. 29, 2026

(54) DAIRY PRODUCT AND PROCESS

(71) Applicant: FONTERRA CO-OPERATIVE GROUP LIMITED, Auckland (NZ)

(72) Inventors: Esra Cakir-Fuller, Palmerston North (NZ); Chih-Chieh Chuang, Palmerston North (NZ); Abbas Mehrabadi, Palmerston North (NZ); Mark Pritchard, Palmerston North (NZ); David Francis Elgar, Palmerston North (NZ)

(21) Appl. No.: 19/147,805

(22) PCT Filed: Feb. 20, 2024
(86) PCT No.: PCT/IB2024/051582

§ 371 Date: Jul. 14, 2025

(30) Foreign Application Priority Data
Feb. 22, 2023 (AU) 2023900455
Oct. 27, 2023 (AU) 2023903437

(51) Int. Cl. A23J 3/10; A23C 9/13; A23L 2/66

(52) U.S. Cl. CPC A23J 3/10; A23C 9/1307; A23L 2/66

(57) ABSTRACT

The present invention relates to heat stable protein compositions comprising whey protein and casein, and methods for producing such heat stable protein compositions. The present invention also relates to nutritional compositions comprising the heat stable protein compositions, and methods for producing nutritional compositions.

### FIELD OF THE INVENTION

This invention relates to heat stable protein compositions comprising whey protein and casein, and methods for producing such heat stable protein compositions. This invention also relates to nutritional compositions comprising the heat stable protein compositions, methods of producing such nutritional compositions, and methods for providing nutrition to a subject in need thereof.

The heat stable protein compositions described herein are resistant to sedimentation and heat-induced coagulation or gelation. The protein particles comprised therein show minimal changes in size upon heat treatment and/or storage. The compositions described herein are therefore particularly useful in high protein shelf-stable beverages that are heat-treated and stored for extended time periods.

### BACKGROUND TO THE INVENTION

High-protein foods and beverages can be made using an ingredient with a high-protein content. Desirable properties of an ingredient with high-protein content include heat-stability to allow for subsequent heat treatment to ensure product safety and extended shelf life such as retort or ultra-high temperature (UHT) processing, and for beverage applications in particular, suspendability with minimal or essentially no sedimentation.

Microparticulated whey protein concentrate (WPC) ingredients have been known and used by the food industry to increase the protein content of various applications including cultured and ready-to-drink beverages, and food products, including bars and set or stirred yoghurts.

Microparticulation of whey proteins is an advanced technology for the production of whey protein particles. The size of the whey protein particles is important in delivering the desired mouthfeel; particles from 0.1 to 3 μm provide a creamy mouthfeel, whereas particles >3 μm cause a powdery and even gritty sensation and particles having a size of 0.1 μm create a watery mouthfeel. In fact, particle sizes in the range of less than 0.1 μm are known to contribute a greasy taste which is objectionable if it is perceived as the dominant tactile characteristic.

The principal mechanism of the formation of whey protein particles involves two steps: first, the whey proteins unfold (denature) during heating; and second, the unfolded protein molecules aggregate primarily via disulfide bonds and hydrophobic interactions. Processing conditions, such as temperature, heating time, pH, and shear stress determine the reaction kinetics as well as physical and chemical properties of the particles.

Traditional microparticulation processes incorporate shear or turbulent flow to limit the size of the whey protein particles. However, where high whey protein concentrations are used to manufacture the protein particles, the microparticulation/aggregation reaction occurs very rapidly likely due to the high molecule (protein) density and high collision efficiency. Although these technologies are effective in preventing the formation of very large microparticulates/aggregates, the mean size of the protein particles created during the traditional microparticulation process ranges from 1 micrometre to 10 micrometres with most of the particles having a diameter greater than 1 micrometre. This particle size range is still prone to cause sedimentation or precipitation in liquid applications over the shelf life of the product, particularly in low viscosity liquid applications. They may also have an unwanted gritty texture due to the presence of larger particles. Existing compositions can also show low heat stability, particularly at high protein concentrations, which can make these products unsuitable for high-protein UHT treated or retorted food/beverage products. For example, existing compositions can be prone to increases in particle size, increases in viscosity, or gelation following UHT or retort treatment. Moreover, reduction of the protein particle sizes while ensuring all unfolded proteins form into a stable microparticles has not been achievable.

Various methods of preparing microparticulated denatured whey protein compositions are known in the art. For example, McCarthy (U.S. Pat. No. 5,350,590) prepared “loosely bound” agglomerates comprising whey protein and casein generally having volume mean particle diameters of about 3.0 to about 15 microns. McCarthy reported that these agglomerates are relatively loosely formed and “can be easily broken into the smaller, more organoleptically-efficient particle sizes . . . with only usual dairy processing, e.g. homogenization.”.

There remains a need for protein compositions with suitable organoleptic properties (i.e. no gritty or powdery mouthfeel), that are stable when exposed to secondary heat treatment, particularly compositions that exhibit substantially no gelation and/or substantially no change in particle size distribution upon exposure to secondary heat treatment (particularly for UHT or retorted food/beverage products), and/or compositions that show low or no sedimentation in low viscosity beverages.

It is an object of the present invention to provide improved or alternative heat stable protein compositions, methods for their preparation, nutritional compositions comprising them, and/or methods for preparing nutritional compositions, or to at least provide the public with a useful choice.

Other objects of the invention may become apparent from the following description which is given by way of example only.

In this specification, where reference has been made to external sources of information, including patent specifications and other documents, this is generally for the purpose of providing a context for discussing the features of the present invention. Unless stated otherwise, reference to such sources of information is not to be construed, in any jurisdiction, as an admission that such sources of information are prior art or form part of the common general knowledge in the art.

### SUMMARY OF THE INVENTION

In a first aspect, the invention provides a heat stable protein composition comprising whey protein and casein, wherein the composition comprises β-lactoglobulin and casein in a weight ratio of from about 1.6:1 to about 5:1, the whey protein comprises denaturable whey protein of which at least about 65% (w/w) is denatured, at least about 40% (w/w) of total β-lactoglobulin in the composition is covalently aggregated, and the composition comprises protein particles, wherein at least 40% by volume of the protein particles have a particle size of less than 1 μm, and at least a portion of the protein particles comprise co-aggregates of denatured whey protein and casein.

In a second aspect, the invention provides a method for preparing a heat stable protein composition, the method comprising:
a. providing an aqueous composition having a pH of from 5.5 to 6.8, comprising
   i. a total whey protein content of at least about 18 g/100 g of the aqueous composition,
   ii. a β-lactoglobulin content of at least about 9 g/100 g of the aqueous composition,
   iii. a total protein content of at least about 20 g/100 g of the aqueous composition, and
   iv. β-lactoglobulin and casein in a weight ratio from about 1.6:1 to about 5:1, and
b. heat treating the aqueous composition to at least about 70 °C, for a time sufficient to allow protein denaturation to occur; the heat-treating comprising heating the aqueous composition under high shear stress to provide the heat stable protein composition.

In a third aspect, the invention provides a method for preparing a heat stable protein composition, the method comprising:
a. contacting a whey protein source with an oxidising agent in combination with a catalyst, such as an enzymatic catalyst or a chemical catalyst, preferably a peroxidase enzyme,
b. contacting the whey protein source and a casein protein source to provide an aqueous composition having a pH of from 5.5 to 6.8, comprising
   i. a total whey protein content of at least about 14 g/100 g of the aqueous composition,
   ii. a total β-lactoglobulin content of at least about 4 g/100 g of the aqueous composition,
   iii. a total protein content of at least about 15 g/100 g of the aqueous composition, and
   iv. β-lactoglobulin and casein in a weight ratio from about 1.6:1 to about 5:1, and
c. heat treating the aqueous composition to at least about 70 °C, for a time sufficient to allow protein denaturation to occur; the heat-treating comprising heating the aqueous composition under high shear stress to provide the heat stable protein composition.

In a fourth aspect, the invention provides a method for preparing a heat stable protein composition, the method comprising:
a. providing an aqueous composition having a pH of from 5.5 to 6.8, comprising
   i. a total whey protein content of at least about 14 g/100 g of the aqueous composition,
   ii. a β-lactoglobulin content of at least about 4 g/100 g of the aqueous composition,
   iii. a total protein content of at least about 15 g/100 g of the aqueous composition, and
   iv. β-lactoglobulin and casein in a weight ratio from about 1.6:1 to about 5:1,
b. contacting the aqueous composition with an oxidising agent in combination with a catalyst, such as an enzymatic catalyst or a chemical catalyst, preferably a peroxidase enzyme, and
c. heat treating the aqueous composition to at least about 70 °C, for a time sufficient to allow protein denaturation to occur; the heat-treating comprising heating the aqueous composition under high shear stress to provide the heat stable protein composition.

In a fifth aspect, the invention provides a heat stable protein composition produced by the method of the second, third, or fourth aspects.

In a sixth aspect, the invention provides a nutritional composition comprising the heat stable protein composition of the first or fifth aspects.

In a seventh aspect, the invention provides a liquid composition comprising the heat stable protein composition of the first or fifth aspects.

In a eighth aspect, the invention provides a sterilised and/or pasteurised, shelf-stable liquid nutritional composition comprising the heat stable protein composition of the first or fifth aspects.

In a ninth aspect, the invention provides a food product comprising the heat stable protein composition of the first or fifth aspects.

In a further aspect, the invention provides use of the heat stable protein composition of the first or fifth aspects in the preparation of a nutritional composition.

In a further aspect, the invention provides a method for providing nutrition to a subject in need thereof, the method comprising administering to the subject the nutritional composition, liquid composition, sterilised and/or pasteurised shelf-stable liquid nutritional composition, and/or food product of any one of the sixth to ninth aspects.

In a further aspect, the invention provides a method for preparing a nutritional composition, the method comprising contacting:
a. a heat stable protein composition of the first or fifth aspects, and
b. one or more additional ingredients.

In a further aspect, the invention provides a method for preparing a liquid composition, the method comprising contacting:
a. a heat stable protein composition of the first or fifth aspects, and
b. one or more additional ingredients.

The following embodiments and preferences may relate alone or in any combination of any two or more to any of the above aspects.

In some embodiments, the casein comprises, consists essentially of, or consists of, non-micellar casein. In some embodiments, the composition comprises β-lactoglobulin and non-micellar casein in a weight ratio of from about 1.6:1 to about 5:1. In some embodiments, at least a portion of the protein particles comprise co-aggregates of denatured whey protein and non-micellar casein. In some embodiments, the composition comprises β-lactoglobulin and non-micellar casein in a weight ratio of from about 1.6:1 to about 5:1, and at least a portion of the protein particles comprise co-aggregates of denatured whey protein and non-micellar casein.

In some embodiments, at least about 40% by volume of the protein particles have a particle size of less than 1 μm, such as at least about 45%, at least about 50%, at least about 55%, at least about 60%, at least about 65%, at least about 70%, at least about 75%, at least about 80%, at least about 85%, at least about 90%, at least about 95%, or about 100%, and useful ranges may be selected between any of these values (for example, from about 40% to about 100%, from about 40% to about 95%, from about 40% to about 90%, from about 40% to about 85%, from about 40% to about 80%, from about 45% to about 100%, from about 45% to about 95%, from about 45% to about 90%, from about 45% to about 85%, from about 45% to about 80%, from about 50% to about 100%, from about 50% to about 95%, from about 50% to about 90%, from about 50% to about 85%, or from about 50% to about 80%).

In some embodiments, at least about 40% by volume of the protein particles have a particle size of from 0.1 to 1 μm, such as at least about 45%, at least about 50%, at least about 55%, at least about 60%, at least about 65%, at least about 70%, at least about 75%, at least about 80%, at least about 85%, at least about 90%, at least about 95%, or about 100%, and useful ranges may be selected between any of these values (for example, from about 40% to about 100%, from about 40% to about 95%, from about 40% to about 90%, from about 40% to about 85%, from about 40% to about 80%, from about 45% to about 100%, from about 45% to about 95%, from about 45% to about 90%, from about 45% to about 85%, from about 45% to about 80%, from about 50% to about 100%, from about 50% to about 95%, from about 50% to about 90%, from about 50% to about 85%, or from about 50% to about 80%).

In some embodiments, less than about 55% by volume of the protein particles have a particle size of from 1 to 5 μm, such as less than about 50%, less than about 45%, less than about 40%, less than about 35%, less than about 30%, or less than about 25%, and useful ranges may be selected from between any of these values (for example, from 25% to 55%, from 25% to 50%, from 25% to 45%, from 25% to 40%, from 25% to 35%, from 25% to 30%, from 30% to 55%, from 35% to 55%, from 40% to 55%, or from 45% to 55%).

In some embodiments, less than about 5% by volume of the protein particles have a particle size of at least 5 μm, such as less than about 4%, less than about 3%, less than about 2%, less than about 1%, or about 0%, and useful ranges may be selected from between any of these values (for example, from 0% to 5%, from 0% to 4%, from 0% to 3%, from 0% to 2%, or from 0% to 1%).

In some embodiments, at least about 65% (w/w) of the denaturable whey protein is denatured, such as at least about 70%, at least about 75%, at least about 80%, at least about 85%, at least about 90%, at least about 95%, or about 100% (w/w), and useful ranges may be selected between any of these values (for example, from 65% to 100%, from 65% to 95%, from 65% to 90%, from 70% to 100%, from 70% to 95%, from 70% to 90%, from 75% to 100%, from 75% to 95%, from 75% to 90%, from 80% to 100%, from 80% to 95%, from 80% to 90%, from 85% to 100%, from 85% to 95%, from 85% to 90%, from 90% to 100%, or from 90% to 95%).

In some embodiments, at least about 40% (w/w) of total β-lactoglobulin in the composition is covalently aggregated, such as at least about 45%, 50%, 55%, 60%, 65%, 70%, 75%, or at least about 80%, and useful ranges may be selected between any of these values (for example, from 40% to 80%, from 50% to 80%, from 60% to 80%, from 70% to 80%, from 40% to 70%, from 50% to 70%, from 60% to 70%, or from 55% to 65%).

In some embodiments, the composition comprises total whey protein and casein in a weight ratio of at least about 3:1, such as at least about 4:1, at least about 4.1:1, at least about 4.2:1, at least about 4.3:1, at least about 4.4:1, at least about 4.5:1, at least about 5:1, at least about 5.5:1, at least about 6:1, at least about 7:1, at least about 8:1, at least about 9:1, or about 10:1, and useful ranges may be selected between any of these values (for example, from 3:1 to 10:1, from 3:1 to 9:1, from 3:1 to 8:1, from 3:1 to 7:1, from 3:1 to 6:1, from 3:1 to 5:1, from 4:1 to 10:1, from 4:1 to 9:1, from 4:1 to 8:1, from 4:1 to 7:1, from 4:1 to 6:1, from 4:1 to 5:1, from 4.5:1 to 10:1, from 4.5:1 to 9:1, from 4.5:1 to 8:1, from 4.5:1 to 7:1, from 4.5:1 to 6:1, from 4.5:1 to 5:1, from 5:1 to 10:1, from 5:1 to 9:1, from 5:1 to 8:1, from 5:1 to 7:1, or from 5:1 to 6:1).

In some embodiments, at least about 70% w/w of total protein in the composition is whey protein, such as at least about 75%, 80%, 85%, or at least about 90%, and useful ranges may be selected between any of these values (for example, from 50% to 90%, from 60% to 90%, from 70% to 90%, from 75% to 90%, or from 80% to 90%).

In some embodiments, at least about 35% w/w of total protein in the composition is β-lactoglobulin, such as at least about 36%, 37%, 38%, 39%, 40%, 42%, 44%, 46%, 48%, 50%, 52%, 54%, 56%, 58%, or at least about 60%, and useful ranges may be selected between any of these values (for example, from 35% to 60%, from 35% to 56%, from 35% to 52%, from 35% to 50%, from 38% to 60%, from 38% to 56%, from 38% to 50%, from 40% to 60%, from 40% to 56%, from 40% to 54%, from 40% to 52%, or from 40% to 50%).

In some embodiments, less than about 30% w/w of total protein in the composition is casein, such as less than about 25%, 20%, 15%, or less than about 10%, and useful ranges may be selected between any of these values (for example, from 10% to 30%, from 10% to 25%, from 10% to 20%, from 10% to 15%, from 15% to 30%, from 15% to 25%, or from 15% to 20%).

In some embodiments, from about 80% to about 90% w/w of total protein in the composition is whey protein, and from about 10% to about 20% w/w of total protein in the composition is casein.

In some embodiments, the composition comprises β-lactoglobulin and casein in a weight ratio of at least about 1.6:1, such as at least about 1.8:1, at least about 2:1, at least about 2.2:1, at least about 2.4:1, at least about 2.6:1, at least about 2.8:1, at least about 3:1, at least about 3.2:1, at least about 3.4:1, at least about 3.6:1, at least about 3.8:1, at least about 4:1, at least about 4.2:1, at least about 4.4:1, at least about 4.6:1, at least about 4.8:1, or at least about 5:1, and useful ranges may be selected between any of these values (for example, from 1.6:1 to 5:1, from 1.6:1 to 4:1, from 1.6:1 to 3.5:1, from 1.6:1 to 3:1, from 1.8:1 to 5:1, from 1.8:1 to 4:1, from 1.8:1 to 3.5:1, from 1.8:1 to 3:1, from 2:1 to 5:1, from 2:1 to 4:1, from 2:1 to 3.5:1, from 2:1 to 3:1, from 2.2:1 to 5:1, from 2.2:1 to 4:1, from 2.2:1 to 3.5:1, from 2.2:1 to 3:1, from 2.4:1 to 5:1, from 2.4:1 to 4:1, from 2.4:1 to 3.5:1, from 2.4:1 to 3:1, from 2.6:1 to 5:1, from 2.6:1 to 4:1, from 2.6:1 to 3.5:1, or from 2.6:1 to 3:1).

In some embodiments, an aqueous composition comprising an amount of the heat stable protein composition sufficient to provide a total protein content of 15% w/w, and that has been subjected to a secondary heat treatment at 120 °C for 4 minutes, comprises protein particles of which at least about 40% by volume have a particle size of from 0.1 to 1 μm, such as at least about 41%, at least about 42%, at least about 43%, at least about 44%, at least about 45%, at least about 46%, at least about 47%, at least about 48%, at least about 49%, at least about 50%, at least about 51%, at least about 52%, or at least about 53%, and useful ranges may be selected between any of these values (for example, from 40% to 53%, from 40% to 52%, from 40% to 51%, from 40% to 50%, from 41% to 53%, from 41% to 52%, from 41% to 51%, from 41% to 50%, from 42% to 53%, from 42% to 52%, from 42% to 51%, from 42% to 50%, from 43% to 53%, from 43% to 52%, from 43% to 51%, from 43% to 50%, from 44% to 53%, from 44% to 52%, from 44% to 51%, from 44% to 50%, from 45% to 53%, from 45% to 52%, from 45% to 51%, from 45% to 50%, from 46% to 53%, from 46% to 52%, from 46% to 51%, from 46% to 50%, from 47% to 53%, from 47% to 52%, from 47% to 51%, from 47% to 50%, from 48% to 53%, from 48% to 52%, from 48% to 51%, from 48% to 50%, from 49% to 53%, from 49% to 52%, from 49% to 51%, from 49% to 50%, from 50% to 53%, from 50% to 52%, or from 50% to 51%).

In some embodiments, an aqueous composition comprising an amount of the heat stable protein composition sufficient to provide a total protein content of 15% w/w, and that has been subjected to a secondary heat treatment at 120 °C for 4 minutes, comprises protein particles of which less than about 60% by volume of the protein particles have a particle size of from 1 to 5 μm, such as less than about 58%, less than about 56%, less than about 55%, less than about 54%, less than about 52%, less than about 50%, less than about 48%, less than about 46%, less than about 44%, less than about 42%, or less than about 40%, and useful ranges may be selected between any of these values (for example, from 40% to 60%, from 40% to 58%, from 40% to 56%, from 40% to 54%, from 44% to 60%, from 44% to 58%, from 44% to 56%, from 44% to 54%, from 46% to 60%, from 46% to 58%, from 46% to 56%, from 46% to 54%, from 48% to 60%, from 48% to 58%, from 48% to 56%, or from 48% to 54%).

In some embodiments, an aqueous composition comprising an amount of the heat stable protein composition sufficient to provide a total protein content of 15% w/w, and that has been subjected to a secondary heat treatment at 120 °C for 4 minutes, comprises protein particles of which less than about 10% by volume of the protein particles have a particle size of at least 5 μm, such as less than about 9%, less than about 8%, less than about 7%, less than about 6%, less than about 5%, less than about 4%, less than about 3%, less than about 2%, less than about 1%, or about 0%, and useful ranges may be selected between any of these values (for example, from about 0% to about 10%, from about 0% to about 9%, from about 0% to about 8%, from about 0% to about 7%, from about 0% to about 6%, from about 0% to about 5%, from 0% about to about 4%, from about 0% to about 3%, from about 0% to about 2%, from about 0% to about 1%, from about 1% to about 10%, from about 1% to about 9%, from about 1% to about 8%, from about 1% to about 7%, from about 1% to about 6%, from about 1% to about 5%, from about 1% to about 4%, from about 1% to about 3%, from about 2% to about 10%, from about 2% to about 9%, from about 2% to about 8%, from about 2% to about 7%, from about 2% to about 6%, from about 2% to about 5%, from about 2% to about 4%, or from about 2% to about 3%).

In some embodiments, an aqueous composition comprising an amount of the heat stable protein composition sufficient to provide a total protein content of 15% w/w, and that has been subjected to a secondary heat treatment at 120 °C for 4 minutes, comprises protein particles of which the D [4,3] is less than about 5, such as less than about 4, less than about 3, less than about 2, less than about 1.8, less than about 1.6, less than about 1.4, less than about 1.2, less than about 1.0, or about 0.9, and useful ranges may be selected between any of these values (for example, from about 0.9 to about 5, from about 0.9 to about 4, from about 0.9 to about 3, from about 0.9 to about 2, from about 0.9 to about 1.8, from about 0.9 to about 1.6, from about 0.9 to about 1.4, from about 0.9 to about 1.2, or from about 0.9 to about 1.0).

In some embodiments, an aqueous composition comprising an amount of the heat stable protein composition sufficient to provide a total protein content of 15% w/w, and that has been subjected to a secondary heat treatment at 120 °C for 4 minutes, has a viscosity of less than about 100 mPa·s at 100 s⁻¹, such as less than about 90 mPa·s, less than about 80 mPa·s, less than about 70 mPa·s, less than about 60 mPa·s, less than about 50 mPa·s, less than about 40 mPa·s, less than about 30 mPa·s, less than about 20 mPa·s, less than about 10 mPa·s, or less than about 5 mPa·s, and useful ranges may be selected between any of these values (for example, from 5 to 100 mPa·s, from 5 to 80 mPa·s, from 5 to 70 mPa·s, from 5 to 60 mPa·s, from 5 to 50 mPa·s, from 5 to 40 mPa·s, from 5 to 30 mPa·s, from 10 to 100 mPa·s, from 10 to 80 mPa·s, from 10 to 70 mPa·s, from 10 to 60 mPa·s, from 10 to 50 mPa·s, from 10 to 40 mPa·s, or from 10 to 30 mPa·s).

In some embodiments, the method comprises contacting a whey protein source and a casein protein source to provide the aqueous composition of step a).

In some embodiments, the whey protein source comprises, or consists of, a whey protein concentrate (WPC), a whey protein isolate (WPI), or a combination thereof.

In some embodiments, the casein protein source comprises, consists essentially of, or consists of non-micellar casein or casein-calcium-sodium/potassium-phosphate complexes. In some embodiments, the casein protein source comprises, or consists of, a caseinate, a β-casein enriched fraction, a κ-casein enriched fraction, a calcium-depleted milk protein concentrate (MPC), a calcium-depleted micellar casein concentrate (MCC), a total milk protein (TMP), or a combination of any two or more of these. In some embodiments, the casein protein source comprises, or consists of, a caseinate. In some embodiments, the casein protein source comprises, or consists of, calcium-depleted milk protein concentrate (MPC).

In some embodiments, the method further comprises contacting the whey protein source with an oxidising agent in combination with a catalyst, such as an enzymatic catalyst or a chemical catalyst, preferably a peroxidase enzyme, and preferably prior to step a).

In some embodiments, the method further comprises contacting the aqueous composition with an oxidising agent in combination with a catalyst, such as an enzymatic catalyst or a chemical catalyst, preferably a peroxidase enzyme, and preferably prior to step b).

In some embodiments, the catalyst is an enzymatic catalyst, for example a microbial peroxidase enzyme such as MaxiBright® (DSM Food Specialties), or a dye-decolorising (DyP-type) peroxidase such as EfeB/YcdB from Escherichia coli O157, DyPB from Rhodococcus jostii RHA1, or DyP2 from Amycolatopsis sp. 75iv2. In some embodiments, the catalyst is a chemical catalyst such as copper, iron, zinc, or manganese.

In some embodiments, the oxidising agent is hydrogen peroxide or benzoyl peroxide and/or the catalyst is a peroxidase enzyme.

In some embodiments, the oxidising agent is any food grade oxidising agent. In some embodiments, the oxidising agent is oxygen (O₂), ozone, a peroxide including an alkyl hydroperoxide, superoxide, peroxynitrite, peroxydisulfuric acid, or lactoperoxidase.

In some embodiments, the oxidising agent is a peroxide, preferably an organic peroxide. In some embodiments, the peroxide is a metal peroxide (e.g., an alkali metal peroxide such as sodium peroxide; an alkaline earth metal peroxide such as magnesium peroxide, or calcium peroxide; or a transition metal peroxide such as zinc peroxide), hydrogen peroxide, or benzoyl peroxide. In some embodiments, the oxidising agent is a perborate such as sodium perborate.

In some such embodiments, the oxidising agent is benzoyl peroxide or hydrogen peroxide. In some embodiments, the hydrogen peroxide is food grade.

In some embodiments, the oxidising agent is present in an amount less than 300 ppm or less than 200 ppm, or the mole ratio of the oxidising agent to β-lactoglobulin is less than 2, preferably less than 1, or from about 0.1 to about 0.85.

In some embodiments, the aqueous composition comprises α total whey protein content of at least about 14 g/100 g of the aqueous composition, such as at least about 15, 16, 17, or at least about 18 g/100 g.

In some embodiments, the aqueous composition comprises a total β-lactoglobulin content of content of at least about 4 g/100 g of the aqueous composition, such as at least about 5, 6, 7, 8, or at least about 9 g/100 g.

In some embodiments, the aqueous composition comprises a total protein content of at least about 15 g/100 g of the aqueous composition, such as at least about 16, 17, 18, 19, or at least about 20 g/100 g.

In some embodiments, the whey protein source and/or the casein protein source are in the form of a powder. In some embodiments, the method comprises reconstituting the powder(s) to provide the aqueous composition.

In some embodiments, the method further comprises homogenising the aqueous composition, preferably at about 200/50 bar. In some embodiments, the method comprises homogenising the aqueous composition prior to step b), preferably at about 200/50 bar.

In some embodiments, the method further comprises adjusting the pH of the aqueous composition to a pH of from 5.5 to 6.8.

In some embodiments, the method further comprises concentrating the aqueous composition prior to step b), preferably by evaporation.

In some embodiments, the whey protein comprises denaturable whey protein, and step b) comprises heat-treating the aqueous composition for a time sufficient to allow at least about 65% (w/w) of the denaturable whey protein in the aqueous composition to denature, such as at least about 70%, at least about 75%, at least about 80%, at least about 85%, at least about 90%, at least about 95%, or about 100% (w/w), and useful ranges may be selected between any of these values (for example, from 65% to 100%, from 65% to 95%, from 65% to 90%, from 70% to 100%, from 70% to 95%, from 70% to 90%, from 75% to 100%, from 75% to 95%, from 75% to 90%, from 80% to 100%, from 80% to 95%, from 80% to 90%, from 85% to 100%, from 85% to 95%, from 85% to 90%, from 90% to 100%, or from 90% to 95%).

In some embodiments, less than about 10% (w/w) of total denaturable whey protein in the aqueous composition prior to step b) is denatured, preferably less than about 9%, less than about 8%, less than about 7%, less than about 6%, less than about 5%, less than about 4%, less than about 3%, less than about 2%, or less than about 1%, and useful ranges may be selected between any of these values (for example, from 1% to 10%, from 1% to 8%, from 1% to 5%, or from 1% to 4%).

In some embodiments, the heat stable protein composition comprises protein particles, of which at least about 40% by volume have a particle size of less than 1 μm, such as at least about 45%, at least about 50%, at least about 55%, at least about 60%, at least about 65%, at least about 70%, at least about 75%, at least about 80%, at least about 85%, at least about 90%, at least about 95%, or about 100%, and useful ranges may be selected between any of these values (for example, from about 40% to about 100%, from about 40% to about 95%, from about 40% to about 90%, from about 40% to about 85%, from about 40% to about 80%, from about 45% to about 100%, from about 45% to about 95%, from about 45% to about 90%, from about 45% to about 85%, from about 45% to about 80%, from about 50% to about 100%, from about 50% to about 95%, from about 50% to about 90%, from about 50% to about 85%, or from about 50% to about 80%).

In some embodiments, step b) comprises heat treating the aqueous solution to a temperature of from about 70 °C to about 150 °C.

In some embodiments, the heat stable protein composition comprises at least about 70% w/w whey protein relative to total protein in the composition, preferably from about 70% to about 90% w/w. In some embodiments, the heat stable protein composition comprises at least about 80% w/w whey protein relative to total protein in the composition, preferably from about 80% to about 90% w/w. In some embodiments, the heat stable protein composition comprises at least about 35% w/w β-lactoglobulin relative to total protein in the composition, preferably from about 40% to about 60% w/w. In some embodiments, the heat stable protein composition comprises less than about 30% w/w casein relative to total protein in the composition, preferably from about 10% to about 20% w/w. In some embodiments, the heat stable protein composition comprises at least about 70% w/w whey protein relative to total protein in the composition, and less than about 30% w/w casein relative to total protein in the composition.

In some embodiments, the method further comprises the step of drying the heat stable protein composition.

In some embodiments, the heat stable protein composition is not subjected to a mechanical shear process prior to drying other than where liquid is converted into droplets to facilitate drying.

In some embodiments, step b) comprises heating the solution:
i. under conditions of turbulent flow with a Reynold's number of at least about 2000,
ii. under conditions of high wall shear with a wall shear rate of at least about 1000 s⁻¹, or
iii. under conditions of mechanical shear, preferably mechanical shear produced by a homogeniser, colloid mill, high pressure pump, scraped surface heat exchanger, and/or a high shear mixer.

In some embodiments, the method produces a heat stable protein composition according to the first aspect.

In some embodiments, the nutritional composition comprises at least about 1%, at least about 2%, at least about 3%, at least about 4%, at least about 5%, at least about 6%, at least about 7%, at least about 8%, at least about 9%, at least about 10%, at least about 11%, at least about 12%, at least about 13%, at least about 14%, at least about 15%, at least about 16%, at least about 17%, at least about 18%, at least about 19%, at least about 20%, at least about 30%, at least about 40%, or at least about 50% by weight total protein on a dry basis, and useful ranges may be selected from between any of these values (for example, from about 1% to about 40%, or from about 1% to about 30%, or from about 1% to about 20%, or about 1% to about 16%, 1% to about 15%, 1% to about 14%, or about 1% to about 12%, or about 1% to about 10%, or from about 2% to about 50%, or from about 2% to about 40%, or from about 2% to about 30%, or about 2% to about 20%, or about 2% to about 16%, 2% to about 15%, 2% to about 14%, or about 2% to about 12%, or about 2% to about 10%, from about 4% to about 50%, or from about 4% to about 40%, or from about 4% to about 30%, or about 4% to about 20%, or about 4% to about 16%, 4% to about 15%, 4% to about 14%, or about 4% to about 12%, or about 4% to about 10%, from about 5% to about 50%, or from about 5% to about 40%, or from about 5% to about 30%, or about 5% to about 20%, or about 5% to about 16%, 5% to about 15%, 5% to about 14%, or about 5% to about 12%, or about 5% to about 10%).

In some embodiments, the nutritional composition comprises at least about 1%, at least about 2%, at least about 3%, at least about 4%, at least about 5%, at least about 6%, at least about 7%, at least about 8%, at least about 9%, at least about 10%, at least about 11%, at least about 12%, at least about 13%, at least about 14%, at least about 15%, at least about 16%, at least about 17%, at least about 18%, at least about 19%, at least about 20%, at least about 30%, at least about 40%, or at least about 50% by weight denatured whey protein on a dry basis, and useful ranges may be selected from between any of these values (for example, from about 1% to about 40%, or from about 1% to about 30%, or from about 1% to about 20%, or about 1% to about 16%, 1% to about 15%, 1% to about 14%, or about 1% to about 12%, or about 1% to about 10%, or from about 2% to about 50%, or from about 2% to about 40%, or from about 2% to about 30%, or about 2% to about 20%, or about 2% to about 16%, 2% to about 15%, 2% to about 14%, or about 2% to about 12%, or about 2% to about 10%, from about 4% to about 50%, or from about 4% to about 40%, or from about 4% to about 30%, or about 4% to about 20%, or about 4% to about 16%, 4% to about 15%, 4% to about 14%, or about 4% to about 12%, or about 4% to about 10%, from about 5% to about 50%, or from about 5% to about 40%, or from about 5% to about 30%, or about 5% to about 20%, or about 5% to about 16%, 5% to about 15%, 5% to about 14%, or about 5% to about 12%, or about 5% to about 10%).

In some embodiments, at least about 50% (w/w) of total protein in the nutritional composition is denatured whey protein, such as at least about 55%, at least about 60%, at least about 65%, at least about 70%, at least about 75%, at least about 80%, at least about 85%, at least about 90%, or at least about 95%, and useful ranges may be selected between any of these values (for example, from 50% to 95%, from 50% to 90%, from 50% to 85%, from 50% to 80%, from 55% to 95%, from 55% to 90%, from 55% to 85%, from 55% to 80%, from 60% to 95%, from 60% to 90%, from 60% to 85%, from 60% to 80%, from 65% to 95%, from 65% to 90%, from 65% to 85%, from 65% to 80%, from 70% to 95%, from 70% to 90%, from 70% to 85%, from 70% to 80%, from 75% to 95%, from 75% to 90%, from 75% to 85%, from 75% to 80%, from 80% to 95%, from 80% to 90%, or from 80% to 85%).

In some embodiments, at least about 50% (w/w) of total protein in the nutritional composition is provided by the heat stable protein composition, such as at least about 55%, at least about 60%, at least about 65%, at least about 70%, at least about 75%, at least about 80%, at least about 85%, at least about 90%, at least about 95%, or about 100%, and useful ranges may be selected between any of these values (for example, from 50% to 100%, from 50% to 95%, from 50% to 90%, from 50% to 85%, from 50% to 80%, from 50% to 75%, from 55% to 100%, from 55% to 95%, from 55% to 90%, from 55% to 85%, from 55% to 80%, from 55% to 75%, from 60% to 100%, from 60% to 95%, from 60% to 90%, from 60% to 85%, from 60% to 80%, from 60% to 75%, from 65% to 100%, from 65% to 95%, from 65% to 90%, from 65% to 85%, from 65% to 80%, from 65% to 75%, from 70% to 100%, from 70% to 95%, from 70% to 90%, from 70% to 85%, from 70% to 80%, from 70% to 75%, from 75% to 100%, from 75% to 95%, from 75% to 90%, from 75% to 85%, or from 75% to 80%).

In some embodiments, at least about 40% by volume of the protein particles in the nutritional composition have a particle size of less than 1 μm, such as at least about 45%, at least about 50%, at least about 55%, at least about 60%, at least about 65%, at least about 70%, at least about 75%, at least about 80%, at least about 85%, at least about 90%, at least about 95%, or about 100%, and useful ranges may be selected between any of these values (for example, from 40% to 100%, from 40% to 95%, from 40% to 90%, from 40% to 85%, from 40% to 80%, from 45% to 100%, from 45% to 95%, from 45% to 90%, from 45% to 85%, from 45% to 80%, from 50% to 100%, from 50% to 95%, from 50% to 90%, from 50% to 85%, or from 50% to 80%).

In some embodiments, at least about 40% by volume of the protein particles in the nutritional composition have a particle size of from 0.1 to 1 μm, such as at least about 45%, at least about 50%, at least about 55%, at least about 60%, at least about 65%, at least about 70%, at least about 75%, at least about 80%, at least about 85%, at least about 90%, at least about 95%, or about 100%, and useful ranges may be selected between any of these values (for example, from 40% to 100%, from 40% to 95%, from 40% to 90%, from 40% to 85%, from 40% to 80%, from 45% to 100%, from 45% to 95%, from 45% to 90%, from 45% to 85%, from 45% to 80%, from 50% to 100%, from 50% to 95%, from 50% to 90%, from 50% to 85%, or from 50% to 80%).

In some embodiments, less than about 60% by volume of the protein particles in the nutritional composition have a particle size of from 1 to 5 μm, such as less than about 55%, less than about 50%, less than about 45%, less than about 40%, less than about 35%, less than about 30%, or less than about 25%, and useful ranges may be selected from between any of these values (for example, from 25% to 60%, from 25% to 55%, from 25% to 50%, from 25% to 45%, from 25% to 40%, from 25% to 35%, from 25% to 30%, from 30% to 60%, from 30% to 55%, from 35% to 55%, from 40% to 55%, or from 45% to 55%).

In some embodiments, less than about 10% by volume of the protein particles in the nutritional composition have a particle size of at least 5 μm, such as less than about 9%, less than about 8%, less than about 7%, less than about 6%, less than about 5% less than about 4%, less than about 3%, less than about 2%, less than about 1%, or about 0%, and useful ranges may be selected from between any of these values (for example, from 0% to 10%, from 0% to 9%, from 0% to 8%, from 0% to 7%, from 0% to 6%, from 0% to 5%, from 0% to 4%, from 0% to 3%, from 0% to 2%, or from 0% to 1%).

In some embodiments, the nutritional composition has been subjected to a secondary heat treatment, preferably sterilisation and/or pasteurisation. In some embodiments, the nutritional composition is sterilised and/or pasteurised. Preferably the sterilised and/or pasteurised nutritional composition shows negligible bacterial growth when packaged aseptically after prolonged storage at a temperature from about 20 °C to about 25 °C for at least 2 months, at least 3 months, at least 6 months, or at least 12 months.

In some embodiments, the nutritional composition is a food product.

In some embodiments, the food product is a baked food product, a bar, a set or stirred yoghurt, a set gel, or a semi-solid food product.

In some embodiments, the food product is a set yoghurt or a stirred yoghurt. In some embodiments, the set yoghurt or stirred yoghurt comprises about 6% to about 20% (w/v) total protein.

In some embodiments, the set yoghurt or stirred yoghurt exhibits reduced volume weighted mean particle size compared to a control yoghurt product having the same ingredient composition and the same total protein content except that the control yoghurt product does not comprise a heat stable protein composition of the first or third aspects.

In some embodiments, the food product is a heat-treated, high protein set gel. In some embodiments, the heat-treated high protein set gel comprises at least about 10% (w/v) or at least about 15% (w/v) total protein.

In some embodiments, the food product is a heat-treated, high protein semi-solid food product. In some embodiments, the heat-treated high protein semi-solid food product comprises at least about 10% (w/v) or at least about 15% (w/v) total protein.

In some embodiments, the food product has a viscosity of less than about 1000 mPa·s, less than about 800 mPa·s, less than about 600 mPa·s, or less than about 400 mPa·s measured at 50 s⁻¹ at 20 °C.

In some embodiments, the nutritional composition is a liquid composition, such as a liquid nutritional composition. In some embodiments, the nutritional composition is a liquid nutritional composition.

In some embodiments, the liquid composition has a viscosity of less than about 400 mPa·s measured at 100 s⁻¹ at 20 °C, such as less than about 350 mPa·s, less than about 300 mPa·s, less than about 250 mPa·s, less than about 200 mPa·s, less than about 150 mPa·s, less than about 100 mPa·s, less than about 90 mPa·s, less than about 80 mPa·s, less than about 70 mPa·s, less than about 60 mPa·s, less than about 50 mPa·s, less than about 40 mPa·s, less than about 30 mPa·s, less than about 20 mPa·s, less than about 10 mPa·s, less than about 8 mPa·s, less than about 6 mPa·s, less than about 5 mPa·s, about 4 mPa·s, about 3 mPa·s, or about 2 mPa·s, and useful ranges may be selected between any of these values (for example, from 2 to 400 mPa·s, from 2 to 300 mPa·s, from 2 to 200 mPa·s, from 2 to 100 mPa·s, from 4 to 400 mPa·s, from 4 to 300 mPa·s, from 4 to 200 mPa·s, from 4 to 100 mPa·s, from 6 to 400 mPa·s, from 6 to 300 mPa·s, from 6 to 200 mPa·s, or from 6 to 100 mPa·s).

In some embodiments, the liquid composition exhibits less than about 10% sedimentation following (a) storage at a temperature of from about 20 °C to about 25 °C for at least 6 weeks; (b) storage at a temperature of from about 20 °C to about 25 °C for at least 3 months; and/or (c) centrifugation at 1540×g for 5 minutes; such as less than about 9%, less than about 8%, less than about 7%, less than about 6%, less than about 5%, less than about 4%, less than about 3%, less than about 2%, less than about 1%, or about 0% sedimentation, and useful ranges may be selected between any of these values (for example, from 0% to 10%, from 0% to 9%, from 0% to 8%, from 0% to 7%, from 0% to 6%, from 0% to 5%, from 1% to 10%, from 1% to 9%, from 1% to 8%, from 1% to 7%, from 1% to 6%, from 1% to 5%, from 2% to 10%, from 2% to 9%, from 2% to 8%, from 2% to 7%, from 2% to 6%, from 2% to 5%, from 3% to 10%, from 3% to 9%, from 3% to 8%, from 3% to 7%, from 3% to 6%, from 3% to 5%, from 4% to 10%, from 4% to 9%, from 4% to 8%, from 4% to 7%, from 4% to 6%, from 4% to 5%, from 5% to 10%, from 5% to 9%, from 5% to 8%, from 5% to 7%, or from 5% to 6% sedimentation).

In some embodiments, the liquid composition further comprises:
a. from about 0.1 to about 30% (w/v) lipid,
b. from about 0.1 to about 40% (w/v) carbohydrate, preferably from about 0.1 to about 30% (w/v) carbohydrate,
c. at least one monovalent cation,
d. at least one divalent metal cation, preferably Ca²⁺, optionally present in an amount of at least about 30 mg/100 mL, at least about 50 mg/100 mL, or at least about 100 mg/100 mL, or
e. any combination of any two or more of (a) to (d).

In some embodiments, the liquid composition comprises at least about 0.1% w/v carbohydrate, such as at least about 1%, 2%, 3%, 4%, 5%, 6%, 7%, 8%, 9%, 10%, 15%, 20%, 25%, 30%, 35%, or at least about 40% w/v, and useful ranges may be selected between any of these values (for example, from about 0.1% to about 40%, from about 0.1% to about 30%, from about 0.1% to about 20%, from about 0.1% to about 10%, from about 1% to about 40%, from about 1% to about 30%, from about 1% to about 20%, from about 1% to about 10%, from about 10% to about 40%, from about 10% to about 30%, from about 10% to about 20%, from about 20% to about 40%, from about 20% to about 30%, or from about 30% to about 40%).

In some embodiments, the liquid composition has an energy density of at least about 0.5 kcal/mL, such as at least about 1.0, at least about 1.5, or at least about 2.0 kcal/mL, and useful ranges may be selected between any of these values (for example, from 0.5 to 2.0 kcal/ml, from 1.0 to 2.0 kcal/mL, from 1.5 to 2.0 kcal/ml, from 0.5 to 1.5 kcal/ml, or from 1.0 to 1.5 kcal/mL).

In some embodiments, the liquid composition is a heat-treated, shelf-stable liquid nutritional composition.

In some embodiments, the liquid composition is a high protein beverage, or a medical food.

In some embodiments, the liquid composition is a drinking yoghurt. In some embodiments, the drinking yoghurt has a viscosity of less than about 400 mPa·s, less than about 300 mPa·s, less than about 200 mPa·s, or less than about 100 mPa·s measured at 50 s⁻¹ at 20 °C, and useful ranges may be selected between any of these values (for example, from 100 to 400 mPa·s, from 100 to 300 mPa·s, or from 100 to 200 mPa·s).

In some embodiments, the liquid composition is an acidic beverage. In some embodiments, the acidic beverage has a pH from about 2 to about 4.8. In some embodiments, the liquid composition is a neutral beverage. In some embodiments, the neutral beverage has a pH from about 6.5 to about 7.5. In some embodiments, the acidic beverage or the neutral beverage has a viscosity of less than about 400 mPa·s, less than about 300 mPa·s, less than about 200 mPa·s, or less than about 100 mPa·s measured at 100 s⁻¹ at 20 °C, and useful ranges may be selected between any of these values (for example, from 100 to 400 mPa·s, from 100 to 300 mPa·s, or from 100 to 200 mPa·s).

In some embodiments, the use of the heat stable protein composition is use in the preparation of a nutritional composition according to the fourth aspect.

In some embodiments, the one or more additional ingredients comprise one or more lipids, one or more carbohydrates, one or more proteins, one or more vitamins, one or more minerals, one or more dairy products, water, one or more food additives, one or more polyols, one or more colours, one or more fruit preparations, or any combination of any two or more of these ingredients.

In some embodiments, the one or more lipids comprise one or more plant lipids and/or one or more dairy lipids.

In some embodiments, the one or more carbohydrates, comprise one or more monosaccharides, disaccharides, oligosaccharides, polysaccharides, or any combination of any two or more of these.

In some embodiments, the one or more additional sources of protein are derived from milk, whey, casein, caseinate, egg, egg white, egg yolk, vegetable, plant, alfalfa, clover, pea, bean, kidney bean, soybean, lentil, lupin, cocoa, carob, nut, peanut, rye, cereal, whole wheat, rice, hemp, wheat gluten, fungal, or algal protein, a protein concentrate thereof, a protein isolate thereof, a hydrolysate thereof, or any combination of any two or more of these.

In some embodiments, the one or more vitamins comprise vitamin C, vitamin A, vitamin E, vitamin B12, vitamin K, riboflavin, niacin, vitamin D, vitamin B6, folic acid, pyridoxine, thiamine, pantothenic acid, biotin, or any salt, derivative, or metabolite thereof, or any combination of any two or more of these.

In some embodiments, the one or more minerals comprise chloride, sodium, calcium, iron, chromium, copper, iodine, zinc, magnesium, phosphorus, or potassium, or any combination of any two or more of these.

In some embodiments, the one or more food additives comprise one or more emulsifiers, preferably lecithins, mono and diglycerides, polyglycerol esters, milk phospholipids, citric acid esters (CITREMs), polysorbate 60, glyceryl monostearate, DATEMs, or any combination of any two or more of these.

In some embodiments, the one or more food additives comprise one or more stabilisers, preferably carrageenan, gellan gum, pectin, guar gum, locust bean gum, carboxymethyl cellulose, alginates, agar, oat gum, tragacanth gum, acacia gum, xanthan gum, karaya gum, tara gum, starch, and modified starch and microcrystalline cellulose, gelatin, or any combination of any two or more of these.

In some embodiments, the nutritional composition, or the liquid composition, is a nutritional composition according to the fourth aspect.

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9, and 10) and also any range of rational numbers within that range (for example, 2 to 8, 1.5 to 5.5, and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

Although the present invention is broadly as defined above, those persons skilled in the art will appreciate that the invention is not limited thereto and that the invention also includes embodiments of which the following description gives examples.

### BRIEF DESCRIPTION OF THE DRAWINGS

The invention will now be described by way of example only and with reference to the drawings in which:

FIG. 1 shows the change in viscosity of an aqueous solution comprising a comparative denatured whey protein composition (sample 4) at 10% total solids, pH 7.0, before heating (crosses), after heating (triangles), and after evaporation to 19% total solids (diamonds), as described in Example 1.

FIG. 2 shows the change in particle size distribution (by volume density) of the aqueous solution shown in FIG. 1 before heating (circles), after heating (squares), after evaporation to 19% total solids (triangles), and after spray-drying to a powder and reconstituting the powder in water at 10% total solids (diamonds), as described in Example 1.

FIG. 3 shows the change in particle size distribution (by volume density) of an embodiment of a heat stable protein composition of the invention (sample 1) at 14% protein, pH 6.8, before heating (circles) and after heating (squares) at 120 °C for 10 minutes, as described in Example 1.

FIG. 4 shows a flow diagram of an embodiment of a process for producing a heat stable protein composition. The whey protein source may comprise a whey retentate, a whey protein powder, or a mixture of these.

FIG. 5 shows a flow diagram of an embodiment of a process for producing a liquid nutritional composition comprising a heat stable protein composition.

### DETAILED DESCRIPTION OF THE INVENTION

The present invention relates to heat stable protein compositions comprising protein particles that contain both whey and casein proteins. The protein particles are of a size that is resistant to sedimentation and provides good mouthfeel (i.e. no grittiness or powderiness). After manufacture, the protein particles do not require additional mechanical shear to further break them down to a desirable size, and are resistant to being broken down. The protein particles also show minimal changes in size upon heat treatment and/or storage. The protein compositions are resistant to heat-induced coagulation or gelation. The protein compositions also have a favourable flavour profile, for example a reduction in “eggy” flavour and an increase in “milky” flavour compared to all-whey compositions.

### 1. DEFINITIONS

Unless otherwise stated, the singular forms “a,” “an,” and “the” include the plural reference.

The term “about” as used herein generally refers to a range of numerical values (e.g. #5 to 10% of the recited value) that those skilled in the art would consider equivalent to the recited value. Ranges can be expressed herein as from “about” one particular value, and/or to “about” another particular value. When such a range is expressed, the range is inclusive of the recited values.

As used herein the term “and/or” means “and” or “or”, or both.

The phrase “calcium depleted” is used herein to refer to a composition, such as a milk protein concentrate (MPC), in which the concentration of calcium bound to casein has been reduced and is lower than the concentration of calcium bound to casein in the corresponding non-depleted composition. Such a composition may also be depleted in other divalent cations, and so have a lower concentration of divalent cations bound to casein, for example, magnesium, than the corresponding non-depleted composition. Similarly, reference to calcium in casein protein is a reference to bound calcium—that is, calcium bound by the casein protein.

The term “co-aggregates of denatured whey protein and casein” as used herein refers to aggregates that comprise both denatured whey protein and casein.

The term “comprising” as used in this specification means “consisting at least in part of”. When interpreting statements in this specification which include that term, the features, prefaced by that term in each statement, all need to be present but other features can also be present. Related terms such as “comprise” and “comprised” are to be interpreted in the same manner.

The term “casein” as used herein includes α(s1) and α(s2)-caseins, β-casein, kappa-casein and mixtures thereof and also includes caseinates such as sodium caseinate, calcium caseinate, magnesium caseinate, potassium caseinate, and ammonium caseinate.

The term “caseinate” refers to a chemical compound of casein and a metal ion produced by acid precipitation of casein followed by resolubilisation with alkali comprising the metal ion. Hydroxide solutions comprising sodium, calcium, magnesium, potassium, or ammonium may be used to produce sodium caseinate, calcium caseinate, magnesium caseinate, potassium caseinate or ammonium caseinate. A description of caseinates and methods of producing caseinates suitable for use herein are described in Fox & McSweeney, 2003 and the Dairy Processing Handbook, 2003.

The term “covalently aggregated” and related terms such as “covalent aggregates” as used herein refers to denatured β-lactoglobulin molecules that contain at least one intermolecular covalent bond to another protein molecule. One example of such covalent bonds is a disulphide bond formed between two sulfhydryl groups, such as those in the sidechains of two cysteine amino acids.

The term “denaturable whey protein” as used herein refers to the sum of whey proteins capable of being denatured. Certain whey protein sources such as cheese whey may contain proteins such as glycomacropeptide (GMP) and proteose peptone 5 (pp5), which are casein-related proteins. Heat treatment results in denaturation of bovine serum albumin (BSA), α-lactalbumin, β-lactoglobulin, lactoferrin, immunoglobulins. In contrast, GMP and pp5 are non-denaturable. The term “denaturable whey protein” therefore excludes GMP and pp5. The total denaturable whey protein may be calculated as described in section 1.1 of example 1.

The term “dry weight basis” as used herein refers to the percentage of the substance in the composition or product after removing the moisture in the product. This can be calculated by applying a correction to allow for the retained moisture in the product.

The term “heat stable” as used herein refers to compositions that are resistant to undesirable changes upon secondary heat treatment, such as increased viscosity, gelation, and/or a change in particle size distribution. Heat stability is typically assessed as described in section 7. Compositions that are not heat stable may gel or show an increase in viscosity when subjected to secondary heat treatment, and may show an increase in particle size distribution (for example, an increase in the proportion of particles with a particle size of at least 5 μm, an increase in the proportion of particles with a particle size of 1 to 5 μm, and/or a decrease in the proportion of particles with a particle size of 0.1 to 1 μm). In some embodiments, heat stable compositions show minimal or essentially no gelation, do not substantially increase in viscosity, the proportion of protein particles having a particle size of from 1 to 5 μm and/or at least 5 μm does not substantially increase, and/or the proportion of protein particles having a particle size of from 0.1 to 1 μm does not substantially decrease when the heat stable composition is subjected to secondary heat treatment.

The term “liquid nutritional composition” refers to an aqueous composition to be administered to the gastrointestinal tract of a subject. The administration is preferably by mouth, or may be by other means such as by tube feeding including naso-gastric feeding and gastric feeding. The term “liquid nutritional composition” includes medical food, enteral nutrition, food for special medical purposes, liquid meal replacers and supplements. The liquid nutritional compositions described herein may provide significant amounts of protein and carbohydrate and usually also lipid. They may also include vitamins and minerals. In various embodiments, a subject in need of nutrition may be suffering from or predisposed to a disease or condition, or may be being or have been treated for a disease or condition, is an elderly person, a person that is recovering from a disease or condition, or a person that is malnourished. In other embodiments, the subject may also be a healthy individual, including but not limited to, a sportsman or active elderly person, including persons having particular nutritional requirements.

The term “mechanical shear process” as used herein refers to a process in which a mechanical device, such as a homogeniser, colloid mill, high pressure pump, scraped surface heat exchanger, high shear mixer, ultrasonicator, microfluidizer, or the like, is used to mix a solution or break up particles within it.

The term “non-dairy protein” as used herein refers to any protein that is not a milk protein (i.e., any protein that is not derived from animal milk). Non-dairy protein includes plant-derived protein, fungal protein, and algal protein.

The terms “non-denatured” and “native” refer to protein that has not been denatured. This includes both denaturable and non-denaturable protein.

The term “non-whey protein” as used herein refers to any protein that is not whey protein, and includes casein and protein derived from one or more non-dairy sources.

The term “nutritional composition” as used herein means a composition for consumption by humans or animals, including foods and beverages. Consumption can be via eating or drinking. In various embodiments, the food products provided herein meet standards for food safety required by the U.S. Food and Drug Administration (FDA), the U.S. Department of Agriculture, the European Food Safety Authority, and/or other state or region food regulatory agencies. The term includes compositions that can be combined with or added to other ingredients to make compositions that can be ingested by humans or animals.

The terms “primary heating” and “primary heat treatment” as used herein refer to the heat treatment used to denature proteins during the preparation of the heat stable protein composition of the invention. In some embodiments, the primary heat treatment may comprise multiple heating and/or holding steps. For example, in some embodiments the primary heat treatment comprises pre-heating at a first temperature, followed by heating at a second temperature. The term “primary heat treatment” is intended to encompass all such heating steps that are used to denature proteins during the preparation of the heat stable protein composition of the invention.

The term “protein particles” as used herein refers to aggregates of proteins that are insoluble in aqueous solutions such as water. Such particles can be formed by denaturation, for example by heating, in conjunction with shear such as by a mechanical shear process. Protein particles that are insoluble in aqueous solutions are able to be separated from the aqueous solution by centrifugation, for example centrifugation at 20,000×g for 1 hour at 25 °C. If a composition comprising protein particles contains casein, the centrifugation should be at neutral pH to avoid precipitation of the casein.

The terms “residual non-denatured” and “residual native” refer to protein that has not been denatured after a denaturation treatment. This includes both denaturable protein that has not been denatured and non-denaturable protein.

The term “retentate” as used herein refers to the retained fraction after ultrafiltration of whey or a source or whey, milk or skim milk. Such fractions have increased percentage protein and lower percentage lactose as total solids than does the starting material.

As used herein “(s)” following a noun means the plural and/or singular forms of the noun.

The terms “secondary heating” and “secondary heat treatment” as used herein refer to any additional heating step that occurs after the heat treatment used to denature proteins during the preparation of the heat stable protein composition of the invention. For example, in some embodiments the heat stable protein composition of the invention is used to produce a nutritional composition, which is subsequently subjected to a secondary heat treatment. Some non-limiting examples of secondary heat treatments include high temperature pasteurisation, ultra-high temperature (UHT) processing, and retort heating. In some embodiments, a sample of the heat stable protein composition of the invention is subjected to a primary particle growth test as described in section 1.4 of Example 1. A primary particle growth test comprises a secondary heat treatment. In some embodiments, a secondary heat treatment comprises heating to at least 80 °C, such as at least 90 °C, at least 110 °C, at least 120 °C, or at least 135 °C, or at least 140 °C. In some embodiments, a secondary heat treatment comprises heating to a temperature of 80-85 °C for 20-30 minutes, or 90-95 °C for 5 minutes, or 135-150 °C for 4 to 10 seconds, or 110 °C-130 °C for 10-20 minutes. In some embodiments, a secondary heat treatment comprises heating to a temperature of about 90 °C for about 10 minutes, or about 120 °C for about 4 minutes, or about 140 °C for about 2 minutes.

The term “shelf-stable” as used herein refers to compositions (for example, liquid compositions such as liquid nutritional compositions) which are able to be stored at room temperature (for example, from about 20 °C to about 25 °C) for extended time periods (for example, at least 2 months, at least 3 months, at least 6 months, or at least 12 months) without undergoing undesirable changes. For example, in some embodiments, a shelf-stable composition shows minimal or essentially no sedimentation, gelation, aggregation, flocculation, coagulation, increase in viscosity, decrease in the proportion by volume of protein particles having a particle size of from 0.1 to 1 μm, increase in the proportion by volume of protein particles having a particle size of from 1 to 5 μm, and/or increase in the proportion by volume of protein particles having a particle size of at least 5 μm, after storage at a temperature of from about 20 °C to about 25 °C for a period of at least 2 months, at least 3 months, at least 6 months, or at least 12 months. In some embodiments, a shelf-stable composition exhibits minimal or essentially no powderiness or grittiness. To reduce bacterial growth, shelf-stable compositions are typically heat treated, for example by sterilisation and/or high temperature pasteurisation, and aseptically packaged. In some embodiments, a shelf-stable composition (for example, a sterilised and/or pasteurised shelf-stable composition) shows negligible bacterial growth after prolonged storage at a temperature from about 20 °C to about 25 °C for at least 2 months, at least 3 months, at least 6 months or at least 12 months.

The term “subject” as used herein includes humans and other primates as well as other mammals such as farm animals, sport animals, and pets. In certain embodiments, the subject is a human. In some such embodiments, the subject is a human infant, a human toddler, a human child, or a human adult. In certain embodiments, the subject is in need of nutritional support.

The term “total amount of denaturable whey protein” as used herein refers to the sum of the amounts of denaturable serum albumin, denaturable α-lactalbumin, denaturable β-lactoglobulin, denaturable lactoferrin, and denaturable immunoglobulins (IgG). “Denaturable” in this context refers to the sum of denatured protein and non-denatured protein that is capable of being denatured, while excluding non-denatured protein that is incapable of being denatured. The total amount of denaturable whey protein can be determined as described in section 1.1 of Example 1.

The term “denatured whey protein” as used herein refers to denatured serum albumin, denatured α-lactalbumin, denatured β-lactoglobulin, denatured lactoferrin, and denatured immunoglobulins (IgG). The total amount of denatured whey protein can be determined as described in section 1.1 of Example 1.

The term “total protein” as used herein refers to the total amount of protein of a composition as determined by determining the total nitrogen content of the composition and then multiplying by 6.38, without subtracting the non-protein nitrogen content. The total protein content of a sample can be determined by the Kjeldahl method as described in ISO 8968-1:2014.

The term “whey” as used herein refers to the liquid composition which is left after casein has been removed from milk. This may be through the action of a rennet enzyme, such as is used in cheese making, and the resultant whey is called “sweet whey” or “cheese whey”. Alternatively, casein may be removed by acid precipitation, e.g. by reducing the pH of the milk below pH 4.6. The whey produced using this method is called “acid whey” or “sour whey”. Alternatively, casein may be removed by microfiltration, or by any other suitable method known in the art. All such wheys are contemplated for use in the invention.

The term “whey protein concentrate” or “WPC” as used herein refers to a fraction of whey from which lactose has been at least partially removed to increase the protein content to at least 20% by weight. In certain embodiments, the WPC has at least 65%, at least 70%, at least 75%, or at least 80% by weight of the total solids (TS) as whey protein. In some examples, the proportions of the whey proteins are substantially unaltered relative to those of the whey from which the WPC is derived. In various embodiments, the WPC is an evaporated whey protein retentate. For the purposes of this specification, the term “WPC” includes whey protein isolates (WPI) when the context allows.

A “whey protein isolate” or “WPI” as used herein refers to a WPC having at least 90% of the TS as whey protein.

The term “yoghurt” as used herein refers to an acidic or fermented food or beverage product prepared from a dairy resource, and containing either viable microorganisms or chemical acidulants or both. The term “yoghurt” includes set or stirred yoghurts as well as drinking yoghurts and also includes ambient-stable yoghurts.

### 2. HEAT STABLE PROTEIN COMPOSITIONS

In a first aspect, the invention provides a heat stable protein composition comprising whey protein and casein, wherein
the composition comprises β-lactoglobulin and casein in a weight ratio of from about 1.6:1 to about 5:1,
the whey protein comprises denaturable whey protein of which at least about 65% (w/w) is denatured,
at least about 40% (w/w) of total β-lactoglobulin in the composition is covalently aggregated, and
the composition comprises protein particles, wherein
at least about 40% by volume of the protein particles have a particle size of less than 1 μm, and
at least a portion of the protein particles comprise co-aggregates of denatured whey protein and casein.

In certain embodiments, the heat stable protein composition comprises at least about 60%, at least about 65%, at least about 70%, at least about 75%, at least about 80%, at least about 85%, at least about 90%, or at least about 95% by weight total protein on a dry weight basis, and useful ranges may be selected between any of these values (for example, from 60% to 95%, from 65% to 95%, from 70% to 95%, from 75% to 90%, from 80% to 85%).

In various embodiments, at least about 70% w/w of total protein in the composition is whey protein, such as at least about 75%, at least about 80%, at least about 85%, or about 90% w/w, and useful ranges may be selected between any of these values (for example, from 70% to 90%, from 75% to 90%, or from 80% to 90%).

In various embodiments, less than 30% w/w of total protein in the composition is casein, such as less than about 25%, less than about 20%, less than about 15%, or about 10% w/w, and useful ranges may be selected between any of these values (for example, from 10% to 30%, from 10% to 25%, from 10% to 20%, from 10% to 15%, from 15% to 30%, from 15% to 25%, or from 15% to 20%). In one embodiment, from about 80 to about 90% w/w of total protein is whey protein, and from about 10 to about 20% w/w of total protein is casein.

The relative weights of β-lactoglobulin and casein in a composition of the invention can be described using a weight ratio. The β-lactoglobulin to casein ratios described herein are generally presented in an “x: 1” format. This means that “x” weight units of β-lactoglobulin are present for each 1 weight unit of casein. For example, a β-lactoglobulin to casein weight ratio of 5:1 means that there are 5 g of β-lactoglobulin for every 1 g of casein, and a weight ratio of 1.6:1 means that there are 1.6 g of β-lactoglobulin for every 1 g of casein. Similarly, a β-lactoglobulin to casein weight ratio of from 1.6:1 to 5:1 means that there are from 1.6 to 5 g of β-lactoglobulin for every 1 g of casein.

The β-lactoglobulin to casein weight ratio of a composition in an “x: 1” format can be calculated by dividing the weight of β-lactoglobulin present by the weight of casein present to determine the value of “x”.

The ratio of β-lactoglobulin to casein can be adjusted by including in the composition differing amounts of β-lactoglobulin source (such as a whey protein source) and a casein source (such as a caseinate). In various embodiments, the composition comprises β-lactoglobulin and casein in a weight ratio of from about 1.6:1 to about 5:1, such as about 1.6:1 to about 4:1, about 1.6:1 to about 3.5:1, about 1.6:1 to about 3:1, about 2:1 to about 5:1, about 2:1 to about 4:1, about 2:1 to about 3.5:1, about 2:1 to about 3:1, about 2.1:1 to about 5:1, about 2.1:1 to about 4:1, about 2.1:1 to about 3.5:1, about 2.1:1 to about 3:1, about 2.2:1 to about 5:1, about 2.2:1 to about 4:1, about 2.2:1 to about 3.5:1, or about 2.2:1 to about 3:1. In various embodiments, the composition comprises β-lactoglobulin and casein in a weight ratio of at least about 1.6:1, such as at least about 2:1, at least about 2.1:1, at least about 2.2:1, at least about 2.4:1, at least about 2.6:1, at least about 2.8:1, or at least about 2.9:1.

In various embodiments, the composition comprises total whey protein and casein in a weight ratio of at least 3:1, at least 4:1, at least 4.1:1, at least 4.2:1, at least 4.3:1, at least 4.4:1, at least 4.5:1, at least 5:1, at least 5.5:1, at least 6:1, at least 7:1, at least 8:1, or at least 9:1. In various embodiments, the composition comprises total whey protein and casein in a weight ratio of from 3:1 to 10:1, from 3:1 to 9:1, from 3:1 to 8:1, from 3:1 to 7:1, from 3:1 to 6:1, from 3:1 to 5:1, from 4:1 to 10:1, from 4:1 to 9:1, from 4:1 to 8:1, from 4:1 to 7:1, from 4:1 to 6:1, from 4:1 to 5:1, from 4.5:1 to 10:1, from 4.5:1 to 9:1, from 4.5:1 to 8:1, from 4.5:1 to 7:1, from 4.5:1 to 6:1, from 4.5:1 to 5:1, from 5:1 to 10:1, from 5:1 to 9:1, from 5:1 to 8:1, from 5:1 to 7:1, or from 5:1 to 6:1.

In some embodiments, the composition is a liquid composition. In other embodiments, the composition is a powder, for example a powder with less than about 5% moisture.

### 3. PROTEIN SOURCES

In some embodiments, the protein source comprises both whey and casein (such as a calcium-depleted MPC). In some embodiments, separate whey protein sources and casein protein sources are used. In some embodiments, one or more protein sources that comprises both whey and casein are used together with one or more whey protein sources and/or casein protein sources. This may be useful, for example, to adjust the total protein content, total amount of whey protein, total amount of casein protein, weight ratio of total whey protein to casein, and/or the weight ratio of β-lactoglobulin to casein.

### 3.1 Whey Protein Sources

The source of whey protein for the heat stable protein compositions may be any source that provides one or more whey proteins, such as sweet whey or acid casein whey or milk whey (obtained from microfiltration of skim milk as the permeate phase) or a combination thereof. Exemplary sources of whey protein include, but are not limited to, rennet whey or cheese whey, lactic acid whey, mineral acid whey, casein whey and microfiltered skim milk whey. In certain embodiments, the source of the whey protein for the heat stable protein compositions is whey protein concentrate (WPC) or whey protein isolate (WPI). Whey protein compositions, including WPC and WPI, may be derived from acid casein whey or cheese whey. Alternative sources of the whey protein for the heat stable protein compositions included enriched compositions containing individual whey proteins (e.g., β-lactoglobulin enriched composition or α-lactalbumin enriched composition).

WPC is rich in whey proteins, but also contains other components such as lipid, lactose, minerals/ash, and, in the case of cheese whey-based WPCs, glycomacropeptide (GMP), a casein-related non-globular protein that is non-denaturable. Typical methods of production of whey protein concentrate utilize membrane filtration.

WPCs are frequently described with the percent (w/w) as whey protein being appended to “WPC.” For example, WPC80 is a WPC with 80% by weight whey protein.

Whey proteins may originate from any mammalian animal species, such as, for example cows, sheep, goats, horses, buffalos, deer, and camels. Preferably, the whey protein is bovine.

In certain embodiments, the whey protein source is available as a powder, preferably a WPC or WPI powder.

The heat stable protein compositions may be prepared from a mixture of cheese and/or acid WPCs and/or WPIs or from a mixture of proteins. In certain embodiments, the whey protein source is or comprises WPC and/or WPI. In certain embodiments, the whey protein source is or comprises a blend of a WPC and/or WPI and, optionally, one or more ingredients comprising whey and/or non-whey protein.

In certain embodiments, the whey protein source is cheese whey or a WPC prepared from cheese whey. In some such embodiments, a colouring agent is employed during the cheese making process. For example, cheese manufacturers may use annatto to provide an orange-yellow colour for coloured cheeses, such as cheddar, Leicester, Gloucester, etc. Annatto colouring agents are derived from the seeds of Bixa orellana (achiote), a shrub native to Central America. The seeds contain carotenoid pigments, including bixin, norbixin, and reline. In some such embodiments, the whey protein source comprises a colouring agent.

### 3.2 Casein Protein Sources

The source of casein protein for the heat stable protein compositions may be any source that provides one or more casein proteins. Preferably the casein is non-micellar casein. Preferably the source of casein protein is a source of non-micellar casein. Exemplary sources of non-micellar casein protein include, but are not limited to, caseinates such as sodium caseinate, potassium caseinate, calcium caseinate, and/or magnesium caseinate; calcium depleted milk protein concentrate (MPC); total milk protein (TMP); or any combination of any two or more of these.

In some embodiments, at least about 50% of the casein in the heat stable protein composition is non-micellar casein, such as at least about 55%, at least about 60%, at least about 65%, at least about 70%, at least about 75%, at least about 80%, at least about 85%, at least about 90%, at least about 95%, or about 100%, and useful ranges may be selected between any of these values (for example, from 50% to 100%, from 50% to 90%, from 60% to 100%, from 60% to 90%, from 70% to 100%, from 70% to 90%, from 80% to 100%, from 80% to 90%, or from 90% to 100%).

In some embodiments, the casein may be enriched in β-casein and/or κ-casein. For example, in some embodiments, the casein source is a β-casein and/or κ-casein enriched fraction. In various embodiments at least about 15, 20, 25, 30, 35, 40, 45, 50, 55, 60, 65, 70, 75, 80, 90, 95, 99 or 100% of the total casein is provided by a β-casein and/or κ-casein enriched casein, and various ranges may be selected from between any two of these values.

The term “β-casein enriched fraction” and the like as used herein refer to a casein fraction having a higher ratio of β-casein to α-casein than that of skim milk. The term “K-casein enriched fraction” and the like as used herein refer to a casein fraction having a higher ratio of κ-casein to α-casein than that of skim milk. Casein ratios may be measured by polyacrylamide gel electrophoresis followed by staining with Coomassie Blue and densitometry. Other suitable analytical methods are also known to the skilled addressee. Preferably, the ratio of β-casein to α-casein is higher than 1:1, more preferably higher than 1.2:1, more preferably higher than 1.4:1, more preferably higher than 1.5:1, more preferably higher than 1.6:1, most preferably higher than 1.7:1. Preferably, the ratio of κ-casein to α-casein is higher than 0.2:1, more preferably higher than 0.25:1, more preferably higher than 0.3:1, more preferably higher than 0.35:1, most preferably higher than 0.4:1. β-casein enriched fractions and κ-casein enriched fractions are enriched in β-casein and κ-casein respectively, relative to casein in the casein source from which it was prepared (generally cows' milk).

### 4. PROTEIN PARTICLES

The present invention provides a heat stable protein composition comprising protein particles wherein at least some of the protein particles comprise co-aggregates of denatured whey protein and casein.

The protein particles present in the composition of the present invention have a large proportion of particles having a small particle size (for example, in some embodiments, less than 1 μm) and are heat stable. Larger particles of insoluble protein, in particular particles >3 μm, are often less desirable as they can lead to an unpleasant gritty or sandy mouthfeel in certain applications. Larger particles can also be prone to sedimentation in liquid compositions, particularly in low-viscosity liquid compositions (for example, compositions with a viscosity of less than about 400 mPa·s measured at 100 s⁻¹ at 20 °C). Particles that are not heat stable can gel on secondary heat treatment (for example, during pasteurisation, ultra-high temperature (UHT) processing, or retort heating) leading to products with high viscosity. The inventors have found that co-aggregates of denatured whey protein and casein have a small particle size (for example, in some embodiments, less than 1 μm) with improved heat stability compared to aggregates of denatured whey protein alone. The heat stable protein compositions of the present invention can be used to produce high protein, heat stable nutritional compositions including food products and low viscosity, low sedimentation beverages.

The particle size distribution characteristics of the protein particles of the heat stable protein compositions of the invention are based on the particle size distribution for an aqueous composition comprising the heat stable protein composition. In some embodiments, the heat stable protein composition is an aqueous composition, such as a composition produced by a method of the invention, prior to drying. In these embodiments, the particle size distribution characteristics may be measured directly. In other embodiments, when the heat stable protein composition is a powder for example, it will need to be reconstituted in a liquid before measuring particle size. Particle size may be determined using a Malvern Mastersizer 2000 or 3000 as described in section 1.3 of Example 1. Other suitable methods of determining particle size will be apparent to a skilled worker.

In various embodiments, particle size distribution of the protein particles of the heat stable protein composition is substantially monomodal. Monomodality may be assessed by various means known in the art, for example using the Dip Test (Hartigan & Hartigan, 1985, Ann. Stat. 13 (1), 70-84). In some embodiments, the particle size distribution has a p value of less than 0.10 as determined by the Dip Test, preferably a p value of less than 0.05.

In various embodiments, at least 40% by volume of the protein particles in the composition have a particle size of less than about 1 μm, or at least 45%, or at least 50%, or at least 55%, or at least 60%, or at least 65%, or at least 70%, or at least 75%, or at least 80%, or at least 85%, or at least 90%, or at least 95%, or 100% by volume of the protein particles have a particle size of less than about 1 μm, and useful ranges may be selected from between any of these values (for example, from 40% to 100%, from 45% to 100%, from 45% to 95%, from 45% to 90%, from 45% to 85%, from 45% to 80%, from 50% to 100%, from 50% to 95%, from 50% to 90%, from 50% to 85%, or from 50% to 80%).

In various embodiments, at least 40% by volume of the protein particles in the composition have a particle size of from about 0.1 to about 1 μm, or at least 45%, or at least 50%, or at least 55%, or at least 60%, or at least 65%, or at least 70%, or at least 75%, or at least 80%, or at least 85%, or at least 90%, or at least 95%, or 100% by volume of the protein particles have a particle of from about 0.1 to about 1 μm, and useful ranges may be selected from between any of these values (for example, from 40% to 100%, from 40% to 95%, from 40% to 90%, from 40% to 85%, from 40% to 80%, from 45% to 100%, from 45% to 95%, from 45% to 90%, from 45% to 85%, from 45% to 80%, from 50% to 100%, from 50% to 95%, from 50% to 90%, from 50% to 85%, or from 50% to 80%).

In various embodiments, less than about 55% by volume of the protein particles in the composition have a particle size of from about 1 to about 5 μm, or less than about 50%, or less than about 45%, or less than about 40%, or less than about 35%, or less than about 30%, or less than about 25% by volume of the protein particles have a particle size of from about 1 to about 5 μm and useful ranges may be selected from between any of these values (for example, from 25% to 55%, from 25% to 50%, from 25% to 45%, from 25% to 40%, from 25% to 35%, from 25% to 30%, from 30% to 55%, from 35% to 55%, from 40% to 55%, or from 45% to 55%).

In various embodiments, less than 5% by volume of the protein particles in the composition have a particle size of at least about 5 μm, or less than 4%, or less than 3%, or less than 2%, or less than 1%, or about 0% by volume of the protein particles have a particle size of at least about 5 μm, and useful ranges may be selected from between any of these values (for example, from 0% to 5%, from 0% to 4%, from 0% to 3%, from 0% to 2%, or from 0% to 1%).

Particle sizes may also be expressed as volume weighted mean diameter (D [4,3]). Means for determining D [4,3] are known in the art. Briefly, D [4,3] is calculated based on the volume of the particles, with assumptions that the particles are spherical, based on the principle that different sized particles scatter light at different angles-bigger particles scatter light at smaller angles. Angular scattering intensity data is measured by an appropriate instrument and used to calculate the size of the particles using Mie theory. In various embodiments, the D [4,3] particle size distribution of the particles in the composition is less than about 5 μm, such as less than about 4 μm, less than about 3 μm, less than about 2 μm, less than about 1.5 μm, less than about 1.2 μm, less than about 1.1 μm, less than about 1.0 μm, or less than about 0.9 μm and useful values may be selected from between any of these values (for example from 0.9 μm to 5 μm, from 0.9 μm to 4 μm, from 0.9 μm to 3 μm, from 0.9 μm to 2 μm, from 0.9 μm to 1.5 μm, from 0.9 μm to 1.2 μm, from 1.0 μm to 5 μm, from 1.0 μm to 4 μm, from 1.0 μm to 3 μm, from 1.0 μm to 2 μm, from 1.0 μm to 1.5 μm, or from 1.0 μm to 1.2 μm).

The composition also comprises soluble casein that is not bound in the particles, and may also comprise whey protein that is not bound in the particles (for example, non-denatured whey protein).

### 5. DENATURATION

Methods to determine the degree of whey protein denaturation are well known in the art. One exemplary method is presented in section 1.1 of Example 1. Other methods suitable for use include methods reliant on an Agilent 2100 Bioanalyzer (Agilent Technologies, Inc. 2000, 2001-2007, Waldbronn, Germany) and microfluidic chips, and utilising Agilent 2100 Expert software (e.g. Anema, (2009) International Dairy J, 19 (4), 198-204), and polyacrylamide gel electrophoresis (e.g. Patel et al, (2007) Le Lait, 87, 251-268).

When a pre-denaturation sample is available (i.e. a sample of the protein composition prior to the heat treatment step), the method presented in section 1.1 of Example 1 is preferable.

When a pre-denaturation sample is not available, the degree of whey protein denaturation can be estimated using the following method:

If necessary, the sample is reconstituted at 3% protein in 0.1M NaCl. The sample is then split into three fractions.

For Fraction 1, the total crude protein is measured using the Kjeldahl method as total nitrogen×6.38. This measurement includes casein, denatured whey protein aggregates, and soluble undenatured whey protein.

Fraction 2 is centrifuged at 7,000×g for 20 minutes without adjusting the pH. This step removes the whey protein aggregates, while the soluble undenatured whey protein and casein stay in solution. The supernatant is collected and the protein content measured, again using the Kjeldahl method as total nitrogen×6.38. This measurement includes casein and soluble undenatured whey protein.

Fraction 3 is acidified to pH 4.6 with 15% acetic acid, recording the added volume to correct for the dilution caused. The fraction is again centrifuged at 7,000×g for 20 minutes. This step removes the casein and whey protein aggregates, while the soluble undenatured protein stays in solution. The supernatant is collected and the protein content measured, again using the Kjeldahl method as total nitrogen×6.38, and adjusting to account for the dilution caused by the addition of acetic acid. This measurement includes just the soluble undenatured whey protein.

The casein content can be calculated as fraction 2-fraction 3; the denatured whey protein aggregate content can be calculated as fraction 1-fraction 2; and the total whey protein content can be calculated as (fraction 1-fraction 2)+ fraction 3.

The soluble protein fraction can be characterised by testing the fractions 1 and 3 by HPLC to eludicate what protein sources may have been blended.

The percent whey protein denaturation can then be calculated using the following formula:

$$\% whey protein denaturation = \frac{denaturation whey protein aggregates}{total whey protein} \times 100$$

In various embodiments, the whey protein comprises denaturable whey protein, of which at least about 65% (w/w) is denatured, or at least about 70%, or at least about 75%, or at least about 80%, or at least about 85%, or at least about 90%, or at least about 95%, or about 100% (w/w), and useful ranges may be selected between any of these values (for example, from about 65% to about 100%, from about 70% to about 100%, from about 75% to about 100%, from about 80% to about 100%, from about 85% to about 100%, from about 90% to about 100%, from about 65% to about 95%, from about 70% to about 95%, from about 75% to about 95%, from about 80% to about 95%, from about 85% to about 95%, from about 90% to about 95%, from about 65% to about 90%, from about 70% to about 90%, from about 75% to about 90%, from about 80% to about 90%, from about 85% to about 90%, from about 65% to about 85%, from about 70% to about 85%, from about 75% to about 85%, or from about 80% to about 85%).

In certain embodiments, less than about 20% w/w of total protein in the composition is residual denaturable whey protein, such as less than about 18%, less than about 16%, or less than about 14% or less than about 12%, and useful ranges may be selected between any of these values (for example, from 12% to 20%, from 12% to 18%, from 12% to 16%, or from 12% to 14%). One exemplary method for determining the amount of residual denaturable whey protein is presented in section 1.1 of Example 1.

### 6. COVALENT AGGREGATION

Bonds that form during the heating of whey-protein-containing compositions include covalent bonds and non-covalent bonds, such as hydrogen bonds, ionic bonds, hydrophobic bonds, and Van der Waals bonding interactions. Without wishing to be bound by theory, it is believed that the covalent interactions provide for irreversible aggregation of whey proteins.

Covalent bonds in heated whey compositions include inter- and intramolecular disulfide bonds formed via sulfhydryl-disulfide interchange or sulfhydryl oxidation reactions (Havea, 2006, Int. Dairy J., 16 (5), 415-422). α-Lactalbumin, β-lactoglobulin, K-casein and as2-casein can be involved in sulfhydryl-disulfide interactions (Anema & Mckenna, 1996, J. Agric. Food Chem., 44, 422-428). β-lactoglobulin contains two intramolecular disulfide (SS) groups and one free SH group, making it highly reactive for covalent aggregation. BSA contains 17 SS bonds and one SH group, also making it capable of initiating covalent aggregation. α-lactalbumin contains four SS bonds but no free SH group to serve as the starting point for covalent aggregation.

Covalent aggregates in the protein particles of the present invention can contain covalent bonds formed between any proteins that contain cysteine amino acids. Covalent bonds have a greater bond strength compared to non-covalent interactions. Covalent bonds can be broken using strong reducing reagents such as 2-mercaptoethanol, dithiothreitol (DTT), or tris(2-carboxyethyl)phosphine (TCEP).

Non-covalently aggregated protein may, for example, be formed via hydrophobic interactions (Glani & Apenten, 1999, Int. J. Food Sci., 34 (5-6), 467-476) or protein-protein interactions via calcium-bridging (Anema & Mckenna, 1996, J. Agric. Food Chem., 44 (2), 422-428).

In the protein particles of the present invention, one or more covalent bonds may be formed between two different molecules of the same protein, for example between two β-lactoglobulin molecules, and/or between two different proteins, for example between β-lactoglobulin and any of α-lactalbumin, and BSA in whey protein and αS2- and k-casein in the caseins. Of the caseins, only αS2- and k-casein are able to form covalent bonds with whey proteins. αS2- and κ-casein account for approximately 20% of caseins in the compositions described herein.

Without wishing to be bound by theory, it is believed that a higher proportion of covalently aggregated β-lactoglobulin in the presence of casein molecules results in heat stable particles that are smaller in size (for example, particles less than 1 μm).

As the compositions of the invention contain whey protein, and β-lactoglobulin is the most abundant whey protein, it is convenient to determine the level of covalent aggregation in terms of the amount by weight of the denatured β-lactoglobulin that is covalently aggregated. Without wishing to be bound by theory, it is expected that this will be indicative of the overall degree of covalent aggregation for all proteins in the composition that are capable of covalent aggregation.

In various embodiments, the denatured whey protein comprises denatured β-lactoglobulin. In some embodiments, at least about 40% (w/w) of total β-lactoglobulin in the composition is covalently aggregated, or at least about 50%, or at least about 55%, or at least about 60%, or at least about 65%, or at least about 70%, or at least about 75%, or at least about 80% of total β-lactoglobulin in the composition is covalently aggregated, and useful ranges may be selected between any of these values (for example, from 40% to 80%, from 50% to 80%, from 60% to 80%, from 70% to 80%, from 40% to 70%, from 50% to 70%, from 60% to 70%, or from 55% to 65%).

Methods to determine the amount (percentage) by weight of β-lactoglobulin that is covalently aggregated are well known in the art. One exemplary method used herein relies on using a Bioanalyzer using the method of Anema (2009, International Dairy J, 19 (4), 198-204) with modifications as described in section 1.2 of Example 1.

### 7. HEAT STABILITY

Methods for assessing heat stability are known in the art. In certain embodiments, heat stability is assessed by subjecting a sample to a secondary heat treatment, for example a primary particle growth test as described in section 1.4 of Example 1. Particle size distribution can be assessed following the primary particle growth test as described in section 1.3. Particle size distribution may be assessed for the primary particle growth test sample directly, or may be compared to the particle size distribution of a control sample. A control sample is a sample of the composition used for the primary particle growth test, that has not been subjected to secondary heat treatment.

A primary particle growth test is typically performed on an aqueous composition comprising the protein composition to be tested. Preferably, an aqueous composition comprising an amount of the protein composition to be tested that is sufficient to provide a total protein content of 15% (w/w) is used. The aqueous composition is then subjected to a secondary heat treatment.

In some embodiments, the primary particle growth test comprises subjecting an aqueous composition comprising an amount of the heat stable protein composition sufficient to provide a total protein content of 15% (w/w) to a secondary heat treatment at (a) 90 °C for 10 minutes, (b) 120 °C for 4 minutes, or (c) 140 °C for 2 minutes.

In some embodiments, the particle size distribution characteristics of the protein particles of the heat stable protein composition do not substantially change when subjected to a primary particle growth test.

In some embodiments, the proportion of protein particles having a particle size of from 0.1 to 1 μm does not substantially decrease when subjected to a primary particle growth test. In some embodiments, after a primary particle growth test, the proportion by volume of protein particles having a particle size of from 0.1 to 1 μm is at least about 70% of that of a control sample, such as at least about 75%, at least about 80%, at least about 85%, at least about 90%, at least about 95%, at least about 97%, at least about 98%, or at least about 99%, and useful ranges may be selected between any of these values (for example, from 70% to 99%, from 75% to 99%, from 80% to 99%, from 85% to 99%, from 90% to 99%, from 70% to 95%, from 75% to 95%, from 80% to 95%, from 85% to 95%, from 90% to 95%, 70% to 90%, from 75% to 90%, from 80% to 90%, or from 85% to 90%).

In some embodiments, after a primary particle growth test, at least about 40% by volume of the protein particles in the aqueous composition have a particle size of from 0.1 to 1 μm, such as at least about 42%, at least about 44%, at least about 45%, at least about 46%, at least about 48%, at least about 50%, at least about 52%, at least about 54% or about 55% and useful ranges may be selected between any of these values (for example, from 40% to 55%, from 42% to 55%, from 44% to 55%, from 46% to 55%, from 48%, to 55%, from 50% to 55%, from 52% to 55%, from 40% to 50%, from 42% to 50%, from 44% to 50%, from 46% to 50%, or from 48% to 50%).

In one specifically contemplated embodiment, an aqueous composition comprising an amount of the heat stable protein composition sufficient to provide a total protein content of 15% w/w, that has been subjected to a secondary heat treatment at 120 °C for 4 minutes, comprises protein particles of which at least about 40% by volume, preferably at least about 45% by volume, more preferably at least about 50% by volume have a particle size of from 0.1 to 1 μm.

In some embodiments, the proportion by volume of protein particles having a particle size of from 1 to 5 μm does not substantially increase when subjected to a primary particle growth test. In some embodiments, after a primary particle growth test, the proportion by volume of protein particles having a particle size of from 1 to 5 μm is less than about 130% of that of a control sample, such as less than about 125%, less than about 120%, less than about 115%, less than about 110%, less than about 105%, less than about 103%, less than about 102%, or less than about 101% of that of a control sample.

In some embodiments, less than about 60% by volume of the protein particles in the aqueous composition have a particle size of from 1 to 5 μm, such as less than about 58%, less than about 56%, less than about 55%, less than about 54%, less than about 53%, less than about 52%, less than about 51%, less than about 50%, less than about 49%, less than about 48%, less than about 47%, less than about 46%, or about 45% and useful ranges may be selected between any of these values (for example, from 45% to 60%, from 45% to 56%, from 45% to 55%, from 45% to 52%, or from 45% to 50%).

In one specifically contemplated embodiment, an aqueous composition comprising an amount of the heat stable protein composition sufficient to provide a total protein content of 15% w/w, that has been subjected to a secondary heat treatment at 120 °C for 4 minutes, comprises protein particles of which less than less than about 60% by volume, preferably less than about 55% by volume, more preferably less than about 50% by volume have a particle size of from 1 to 5 μm.

In some embodiments, the proportion of protein particles having a particle size of at least 5 μm does not substantially increase when subjected to a primary particle growth test. In some embodiments, after a primary particle growth test, the proportion by volume of protein particles having a particle size of at least 5 μm is less than about 130% of that of a control sample, such as less than about 125%, less than about 120%, less than about 115%, less than about 110%, less than about 105%, less than about 103%, less than about 102%, or less than about 101% of that of a control sample.

In some embodiments, the proportion by volume of protein particles having a particle size of at least 5 μm is less than about 10%, such as less than about 9%, less than about 8%, less than about 7%, less than about 6%, less than about 5%, less than about 4%, less than about 3%, less than about 2%, less than about 1%, or about 0%, and useful ranges may be selected between any of these values (for example, from 0% to 10%, from 0% to 8%, from 0% to 6%, from 0% to 4%, from 0% to 2%, from 1% to 10%, from 1% to 8%, from 1% to 6%, from 1% to 4%, or from 1% to 2%).

In one specifically contemplated embodiment, an aqueous composition comprising an amount of the heat stable protein composition sufficient to provide a total protein content of 15% w/w, that has been subjected to a secondary heat treatment at 120 °C for 4 minutes, comprises protein particles of which less than about 10% by volume, preferably less than about 5% by volume, more preferably less than about 2% by volume, most preferably less than about 1% by volume have a particle size of at least 5 μm.

In some embodiments, the D [4,3] of the protein particles does not substantially increase when subjected to a primary particle growth test. In some embodiments, after a primary particle growth test, the D [4,3] is less than about 140% of that of a control sample, such as less than about 135%, less than about 130%, less than about 120%, less than about 110%, less than about 105%, less than about 103%, less than about 102%, or less than about 101% of that of a control sample.

In some embodiments, the D [4,3] of the protein particles is less than about 5 μm, such as less than about 4, less than about 3, less than about 2.5, less than about 2, less than about 1.5, or less than about 1 μm, or about 0.9 μm, and useful ranges may be selected between any of these values (for example, from 0.9 μm to 5 μm, from 0.9 μm to 4 μm, from 0.9 μm to 3 μm, from 0.9 μm to 2 μm, from 0.9 μm to 1.5 μm, or from 0.9 μm to 1 μm).

In some embodiments, after a primary particle growth test, the proportion by volume of protein particles having a particle size of 0.1 to 1 μm is at least about 80% of that of an unheated sample, and the proportion by volume of protein particles having a particle size of 1 to 5 μm is less than about 105% of that of an unheated sample. In some embodiments, after a primary particle growth test, at least about 40% of the protein particles have a particle size of 0.1 to 1 μm, less than about 55% of the protein particles have a particle size of 1 to 5 μm, and less than about 3% of the protein particles have a particle size of at least 5 μm.

Heat stability can also be assessed by the state of the aqueous solution after a primary particle growth test. In some embodiments, after a primary particle growth test, the aqueous solution comprising the heat stable protein composition shows minimal or essentially no gelation, sedimentation, or aggregation. Gelation of a liquid composition is considered to be a change in state from a liquid to a soft to firm solid. If the solution no longer flows following heating, it is considered to have gelled.

In some embodiments, an aqueous composition comprising an amount of the heat stable protein composition sufficient to provide a total protein content of 15% w/w, that has been subjected to a secondary heat treatment at 90 °C for 10 minutes or 120 °C for 4 minutes, shows minimal or essentially no gelation or coagulation.

In certain embodiments, the particle size distribution of the heat stable protein composition is stable upon secondary heat treatment (e.g., high temperature pasteurisation, UHT processing or retort heating). High temperature pasteurisation requires a temperature of 80-85 °C for 20-30 minutes or 90-95 °C for 5 minutes. UHT processing typically involves subjecting a composition to a temperature above 135 °C, such as 135 °C to 150 °C, to achieve sterilisation. Typical holding times for UHT are 4 to 10 seconds (or longer). Retort processing typically involves subjecting a composition to temperatures between 110 °C and 130 °C for 10 to 20 minutes in a sealed can to achieve sterilisation.

Heat stability can also be assessed by the viscosity of the aqueous solution after a primary particle growth test. The viscosity of a sample may be measured by methods known in the art, such as the method presented in section 1.6 of Example 1.

In some embodiments, after a primary particle growth test, the aqueous solution comprising the heat stable protein composition shows minimal or essentially no increase in viscosity. In some embodiments, after a primary particle growth test, a 15% (w/w) protein content aqueous solution comprising the heat stable protein composition has a viscosity of less than about 100 mPa·s at 20 °C at a shear rate of 100 s⁻¹, such as less than about 90, less than about 80, less than about 70, less than about 60, less than about 50, less than about 40, less than about 30, less than about 20, less than about 15, less than about 10, less than about 5, or about 4 mPa·s at 20 °C at a shear rate of 100 s⁻¹, and useful ranges may be selected between any of these values (for example from 4 to 100, from 4 to 80, from 4 to 60, from 4 to 50, from 4 to 20, from 4 to 15, from 4 to 10, from 5 to 100, from 5 to 80, from 5 to 60, from 5 to 50, from 5 to 20, from 5 to 15, or from 5 to 10 mPa·s).

In some embodiments, heat stability can be assessed by determining heat coagulation time (HCT). For example, a high heat stability may be indicated by a long heat coagulation time.

Methods for determining heat coagulation time (HCT) are known in the art. One exemplary method for determining HCT is presented in section 1.5 of Example 1.

Applicants believe, without wishing to be bound by any theory, any liquid composition having a heat coagulation time at 140 °C of less than 60 seconds has a high risk of extensive fouling and blocking of UHT heating equipment, while any liquid composition with 65-80 seconds HCT at 140 °C has a potential risk of fouling. As described herein, liquid compositions having a heat coagulation time of higher than 80 seconds are believed to be stable to UHT heating treatment at 140 °C for 5 seconds. Alternatively, or additionally, following heating at 120 °C in an oil bath, a sample having an HCT less than 3 minutes has a high risk of gelation and aggregation in a retort can.

In some embodiments, an aqueous composition comprising an amount of the heat stable protein composition sufficient to provide a total protein content of 10% w/w has a HCT of at least about 60 seconds, such as at least about 70, 80, 90, 100, 110, 120, 130, 140, 150, 160, 170, 180, 190, 200, 210, 220, 230, 240, 250, or at least about 260 seconds, and useful ranges may be selected between any of these values (for example, from 60 to 260 seconds, from 80 to 260 seconds, from 80 to 220 seconds, from 100 to 260 seconds, from 100 to 220 seconds, from 120 to 260 seconds, or from 100 to 220 seconds).

In some embodiments, an aqueous composition comprising an amount of the heat stable protein composition sufficient to provide a total protein content of 15% (w/w), that has been subjected to secondary heat treatment at 90 °C for 10 minutes, 120 °C for 4 minutes, or 140 °C for 2 minutes, shows no visible sign of gelation.

### 8. METHOD FOR PREPARING HEAT STABLE PROTEIN COMPOSITIONS

The applicant has surprisingly found that protein particles comprising denatured whey protein and casein with a high percentage of covalently aggregated denatured β-lactoglobulin can be produced by heat treating an aqueous solution comprising high concentrations of whey and casein proteins under conditions of high shear stress. The particles are small in size (for example, in some embodiments, less than 1 μm), heat stable, and do not require a mechanical shear process to break down the particles further.

Without wishing to be bound by theory, it is believed that a total whey protein concentration of at least about 18 g/100 g of the aqueous composition, a β-lactoglobulin concentration of at least about 9 g/100 g of the aqueous composition, and a total protein concentration of at least about 20 g/100 g of the aqueous composition, combined with a weight ratio of β-lactoglobulin to casein from about 1.6:1 to about 5:1, favour the formation of small particles (for example, at least 40% by volume of the protein particles having a particle size of less than 1 μm) with a high percentage of total β-lactoglobulin being covalently aggregated (for example, at least 40% by weight of the total β-lactoglobulin being covalently aggregated).

Advantageously, such protein compositions are heat stable. Such compositions, when subjected to a secondary heat treatment, may show minimal or no increase in the size of the particles in the composition.

In various embodiments, when the protein composition is subjected to a secondary heat treatment,
a) there is minimal or no decrease in the percent by volume of particles in the protein composition having a particle size of from 0.1 to 1 μm (for example, the proportion by volume of protein particles having a particle size of from 0.1 to 1 μm in the protein composition may be at least 70% of that of a control sample not subjected to a secondary heat treatment).
b) there is minimal or no increase in the percent by volume of particles in the protein composition having a particle size of from 1 to 5 μm (for example, the proportion by volume of protein particles having a particle size of from 1 to 5 μm may be less than 130% of that of a control sample not subjected to a secondary heat treatment), and/or
c) there is minimal or no increase in the percent by volume of particles in the protein composition having a particle size of at least 5 μm (for example, the proportion by volume of protein particles having a particle size of at least 5 μm may be less than 130% of that of a control sample not subjected to a secondary heat treatment).

Such compositions, after a secondary heat treatment, may comprise protein particles of which at least about 40% by volume have a particle size of from 0.1 to 1 μm, less than about 60% by volume have a particle size of from 1 to 5 μm, and/or less than 10% by volume have a particle size of at least 5 μm. Such compositions may also show minimal or no increase in viscosity when subjected to a secondary heat treatment. Such compositions may also show minimal or essentially no gelation or coagulation when subjected to a secondary heat treatment.

Accordingly, in one aspect, the invention provides a method for preparing a heat stable protein composition, the method comprising:
a. providing an aqueous composition having a pH of from 5.5 to 6.8, comprising
   i. a total whey protein content of at least about 18 g/100 g of the aqueous composition,
   ii. a total β-lactoglobulin content of at least about 9 g/100 g of the aqueous composition,
   iii. a total protein content of at least about 20 g/100 g of the aqueous composition, and
   iv. β-lactoglobulin and casein in a weight ratio from about 1.6:1 to about 5:1, and
b. heat treating the aqueous composition to at least about 70 °C, for a time sufficient to allow protein denaturation to occur; the heat-treating comprising heating the aqueous composition under high shear stress to provide the heat stable protein composition.

In another aspect, the invention provides a method for preparing a heat stable protein composition, the method comprising:
a. contacting a whey protein source with an oxidising agent in combination with a catalyst, such as an enzymatic catalyst or a chemical catalyst, preferably a peroxidase enzyme,
b. contacting the whey protein source and a casein protein source to provide an aqueous composition having a pH of from 5.5 to 6.8, comprising
   i. a total whey protein content of at least about 14 g/100 g of the aqueous composition,
   ii. a β-lactoglobulin content of at least about 4 g/100 g of the aqueous composition,
   iii. a total protein content of at least about 15 g/100 g of the aqueous composition, and
   iv. β-lactoglobulin and casein in a weight ratio from about 1.6:1 to about 5:1, and
c. heat treating the aqueous composition to at least about 70 °C, for a time sufficient to allow protein denaturation to occur; the heat-treating comprising heating the aqueous composition under high shear stress to provide the heat stable protein composition.

In another aspect, the invention provides a method for preparing a heat stable protein composition, the method comprising:
a. providing an aqueous composition having a pH of from 5.5 to 6.8, comprising
   i. a total whey protein content of at least about 14 g/100 g of the aqueous composition,
   ii. a β-lactoglobulin content of at least about 4 g/100 g of the aqueous composition,
   iii. a total protein content of at least about 15 g/100 g of the aqueous composition, and
   iv. β-lactoglobulin and casein in a weight ratio from about 1.6:1 to about 5:1,
b. contacting the aqueous composition with an oxidising agent in combination with a catalyst, such as an enzymatic catalyst or a chemical catalyst, preferably a peroxidase enzyme, and
c. heat treating the aqueous composition to at least about 70 °C, for a time sufficient to allow protein denaturation to occur; the heat-treating comprising heating the aqueous composition under high shear stress to provide the heat stable protein composition.

In some embodiments, the heat stable protein composition produced by the method is a composition according to the first aspect.

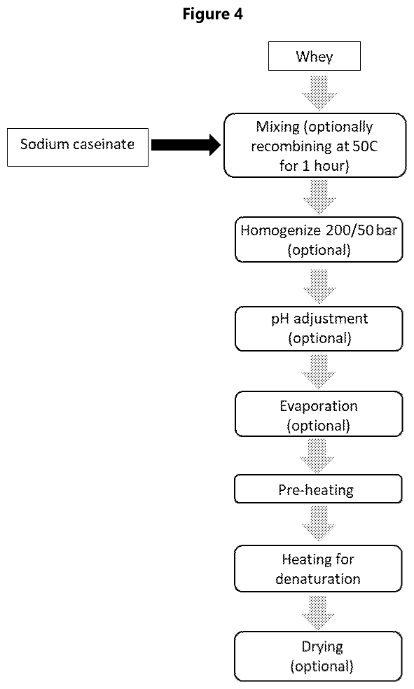

An exemplary method for preparing a heat stable protein composition is shown in FIG. 4. Suitable alterations to the method that achieve the heat stable protein compositions described herein will be apparent to those skilled in the art.

As shown in FIG. 4, in some embodiments the method comprises contacting a whey protein source and a casein protein source to provide the aqueous composition of step a), for example by mixing. The whey protein source and/or the casein protein source may be any suitable source as described herein. In some embodiments, the whey protein source comprises, or consists of, a whey protein concentrate (WPC), a whey protein isolate (WPI), or a combination thereof. In some embodiments, the casein protein source comprises, or consists of, a caseinate, a calcium-depleted milk protein concentrate (MPC), a total milk protein (TMP), or a combination of any two or more of these. Examples of caseinates include sodium caseinate, potassium caseinate, calcium caseinate, and/or magnesium caseinate. Alternatively, or additionally, any other source of non-micellar casein may be used. Alternatively, or additionally, a protein source that comprises both whey and casein (such as a calcium depleted MPC or a total milk protein (TMP)) may be used.

In some embodiments, the whey protein source and/or the casein protein source are in the form of a powder. When the whey protein source and/or the casein protein source are in the form of powders, they will generally need to be reconstituted to provide the aqueous composition of step a). Accordingly, in some such embodiments, the method comprises reconstituting the powder(s) to provide the aqueous composition, for example reconstituting the powder(s) in water.

In some embodiments, the reconstituting comprises stirring for sufficient time to fully hydrate the powders, for example stirring for 60 minutes. In some embodiments, the stirring may be at an elevated temperature, such as at 50 °C. Alternatively, or additionally, homogenisation can be used to reconstitute the powders. In some embodiments, the method further comprises homogenising the aqueous composition, preferably homogenising at about 200/50 bar, and preferably prior to step b).

In various embodiments, the powders are added to water in sufficient quantities to provide the required concentrations. It will be appreciated that different concentrations of total whey protein, β-lactoglobulin, and total protein can be achieved by reconstituting different amounts of a whey protein source and/or a casein protein source. It will also be appreciated that different weight ratios of β-lactoglobulin to casein can be achieved by varying the relative amounts of a whey protein source and a casein protein source used.

In some embodiments, the whey protein source and/or the casein protein source are in the form of a solution. For example, the whey protein source may comprise a whey retentate.

In one exemplary embodiment, the method comprises providing a source of whey proteins, such as cheese whey; clarifying, separating, and/or thermalising (pasteurising) the cheese whey to produce a whey protein solution; subjecting the whey protein solution to ultrafiltration and/or diafiltration to produce a whey protein retentate; and contacting the whey protein retentate with a casein protein source to produce the aqueous solution of step a).

Cheese whey collected after cheese manufacturing is clarified, and thermalised (pasteurised) to provide microbial control and also to deactivate any of the remaining rennet enzyme and starter cultures from cheese making.

General conditions for thermalisation (pasteurisation) are known in the art and include, but are not limited to, about 63 °C for 30 minutes (also referred to the batch holding method), about 72 °C for 15 seconds (also referred to the high temperature short time (HTST) method), about 89 °C for 1 second, or any alternative thermal and non-thermal treatments that have a bactericidal effect equivalent to the above treatments.

The whey protein solution can be subjected to microfiltration and/or ultrafiltration, optionally with diafiltration to obtain a retentate. In certain embodiments, the whey protein retentate has a total solids (TS) content from about 10% to about 40%. In some such embodiments, the whey protein retentate has a TS content from about 13% to about 38%, from about 18% to about 33%, or from about 23% to about 30%. In some such embodiments, the whey protein retentate has a TS content of at least 18%, at least 20%, at least 22%, or at least 24%.

In certain embodiments, the filtration step is run to provide a retentate having from about 65% to about 95% total protein by weight. In some such embodiments, the total protein content of the whey protein retentate is from about 75% to about 90% or from about 80% to about 85% by weight. In some such embodiments, the total protein content of the whey protein retentate is at least 65%, at least 70%, at least 75%, or at least 80% by weight.

At this stage, and particularly during thermalisation, it may be desirable to ensure that the whey protein solution and/or the whey protein retentate remains substantially undenatured (e.g., less than 10% denatured). Without wishing to be bound by theory, the uncontrolled formation of denatured aggregates may cause formation of larger than desired aggregates during the heat-denaturation step.

In some such embodiments, the whey protein source and/or the whey protein retentate have a low level of denaturation prior to step b). For example, the denaturation level of the whey protein source and/or the whey protein retentate prior to step b) may be less than 10%, such as from about 3% to about 8%. Alternatively, the denaturation level of the whey protein source and/or the whey protein retentate prior to the denaturing heat treatment step may be less than 9%, less than 8%, less than 7%, less than 6%, or less than 5%. In some such embodiments, the denaturation level of the whey protein source and/or the whey protein retentate prior to step b) is about 5%, about 4%, about 3%, about 2%, or about 1%.

In various embodiments, the aqueous composition has a low level of denaturation prior to step b). In various embodiments, less than about 10% (w/w) of total denaturable whey protein in the aqueous composition prior to step b) is denatured, such as less than about 9%, less than about 8%, less than about 7%, less than about 6%, less than about 5%, less than about 4%, less than about 3%, less than about 2%, or less than about 1%, and useful ranges may be selected between any of these values (for example, from 1% to 10%, from 1% to 9%, from 1% to 8%, from 1% to 7%, from 1% to 6%, from 1% to 5%, from 1% to 4%, from 1% to 3%, or from 1% to 2%). In some embodiments, about 5% of total denaturable whey protein in the aqueous composition prior to step b) is denatured, such as about 4%, about 3%, about 2%, or about 1%.

In various embodiments, the aqueous composition of step a) comprises a total whey protein content of at least about 18 g/100 g of the aqueous composition, or at least about 20 g, or at least about 22 g, or at least about 24 g, or at least about 26 g/100 g of the aqueous composition, and useful ranges may be selected between any of these values (for example, from about 18 g/100 g to about 26 g/100 g, from about 18 g/100 g to about 24 g/100 g, from about 18 g/100 g to about 22 g/100 g, from about 20 g/100 g to about 26 g/100 g, from about 20 g/100 g to about 24 g/100 g, or from about 20 g/100 g to about 22 g/100 g).

In various embodiments, the aqueous composition of step a) comprises a β-lactoglobulin content of at least about 9 g/100 g of the aqueous composition, or at least about 10 g, or at least about 11 g, or at least about 12 g, or at least about 13 g/100 g of the aqueous composition, and useful ranges may be selected between any of these values (for example, from about 9 g/100 g to about 13 g/100 g, from about 9 g/100 g to about 12 g/100 g, from about 10 g/100 g to about 13 g/100 g, or from about 10 g/100 g to about 12 g/100 g).

In various embodiments, the aqueous composition of step a) comprises a total protein content of at least about 20 g/100 g of the aqueous composition, or at least about 22 g, or at least about 24 g, or at least about 26 g, or at least about 28 g, or at least about 30 g, or at least about 32 g/100 g of the aqueous composition, and useful ranges may be selected between any of these values (for example, from about 20 g/100 g to about 32 g/100 g, from about 20 g/100 g to about 30 g/100 g, from about 20 g/100 g to about 28 g/100 g, from about 22 g/100 g to about 32 g/100 g, from about 22 g/100 g to about 30 g/100 g, from about 22 g/100 g to about 28 g/100 g, from about 24 g/100 g to about 32 g/100 g, from about 24 g/100 g to about 30 g/100 g, from about 24 g/100 g to about 28 g/100 g from about 26 g/100 g to about 32 g/100 g, from about 26 g/100 g to about 30 g/100 g, or from about 26 g/100 g to about 28 g/100 g).

In various embodiments, the aqueous composition of step a) comprises β-lactoglobulin and casein in a weight ratio from about 1.6:1 to about 5:1, such as about 1.6:1 to about 4:1, about 1.6:1 to about 3.5:1, about 1.6:1 to about 3:1, about 2:1 to about 5:1, about 2:1 to about 4:1, about 2:1 to about 3.5:1, about 2:1 to about 3:1, about 2.1:1 to about 5:1, about 2.1:1 to about 4:1, about 2.1:1 to about 3.5:1, about 2.1:1 to about 3:1, about 2.2:1 to about 5:1, about 2.2:1 to about 4:1, about 2.2:1 to about 3.5:1, or about 2.2:1 to about 3:1. In various embodiments, the aqueous solution of step a) comprises β-lactoglobulin and casein in a weight ratio of at least about 1.6:1, such as at least about 2:1, at least about 2.1:1, at least about 2.2:1, at least about 2.4:1, at least about 2.6:1, at least about 2.8:1, or at least about 2.9:1, or at least about 3:1, or at least about 3.5:1, or at least about 4:1, or at least about 4.5:1, or at least about 5:1.

In some embodiments, the method further comprises contacting the whey protein source with an oxidising agent in combination with a catalyst, such as an enzymatic catalyst or a chemical catalyst, preferably a peroxidase enzyme, and preferably prior to step a).

In some embodiments, the method further comprises contacting the aqueous composition with an oxidising agent in combination with a catalyst, such as an enzymatic catalyst or a chemical catalyst, preferably a peroxidase enzyme, and preferably prior to step b).

In some embodiments, the oxidising agent is a peroxide, such as hydrogen peroxide, and the method comprises contacting the aqueous composition, or the whey protein source, with the peroxide in combination with a peroxidase enzyme.

In certain embodiments, the amount of oxidising agent is less than 300 ppm, such as from about 5 to about 250 ppm, such as from about 5 to about 200 ppm or from about 10 to about 150 ppm or from about 20 to about 120 ppm; from about 10 to about 200 ppm, such as from about 40 to about 190 ppm or from about 140 ppm to about 190 ppm; or from about 20 to about 220 ppm, such as from about 20 to about 120 ppm or from about 30 to about 100 ppm.

In certain embodiments, the amount of oxidising agent is less than 1200×10⁻⁶ kg/kg of whey protein, such as from about 20×10⁻⁶ kg/kg of whey protein to about 900×10⁻⁶ kg/kg of whey protein, from about 40×10⁻⁶ kg/kg of whey protein to about 800×10⁻⁶ kg/kg of whey protein, or from about 60×10⁻⁶ kg/kg of whey protein to about 700×10⁻⁶ kg/kg of whey protein, such as from about 80×10⁻⁶ kg/kg of whey protein to about 600×10⁻⁶ kg/kg of whey protein, such as from about 100×10⁻⁶ kg/kg of whey protein to about 400×10⁻⁶ kg/kg of whey protein.

In certain embodiments, the amount of oxidising agent is less than 2000×10⁻⁶ kg/kg of denaturable whey protein, such as from about 30×10⁻⁶ kg/kg of denaturable whey protein to about 1400×10⁻⁶ kg/kg of denaturable whey protein, from about 60×10⁻⁶ kg/kg of denaturable whey protein to about 1200×10⁻⁶ kg/kg of denaturable whey protein, or from about 90×10⁻⁶ kg/kg of denaturable whey protein to about 1000×10⁻⁶ kg/kg of denaturable whey protein, such as from about 120×10⁻⁶ kg/kg of denaturable whey protein to about 800×10⁻⁶ kg/kg of denaturable whey protein, such as from about 150×10⁻⁶ kg/kg of denaturable whey protein to about 600×10⁻⁶ kg/kg of denaturable whey protein.

In certain embodiments, the amount of oxidising agent is less than 2400×10⁻⁶ kg/kg of β-lactoglobulin protein, such as from about 40×10⁻⁶ kg/kg of β-lactoglobulin protein to about 1800×10⁻⁶ kg/kg of β-lactoglobulin protein, from about 80×10⁻⁶ kg/kg of β-lactoglobulin protein to about 1600×10⁻⁶ kg/kg of β-lactoglobulin protein, or from about 120×10⁻⁶ kg/kg of β-lactoglobulin protein to about 1400×10⁻⁶ kg/kg of β-lactoglobulin protein, such as from about 160×10⁻⁶ kg/kg of β-lactoglobulin protein to about 1200×10⁻⁶ kg/kg of β-lactoglobulin protein, such as from about 200×10⁻⁶ kg/kg of β-lactoglobulin protein to about 800×10⁻⁶ kg/kg of β-lactoglobulin protein.

In certain embodiments, the mole ratio of oxidising agent to β-lactoglobulin protein is less than 2, such as from about 0.04 to about 1.8, from about 0.08 to about 1.5, from about 0.12 to about 1.2, from about 0.16 to about 0.9, from about 0.2 to about 0.7, from about 0.24 to about 0.6, from about 0.28 to about 0.5.

In certain embodiments, the amount of oxidising agent is added in one step. More preferably, and to avoid catalyst inhibition and inactivation, the total amount of peroxide is added in more than one step, for example in 2, 3, 4, 5 or more steps. More preferably, the amount of peroxide is added continuously. The skilled person in the art can determine the optimum oxidising agent addition rate as a function of catalyst/enzyme activity and protein concentration in the aqueous solution or whey protein source.

In some embodiments, the oxidising agent is any food grade oxidising agent. In some such embodiments, the oxidising agent is oxygen (O₂), ozone, a peroxide including an alkyl hydroperoxide, superoxide, peroxynitrite, peroxydisulfuric acid, or lactoperoxidase.

In some embodiments, the oxidising agent is a peroxide, preferably an organic peroxide. Exemplary peroxides include, but are not limited to, a metal peroxide (e.g., an alkali metal peroxide such as sodium peroxide; an alkaline earth metal peroxide such as magnesium peroxide, or calcium peroxide; or a transition metal peroxide such as zinc peroxide), hydrogen peroxide, and benzoyl peroxide. In some embodiments, the oxidising agent is a perborate such as sodium perborate.

In some embodiments, the oxidising agent is benzoyl peroxide or hydrogen peroxide. Hydrogen peroxide can be obtained in various concentrations and purities. In one embodiment, the hydrogen peroxide is food grade.

In some embodiments, the oxidising agent is employed with a catalyst, which may be either an enzymatic catalyst or a chemical catalyst. In some embodiments, the oxidising agent is employed with a catalyst enzyme such as for example, a microbial peroxidase enzyme. An exemplary fungal peroxidase enzyme is MaxiBright® (DSM Food Specialties). Other exemplary microbial peroxidase enzymes include Dye-decolorizing (DyP-type) peroxidases such as EfeB/YcdB from Escherichia coli 0157, DyPB from Rhodococcus jostii RHA1; and DyP2 from Amycolatopsis sp. 75iv2. Exemplary chemical catalysts include, but are not limited to, copper, iron, zinc, or manganese.

In some embodiments, the oxidising agent is added over a period of time. For example, an initial amount of oxidising agent may be added and then subsequent amount(s) of oxidising agent may be added as the initial amount is consumed. As such, the total amount of oxidising agent may be added in more than one step, for example in 2, 3, 4, 5 or more steps or added continuously over a period of time.

Exemplary oxidising agents, including hydrogen peroxide, have been previously employed by the dairy industry to bleach whey.

Hydrogen peroxide (H₂O2) is a clear, colourless liquid with a slightly pungent odour. Hydrogen peroxide is one of the two bleaching agents currently approved for bleaching whey in the United States to decolour whey compositions prepared from cheese containing annatto.

In some embodiments, the oxidising agent is optionally inactivated, removed, or consumed prior to step (b) and, therefore, the aqueous composition may be substantially free of the oxidising agent during the heat treatment of step (b). In certain embodiments, the aqueous composition is substantially free of the oxidising agent during the heat treatment of step (b) where no active steps are taken to inactivate, remove, or consume the oxidising agent. For example, the oxidising agent may be present in an amount (e.g., <10 ppm) such that removal or consumption of the oxidising agent is not desirable.

In certain embodiments, the oxidising agent is employed with a catalyst enzyme, such as for example a microbial peroxidase enzyme, and the quantities of the oxidising agent and peroxidase enzyme are such that the oxidising agent is completely used up by the enzyme. Alternatively, when the oxidising agent is hydrogen peroxide, a catalase enzyme may be used to catalyse the decomposition of hydrogen peroxide to water and oxygen. In certain embodiments, a catalase enzyme is not employed.

The aqueous composition may be sampled to confirm that it is substantially free of the oxidising agent. As an example, the aqueous composition may be sampled and tested for detectable peroxide using a peroxide test strip available from Merck/MilliporeSigma.

As shown in FIG. 4, in some embodiments, the method further comprises adjusting the pH of the aqueous composition to a pH of from 5.5 to 6.8. The pH adjustment can be performed by adding food-safe acid(s) or base(s) to reach the required pH. In various embodiments, the pH is adjusted using NaOH, KOH, and/or HCl.

In various embodiments, the method further comprises adjusting the pH of the aqueous composition to a pH of from 5.5 to 6.8, or from 5.6 to 6.7, or from 5.7 to 6.6, or from 5.8 to 6.5, or from 5.9 to 6.4, or from 6.0 to 6.3, or from 6.1 to 6.3. Preferably, the method comprises adjusting the pH of the aqueous composition to a pH of from 6.1 to 6.3.

In some embodiments, the method comprises concentrating the aqueous composition prior to step b), preferably by evaporation.

As shown in FIG. 4, the aqueous composition is subjected to a heat treatment. Heat treatment is applied to impart the required denaturation.

The heat treatment of step b) is of sufficient temperature and duration to denature a proportion of the whey proteins into insoluble aggregates. In some embodiments, step b) comprises heat treating the aqueous composition for a time sufficient to allow at least about 65% (w/w) of the denaturable whey protein in the aqueous composition to denature, such as at least about 70%, or at least about 75%, or at least about 80%, or at least about 85%, or at least about 90%, or at least about 95%, or about 100% (w/w), and useful ranges may be selected between any of these values (for example, from about 65% to about 100%, from about 70% to about 100%, from about 75% to about 100%, from about 80% to about 100%, from about 85% to about 100%, from about 90% to about 100%, from about 65% to about 95%, from about 70% to about 95%, from about 75% to about 95%, from about 80% to about 95%, from about 85% to about 95%, from about 90% to about 95%, from about 65% to about 90%, from about 70% to about 90%, from about 75% to about 90%, from about 80% to about 90%, from about 85% to about 90%, from about 65% to about 85%, from about 70% to about 85%, from about 75% to about 85%, or from about 80% to about 85%).

The temperature and time can be altered depending on the level of protein denaturation required. If a higher temperature is used, then a lower time may be sufficient to provide the same level of denaturation as a lower temperature for a longer time.

In various embodiments, step b) comprises heat treating the aqueous composition to a temperature of at least about 70 °C, or at least about 75 °C, or at least about 80 °C, or at least about 85 °C, or at least about 90 °C. In various embodiments, step b) comprises heat treating the solution to a temperature of from about 70 °C to about 150 °C, or about 70 °C to about 140 °C, or about 70 °C to about 130 °C, or about 70 °C to about 120 °C, or about 70 °C to about 110 °C, or about 70 °C to about 100 °C, or about 70 °C to about 90 °C, or about 70 °C to about 85 °C, or about 70 °C to about 80 °C, or about 75 °C to about 150 °C, or about 75 °C to about 140 °C, or about 75 °C to about 130 °C, or about 75 °C to about 120 °C, or about 75 °C to about 110 °C, or about 75 °C to about 100 °C, or about 75 °C to about 90 °C, or about 80 °C to about 150 °C, or about 80 °C to about 140 °C, or about 80 °C to about 130 °C, or about 80 °C to about 120 °C, or about 80 °C to about 110 °C, or about 80 °C to about 100 °C, or about 80 °C to about 90 °C. Preferably, step b) comprises heat treating the solution to a temperature of from about 80 °C to about 90 °C.

In various embodiments, step b) comprises heat treating the aqueous composition for about 1 second to about 30 minutes, or about 1 second to about 20 minutes, or about 1 second to about 15 minutes, or about 1 second to about 10 minutes, or about 1 second to about 5 minutes, or about 1 second to about 1 minute, or about 1 second to about 45 seconds, or about 1 second to about 30 seconds, or about 1 second to about 15 seconds, or about 1 second to about 5 seconds, or about 5 seconds to about 30 minutes, or about 5 seconds to about 20 minutes, or about 5 seconds to about 15 minutes, or about 5 seconds to about 10 minutes, or about 5 seconds to about 5 minutes, or about 5 seconds to about 1 minute, or about 5 seconds to about 45 seconds, or about 5 seconds to about 30 seconds, or about 5 seconds to about 15 seconds, or about 5 seconds to about 10 seconds, or about 10 seconds to about 30 minutes, or about 10 seconds to about 20 minutes, or about 10 seconds to about 15 minutes, or about 10 seconds to about 10 minutes, or about 10 seconds to about 5 minutes, or about 10 seconds to about 1 minute, or about 10 seconds to about 45 seconds, or about 10 seconds to about 30 seconds, or about 10 seconds to about 15 seconds. Preferably, step b) comprises heat treating the aqueous composition for about 10 seconds to about 30 seconds.

In various embodiments, step b) comprises pre-heating to 55 °C and subsequently heating at 85 °C for 10-15 seconds.

Step b) comprises heating the aqueous composition under conditions of high shear stress. Shear stress can be generated by a variety of means known in the art. For example, in certain embodiments, step b) is performed under conditions of high shear stress generated by increasing serum viscosity, or wall shear rate, or changing flow pattern to turbulent flow, or applying a mechanical shear process, or any combination thereof.

In certain embodiments, step b) comprises heat treating the aqueous composition to at least about 70 °C while maintaining a high wall shear rate, optionally under laminar flow, for example, maintaining a wall shear rate of at least about 1000 s⁻¹. In some such embodiments, the wall shear rate is from about 1000 s⁻¹ to about 10000 s⁻¹, or from about 1500 s⁻¹ to about 5000 s⁻¹, or from about 1500 s⁻¹ to about 4000 s⁻¹ or from about 2000 s⁻¹ to about 3000 s⁻¹.

In certain embodiments, step b) comprises heat treating the aqueous composition to at least 70 °C under conditions of turbulent flow, for example with a Reynolds number of at least about 2000. In some such embodiments, the Reynolds number is from about 2000 to about 20,000, from about 2000 to about 10,000, or from about 2000 to about 5000. In some such embodiments, the Reynolds number is from about 2000 to about 2500 or from about 2100 to about 2300.

Turbulent flow is defined as having sufficient mass flow rate in the heating tubes to provide a Reynolds number, referred to as Re, of at least 2000. Such Reynolds numbers are a characteristic of turbulent flow and are known in the art of hydrodynamics. The determination of Re depends on the mass velocity of the fluid and its highest viscosity at the target heating temperature, which is defined as the nominal viscosity determined using the Hagen-Poiseuille equation from a measurement of the pressure drop along a known length of horizontal pipe of known uniform circular cross section at a known flowrate of the heat-treated fluid at a uniform temperature before it is dried. To calculate Re for a given process, formula for Newtonian fluids can be used subject to using the highest viscosity of heat-treated fluid at the target temperature. This implies Re at all the other viscosities (i.e., lower viscosities) would be higher and would fall in the turbulent zone.

In certain embodiments, step b) comprises heat treating the aqueous composition to at least about 70 °C under conditions of mechanical shear. In some such embodiments, the mechanical shear is produced by a homogenizer, colloid mill, high pressure pump, scraped surface heat exchanger, high shear mixer or the like.

In certain embodiments, step b) comprises heat treating the aqueous composition to a temperature from about 70 °C to about 90 °C while under conditions of high shear stress resulting from increasing serum viscosity, high wall shear rate, turbulent flow, mechanical shear, or a combination of two or more of these. In some such embodiments, step b) comprises heating the solution to a temperature from about 80 °C to about 90 °C at pH 6.1 to pH 6.3 while under conditions of high enough shear stress resulted from increasing serum viscosity, high wall shear rate, turbulent flow, mechanical shear, or combination of two or more.

The heating can be accomplished by a variety of means, as will be understood by the skilled person. Some exemplary heating means are described in US20120114795A1, which is incorporated herein by reference. In preferred embodiments a long tubular thermal reactor is used. Typically, the thermal reactor has a length based on its nominal hold up time of between 1 second and 1000 seconds.

The temperature of the aqueous composition at the end of reactor may be between about 70 °C and about 150 °C, preferably between about 75 °C and about 120 °C and more preferably between about 80 °C and about 90 °C.

Following step b), the heat stable protein composition may be dried. Methods for drying aqueous compositions are well known in the art, and include spray-drying, freeze-drying, drum drying, and fluidised bed drying.

Spray drying is currently preferred. Preferably, the heat treatment zone is coupled directly to a spray drier fitted with a nozzle or a cluster of nozzles or a rotary atomiser or an ultrasonic atomiser for the purpose of producing a stream of droplets.

In various embodiments, the protein composition is not subjected to a mechanical shear process prior to drying other than where liquid is converted into droplets to facilitate drying.

In some embodiments, the protein composition may be used directly for preparation of high protein products without drying. In some embodiments the product exiting the flow path is used as an ingredient in preparing a food product.

In certain embodiments, the protein composition is not subjected to a particle size reduction or a particle size selection procedure such as further microfiltration to achieve the particle size distribution(s) described herein.

In various embodiments, the heat-treated material is not subject to a particle size reduction procedure prior to drying. In various embodiments, the heat-treated material is subject to a particle size reduction procedure prior to drying.

In some embodiments, the method further comprises the step of cooling the heat-treated aqueous composition. Cooling can be by any suitable method, such as by refrigeration, heat exchanger or cooled water bath.

### 9. NUTRITIONAL COMPOSITIONS

The heat-stable protein compositions of the invention are useful for producing a variety of nutritional compositions.

Accordingly, in one aspect the invention provides a nutritional composition comprising the heat-stable protein composition of the first aspect or third aspects.

In some embodiments, the nutritional composition has improved flavour compared to an all-whey composition. For example, the composition may have an increase in “milky” flavour and/or a reduction in “eggy” flavour compared to an all-whey composition.

In various embodiments, the nutritional composition may comprise one or more lipids. In various embodiments, the nutritional composition may comprise one or more carbohydrates. In various embodiments, the nutritional composition may comprise one or more lipids and one or more carbohydrates.

In various embodiments, the nutritional composition may comprise at least about 1%, 2%, 3%, 4%, 5%, 6%, 7%, 8%, 9%, 10%, 11%, 12%, 13%, 14%, 15%, 16%, 17%, 18%, 19%, 20%, 30%, 40%, or at least about 50% by weight total protein on a dry basis, and useful ranges may be selected from between any of these values (for example, from about 1% to about 40%, or from about 1% to about 30%, or from about 1% to about 20%, or about 1% to about 16%, 1% to about 15%, 1% to about 14%, or about 1% to about 12%, or about 1% to about 10%, or from about 2% to about 50%, or from about 2% to about 40%, or from about 2% to about 30%, or about 2% to about 20%, or about 2% to about 16%, 2% to about 15%, 2% to about 14%, or about 2% to about 12%, or about 2% to about 10%, from about 4% to about 50%, or from about 4% to about 40%, or from about 4% to about 30%, or about 4% to about 20%, or about 4% to about 16%, 4% to about 15%, 4% to about 14%, or about 4% to about 12%, or about 4% to about 10%, from about 5% to about 50%, or from about 5% to about 40%, or from about 5% to about 30%, or about 5% to about 20%, or about 5% to about 16%, 5% to about 15%, 5% to about 14%, or about 5% to about 12%, or about 5% to about 10%).

In various embodiments, the nutritional composition may comprise at least about 1%, 2%, 3%, 4%, 5%, 6%, 7%, 8%, 9%, 10%, 11%, 12%, 13%, 14%, 15%, 16%, 17%, 18%, 19%, 20%, 30%, 40%, or at least about 50% by weight denatured whey protein on a dry basis, and useful ranges may be selected from between any of these values (for example, from about 1% to about 40%, or from about 1% to about 30%, or from about 1% to about 20%, or about 1% to about 16%, 1% to about 15%, 1% to about 14%, or about 1% to about 12%, or about 1% to about 10%, or from about 2% to about 50%, or from about 2% to about 40%, or from about 2% to about 30%, or about 2% to about 20%, or about 2% to about 16%, 2% to about 15%, 2% to about 14%, or about 2% to about 12%, or about 2% to about 10%, from about 4% to about 50%, or from about 4% to about 40%, or from about 4% to about 30%, or about 4% to about 20%, or about 4% to about 16%, 4% to about 15%, 4% to about 14%, or about 4% to about 12%, or about 4% to about 10%, from about 5% to about 50%, or from about 5% to about 40%, or from about 5% to about 30%, or about 5% to about 20%, or about 5% to about 16%, 5% to about 15%, 5% to about 14%, or about 5% to about 12%, or about 5% to about 10%).

In various embodiments, at least about 50% (w/w) of total protein in the nutritional composition is denatured whey protein, such as at least about 55%, at least about 60%, at least about 65%, at least about 70%, at least about 75%, or at least about 80% (w/w), and useful ranges may be selected between any of these values (for example, from about 50% to about 80%, from about 50% to about 70%, from about 50% to about 60%, from about 60% to about 80%, from about 60% to about 70%, or from about 70% to about 80%).

In various embodiments, at least about 50%, at least about 55%, at least about 60%, at least about 65%, at least about 70%, at least about 75%, at least about 80%, at least about 85%, at least about 90%, at least about 95%, or about 100% (w/w) of total protein in the nutritional composition is provided by the heat stable protein composition, and useful ranges may be selected between any of these values (for example, from about 50% to about 100%, from about 50% to about 90%, from about 50% to about 80%, from about 50% to about 70%, from about 50% to about 60%, from about 60% to about 100%, from about 60% to about 90%, from about 60% to about 80%, from about 60% to about 70%, from about 70% to about 100%, from about 70% to about 90%, from about 70% to about 80%, from about 80% to about 100%, from about 80% to about 90%, or from about 90% to about 100%).

In various embodiments, at least about 40% by volume of the protein particles in the nutritional composition have a particle size of less than about 1 μm, or at least about 45%, or at least about 50%, or at least about 55%, or at least about 60%, or at least about 65%, or at least about 70%, or at least about 75%, or at least about 80%, or at least about 85%, or at least about 90%, or at least about 95%, or about 100%, and useful ranges may be selected from between any of these values (for example, from 40% to 100%, from 45% to 100%, from 45% to 95%, from 45% to 90%, from 45% to 85%, from 45% to 80%, from 50% to 100%, from 50% to 95%, from 50% to 90%, from 50% to 85%, or from 50% to 80%).

In various embodiments, at least about 40% by volume of the protein particles in the nutritional composition have a particle size of from about 0.1 to about 1 μm, or at least about 45%, or at least about 50%, or at least about 55%, or at least about 60%, or at least about 65%, or at least about 70%, or at least about 75%, or at least about 80%, or at least about 85%, or at least about 90%, or at least about 95%, or about 100%, and useful ranges may be selected from between any of these values (for example, from 40% to 100%, from 40% to 95%, from 40% to 90%, from 40% to 85%, from 40% to 80%, from 45% to 100%, from 45% to 95%, from 45% to 90%, from 45% to 85%, from 45% to 80%, from 50% to 100%, from 50% to 95%, from 50% to 90%, from 50% to 85%, or from 50% to 80%).

In various embodiments, less than about 55% by volume of the protein particles in the nutritional composition have a particle size of from about 1 to about 5 μm, or less than about 50%, or less than about 45%, or less than about 40%, or less than about 35%, or less than about 30%, or less than about 25%, and useful ranges may be selected from between any of these values (for example, from 25% to 55%, from 25% to 50%, from 25% to 45%, from 25% to 40%, from 25% to 35%, from 25% to 30%, from 30% to 55%, from 35% to 55%, from 40% to 55%, or from 45% to 55%.).

In various embodiments, less than about 5% by volume of the protein particles in the nutritional composition have a particle size of at least about 5 μm, or less than about 4%, or less than about 3%, or less than about 2%, or less than about 1%, or about 0%, and useful ranges may be selected from between any of these values (for example, from 0% to 5%, from 0% to 4%, from 0% to 3%, from 0% to 2%, or from 0% to 1%).

In various embodiments, the nutritional composition may comprise at least about 0.1% lipid by weight on a dry basis, such as about 0.1%, about 0.2%, or about 0.5%, or about 1%, or about 3%, or about 5%, or about 10% lipid by weight on a dry basis. In various embodiments, the nutritional composition may comprise from about 0.1% to 40% lipid by weight on a dry basis, and useful ranges may be selected from between any of these values (for example, from about 0.1% to about 40%, or about 0.5% to about 40%, or about 1% to about 40%, or about 3% to about 40%, or about 5% to about 40%, or about 10% to about 40%, or about 15% to about 40%, or about 20% to about 40%, or about 0.1% to about 35%, or about 0.5% to about 35%, or about 1% to about 35%, or about 3% to about 35%, or about 5% to about 35%, or about 10% to about 35%, or about 15% to about 35%, or about 20% to about 35%, or about 0.1% to about 30%, or about 0.5% to about 30%, or about 1% to about 30%, or about 3% to about 30%, or about 5% to about 30%, or about 10% to about 30%, or about 15% to about 30%, or about 20% to about 30%, or about 0.1% to about 20%, or about 0.5% to about 20%, or about 1% to about 20%, or about 3% to about 20%, or about 5% to about 20%, or about 10% to about 20%, or about 15% to about 20%).

In various embodiments, the nutritional composition may comprise at least about 0.1% carbohydrate by weight on a dry basis, such as about 0.1%, or about 0.5%, or about 1%, or about 3%, or about 5%, or about 10% carbohydrate by weight on a dry basis. In various embodiments, the nutritional composition may comprise from about 0.1% to 40%, or from about 0.1% to about 80% carbohydrate by weight on a dry basis, and useful ranges may be selected from between any of these values (for example, from about 0.1% to about 80%, from about 0.1% to about 70%, from about 0.1% to about 65%, from about 0.1% to about 60%, from about 0.1% to about 50%, from about 0.1% to about 40%, or about 0.5% to about 40%, or about 1% to about 40%, or about 3% to about 40%, or about 5% to about 40%, from about 10% to about 80%, from about 10% to about 70%, from about 10% to about 65%, from about 10% to about 60%, from about 10% to about 50%, or about 10% to about 40%, or about 15% to about 40%, from about 20% to about 80%, from about 20% to about 70%, from about 20% to about 65%, from about 20% to about 60%, from about 20% to about 50%, or about 20% to about 40%, from about 30% to about 80%, from about 30% to about 70%, from about 30% to about 65%, from about 30% to about 60%, from about 30% to about 50%, from about 40% to about 80%, from about 40% to about 70%, from about 40% to about 65%, from about 40% to about 60%, from about 40% to about 50%, from about 50% to about 80%, from about 50% to about 70%, from about 50% to about 65%, from about 50% to about 60%, or about 0.1% to about 35%, or about 0.5% to about 35%, or about 1% to about 35%, or about 3% to about 35%, or about 5% to about 35%, or about 10% to about 35%, or about 15% to about 35%, or about 20% to about 35%, or about 0.1% to about 30%, or about 0.5% to about 30%, or about 1% to about 30%, or about 3% to about 30%, or about 5% to about 30%, or about 10% to about 30%, or about 15% to about 30%, or about 20% to about 30%, or about 0.1% to about 20%, or about 0.5% to about 20%, or about 1% to about 20%, or about 3% to about 20%, or about 5% to about 20%, or about 10% to about 20%, or about 15% to about 20%).

In various embodiments, the nutritional composition may comprise at least about 20% lactose by weight on a dry basis, such as at least about 25%, 30%, 35%, 40%, 45%, 50%, 55%, 60%, 65%, 70%, 75%, or at least about 80%, and useful ranges may be selected between any of these values (for example, from about 20% to about 80%, from about 20% to about 70%, from about 20% to about 60%, from about 20% to about 55%, from about 20% to about 50%, from about 30% to about 80%, from about 30% to about 70%, from about 30% to about 60%, from about 30% to about 55%, from about 30% to about 50%, from about 40% to about 80%, from about 40% to about 70%, from about 40% to about 60%, from about 40% to about 55%, from about 40% to about 50%, from about 45% to about 80%, from about 45% to about 70%, from about 45% to about 60%, or from about 45% to about 55%).

In various embodiments, the heat stable protein composition is formulated into a nutritional composition in the form of a powder that is suitable for reconstituting into a beverage by combining with a liquid, such as a protein powder, shake mix, or supplement.

In various embodiments, the heat stable protein composition is formulated into a nutritional composition by wet blending. In various embodiments, the nutritional composition is a wet blended nutritional composition, for example a wet blended meal replacement composition, a wet blended infant formula, or a wet blended medical food.

In various embodiments, the nutritional composition may comprise at least about 30 mg/100 g of a divalent cation such as Ca²⁺, such as at least about 40 mg/100 g, at least about 50 mg/100 g, at least about 60 mg/100 g, at least about 75 mg/100 g, or at least about 100 mg/100 g. In various embodiments, the nutritional composition may comprise at least about 30 mg/100 ml of a divalent cation such as Ca²⁺, such as at least about 40 mg/100 ml, at least about 50 mg/100 ml, at least about 60 mg/100 ml, at least about 75 mg/100 ml, or at least about 100 mg/100 ml.

In certain embodiments, the nutritional composition is a medical food. By way of example only, U.S. federal law and the Food and Drug Administration regulations define medical food as, “a food which is formulated to be consumed or administered enterally under the supervision of a physician and which is intended for the specific dietary management of a disease or condition for which distinctive nutritional requirements, based on recognised scientific principles, are established by medical evaluation” (§ 5 (b) of the 1988 Orphan Drug Act (21 U.S.C. 360ee (b) (3)) and FDA regulation 21 CFR 101.9 (j) (8)).

Described herein is a method for providing nutritional support to a subject comprising enterally administering to the subject a nutritional composition comprising the heat stable protein composition of the invention. In certain embodiments, the subject is a subject in need of nutritional support. Thus, nutritional compositions described herein are for use in a method for providing nutritional support to a subject in need thereof. In some embodiments, the subject is a human. In some embodiments, the subject is a human infant or toddler. In other embodiments, the subject is a human adult. In some embodiments, the subject is a pregnant female. The enteral administration may be orally or via a tube (e.g. naso-gastric feeding or gastric feeding).

In certain embodiments, the nutritional composition is administered enterally to a subject to maintain or increase muscle protein synthesis, maintain or increase muscle mass, prevent or decrease loss of muscle mass, maintain or increase growth, prevent or decrease muscle catabolismprevent or treat cachexia, prevent or treat sarcopenia, increase rate of glycogen resynthesis, modulate blood sugar levels, increase insulin response to raised blood glucose concentration, reduce satiety, reduce satiation, increase food intake, increase calorie intake, improve glucose metabolism, increase rate of recovery following surgery, increase prehabilitation efficacy prior to surgery or chemotherapy, increase rate of recovery following injury, increase rate of recovery following exercise, increase sports performance, and/or to provide nutrition. The enteral administration may be orally or via a tube (e.g. naso-gastric feeding or gastric feeding).

In certain embodiments, the nutritional composition comprising the heat stable protein composition of the invention is for use in maintaining or increasing muscle protein synthesis, maintaining or increasing muscle mass, preventing or decreasing loss of muscle mass, maintaining or increasing growth, preventing or decreasing muscle catabolismpreventing or treating cachexia, preventing or treating sarcopenia, increasing rate of glycogen resynthesis, modulating blood sugar levels, increasing insulin response to raised blood glucose concentration, reducing satiety, reducing satiation, increasing food intake, increasing calorie intake, improving glucose metabolism, increasing rate of recovery following surgery, increasing prehabilitation efficacy prior to surgery or chemotherapy, increasing rate of recovery following injury, increasing rate of recovery following exercise, increasing sports performance, and/or providing nutrition.

In certain embodiments, the nutritional composition is sterilised and/or pasteurised in a manner suitable for commercial applications. In some embodiments, the sterilisation and/or pasteurisation comprises a secondary heat treatment. In other embodiments, the sterilisation and/or pasteurisation comprises a non-thermal treatment. Exemplary techniques for sterilisation and/or pasteurisation include, but are not limited to, secondary heat treatments such as high temperature pasteurisation, ultra-high temperature (UHT) treatment and retort heat treatment.

In a further aspect, the invention provides a method for preparing a nutritional composition, the method comprising contacting:
a) a heat stable protein composition of the invention, and
b) one or more additional ingredients.

Other steps for preparing and packaging a nutritional composition will depend on the nutritional composition to be produced and will be known to a skilled worker.

In various embodiments, the one or more additional ingredients comprise one or more lipids, one or more carbohydrates, one or more monovalent cations, and/or one or more divalent metal cations.

In various embodiments the method may comprise providing an aqueous composition comprising the heat stable protein composition. In some embodiments the method may comprise reconstituting a powdered heat stable protein composition, optionally in combination with one or more additional dry ingredients, to produce an aqueous composition. In other embodiments, a powdered heat stable protein composition may be used without reconstituting.

The heat stable protein compositions of the invention may be useful in the manufacture of powdered or ready-to-mix compositions, particularly wet blended compositions, wet blended meal replacement compositions, wet blended infant formula, and/or wet blended medical foods. Wet blended compositions are compositions that have been prepared using a wet blending step, in which two or more ingredients are combined as an aqueous solution, and optionally subsequently dried to a powder. Wet blending may be required, for example, for ready-to-mix nutritional compositions that need a wet blending step to incorporate a fat source into the composition.

The heat stable protein compositions of the invention are particularly useful in wet blended applications, as the low viscosity of the compositions may enable a high total solids content to be achieved during evaporation. When the evaporation step can achieve a high total solids content, less water must be removed during spray drying, with a corresponding reduction in energy usage. Additionally, the heat stability of the compositions of the invention may reduce line fouling during evaporation and drying, with corresponding reductions in production downtime, and increases in plant throughput and product yields.

Methods for preparing wet blended compositions will be known to a skilled worker. Briefly, methods for preparing wet blended compositions may comprise the step of combining two or more ingredients to form an aqueous solution. The aqueous solution may optionally be subjected to one or more additional steps, such as homogenisation, standardisation, heat treatment (for example pasteurisation and/or UHT treatment), homogenisation, evaporation, and/or spray drying. The aqueous solution may comprise a heat stable protein composition of the invention and one or more additional ingredients, optionally selected from one or more lipids, one or more carbohydrates, one or more additional ingredients as described herein, or any combination of these.

### 9.1 Food Products

In some embodiments, the nutritional composition is a food product.

In various embodiments, the food product may be an ice cream, a fermented product, buttermilk, cheese, processed cheese, cheese analogues, quark, a pudding, a frozen dessert, coffee whitener, a gel, a bar, or a baked good.

The food products prepared using the heat stable protein compositions of the invention may exhibit negligible to no increase in undesirable flavours (for example, bitter, savoury, or eggy) compared to a control food product having the same ingredient composition and protein content as the food product of the invention except that the control food product does not comprise a heat stable protein composition of the invention.

### 9.2 Liquid Compositions

The heat stable protein composition of the invention is useful in the manufacture of liquid compositions, particularly liquid nutritional compositions, such as high protein beverages. In such compositions, the protein compositions of the invention can provide a high protein content while being resistant to changes in particle size after secondary heat treatment, exhibiting reduced sedimentation and good mouth feel (e.g., by low levels of grittiness or powderiness) while maintaining an acceptable viscosity. In some embodiments, the liquid compositions also have improved flavour compared to an all-whey composition, such as an increase in “milky” flavour and/or a reduction in “eggy” flavour.

Accordingly, in one aspect the invention provides a liquid composition comprising a heat stable protein composition of the invention. In some embodiments the liquid composition is a liquid nutritional composition.

Examples of suitable liquid composition include, but are not limited to, high protein beverages such as ready-to-drink (RTD) beverages as well as aqueous liquids (e.g., concentrates) that may be diluted. In certain embodiments, the liquid composition is a shake, a smoothie, a milk drink, a UHT milk, a milk powder, a sports drink including dairy and non-dairy based sports drinks, a protein shot, a fruit juice, a medical food, or a formula such as infant formula, follow-on formula, or growing-up formula. In certain embodiments, the liquid composition is a neutral high protein beverage. In certain embodiments, the liquid composition is an acidic high protein beverage.

An exemplary liquid composition is a sports beverage.

A sports beverage typically comprises a high content of protein, has a low-fat content and has added vitamins and minerals, flavours, sweeteners, stabilisers, and/or salt.

In some embodiments, the liquid composition comprises at least about 6% (w/w) total protein by weight of the liquid composition, such as at least about 7%, at least about 8%, at least about 9%, at least about 10%, at least about 11%, at least about 12%, at least about 13%, at least about 14%, at least about 15%, at least about 16%, at least about 17%, at least about 18%, at least about 19%, at least about 20%, at least about 21%, at least about 22%, at least about 24%, at least about 26%, at least about 28%, or at least about 30% (w/w) total protein, and useful ranges may be selected between any of these values (for example, from 6% to 30%, from 7% to 28%, from 8% to 26%, or from 10% to 24%). The total protein in the liquid composition is the sum of all protein contributed by all protein-containing ingredients in the composition. For example, in embodiments where the liquid composition comprises a heat stable protein composition as well other non-dairy and/or dairy proteins derived from, for example, skim milk powder (SMP) or milk protein concentrate (MPC), the total protein in the liquid composition is the sum of the total protein present in the heat stable protein composition and the SMP and/or MPC.

In some embodiments, the liquid composition comprises at least about 6% (w/w) denatured whey protein by weight of the liquid composition, such as at least about 7%, at least about 8%, at least about 9%, at least about 10%, at least about 11%, at least about 12%, at least about 13%, at least about 14%, at least about 15%, at least about 16%, at least about 17%, at least about 18%, at least about 19%, at least about 20%, at least about 21%, at least about 22%, at least about 24%, at least about 26%, at least about 28%, or at least about 30% (w/w) denatured whey protein and useful ranges may be selected between any of these values (for example, from 6% to 30%, from 7% to 28%, from 8% to 26%, or from 10% to 24%).

In some embodiments, at least about 50%, at least about 60%, at least about 70%, at least about 80%, at least about 85%, at least about 90%, or at least about 95% of total protein in the liquid composition is denatured whey protein, and useful ranges may be selected between any of these values (for example, from 50% to 95%, from 60% to 90%, or from 70% to 85%). In some embodiments, the liquid composition comprises other dairy proteins and/or non-dairy proteins. In some embodiments, the liquid composition comprises whey protein from two or more sources, such as a heat stable protein composition of the invention, a denatured whey protein composition, a non-denatured whey protein composition, a whey protein hydrolysate, or an ingredient comprising both whey and casein (such as an MPC). In such embodiments, the total whey protein in the composition is the sum of the total whey protein present in the heat stable protein composition of the invention, the denatured whey protein composition, the non-denatured whey protein composition, the whey protein hydrolysate, and/or the MPC.

In certain embodiments, the liquid composition exhibits minimal or essentially no sedimentation under conditions amenable to sedimentation. Sedimentation can be assessed by storing the liquid composition at a temperature of about 20 °C to about 25 °C for shelf-life testing at 1 month, 6 weeks, 3 months, 6 months, or 12 months shelf life. To test the sediment, the product is inverted 3 times and carefully poured out. The container is placed upside down for 30 minutes; the weight of the container plus sediment is recorded; the amount of sediment is calculated by subtracting the empty container weight. The % sediment is then calculated by the ratio of the weight of sediment over total weight of the product in the container.

In some embodiments, the liquid composition (for example, a composition with a viscosity of less than about 400 mPa·s measured at 100 s⁻¹ at 20 °C) exhibits less than about 10% sedimentation after storage at a temperature of about 20 °C to about 25 °C for at least 6 weeks, such as at least 3 months, at least 6 months, or at least 12 months. In some embodiments, the liquid composition (for example, a composition with a viscosity of less than about 400 mPa·s measured at 100 s⁻¹ at 20 °C) exhibits less than about 10% sedimentation after storage at a temperature of about 20 °C to about 25 °C for 3 months, such as less than about 9%, less than about 8%, less than about 7%, less than about 6%, less than about 5%, less than about 4%, less than about 3%, less than about 2%, less than about 1%, or essentially no sedimentation.

In various embodiments the liquid composition is heat-stable, for example the composition is in a liquid state in which essentially no gelation, flocculation, aggregation, coagulation, sedimentation, increase in viscosity, decrease in the proportion by volume of protein particles having a particle size of from 0.1 to 1 μm, increase in the proportion by volume of protein particles having a particle size of from 1 to 5 μm, or increase in the proportion by volume of protein particles having a particle size of at least 5 μm is observed in the composition after a secondary heat treatment.

In various embodiments the liquid composition is shelf-stable, for example the composition is in a liquid state in which essentially no gelation, flocculation, aggregation, coagulation, sedimentation, increase in viscosity, decrease in the proportion by volume of protein particles having a particle size of from 0.1 to 1 μm, increase in the proportion by volume of protein particles having a particle size of from 1 to 5 μm, or increase in the proportion by volume of protein particles having a particle size of at least 5 μm is observed in the composition after prolonged storage at temperatures of about 20 °C, e.g. at least 3 months, or preferably at least 6 months or 12 months.

Gelation of a liquid composition is considered to be a change in state from a liquid to a soft to firm solid. If the solution no longer flows, it is considered to have gelled.

In certain embodiments, the liquid composition is sterilised and/or pasteurised in a manner suitable for commercial applications. In some embodiments, the sterilisation and/or pasteurisation comprises a secondary heat treatment. In other embodiments, the sterilisation and/or pasteurisation comprises a non-thermal treatment. Exemplary techniques for sterilisation and/or pasteurisation include, but are not limited to, secondary heat treatments such as high temperature pasteurisation, ultra-high temperature (UHT) treatment and retort heat treatment.

Secondary heat treatment (for example, sterilisation and/or pasteurisation) may be useful to provide liquid compositions that are shelf stable, and able to be stored for extended periods at room temperature.

In some embodiments, the liquid composition is shelf-stable following secondary heat treatment (e.g. sterilisation and/or pasteurisation). In some embodiments, the liquid composition shows minimal or essentially no sedimentation, gelation, aggregation, coagulation, increase in viscosity, decrease in the proportion by volume of protein particles having a particle size of from 0.1 to 1 μm, increase in the proportion by volume of protein particles having a particle size of from 1 to 5 μm, or increase in the proportion by volume of protein particles having a particle size of at least 5 μm following secondary heat treatment (e.g. sterilisation and/or pasteurisation). In some embodiments, the sterilised and/or pasteurised liquid composition shows negligible bacterial growth when packaged aseptically after prolonged storage at a temperature from about 20 °C to about 25 °C for at least 2 months, at least 3 months, at least 6 months or at least 12 months. In some such embodiments, the liquid composition exhibits minimal or essentially no powderiness or grittiness. Thus, for example, the liquid composition may be a heat-treated, shelf-stable liquid composition.

In some embodiments, the proportion by volume of protein particles in the liquid composition having a particle size of from 0.1 to 1 μm does not decrease following a secondary heat treatment (such as sterilisation and/or pasteurisation). In some embodiments, following a secondary heat treatment, the proportion by volume of protein particles having a particle size of from 0.1 to 1 μm is at least 70% of that of the composition prior to the secondary heat treatment, such as at least 75%, at least 80%, at least 85%, at least 90%, at least 95%, at least 97%, at least 98%, or at least 99% of that of the composition prior to the secondary heat treatment.

In some embodiments, at least about 40% by volume of the protein particles in the heat-treated liquid composition have a particle size of from 0.1 to 1 μm, such as at least about 42%, at least about 44%, at least about 45%, at least about 46%, at least about 48%, at least about 50%, or at least about 52%, or at least about 54%, or about 55%, and useful ranges may be selected between any of these values (for example, from 40% to 55%, from 42% to 55%, from 44% to 55%, from 46% to 55%, from 48% to 55%, or from 50% to 55%).

In some embodiments, the proportion by volume of protein particles in the liquid composition having a particle size of from 1 to 5 μm does not substantially increase following a secondary heat treatment (such as sterilisation and/or pasteurisation). For example, in some embodiments, following a secondary heat treatment, the proportion by volume of protein particles in the liquid composition having a particle size of from 1 to 5 μm is less than 130% of that of the composition prior to the secondary heat treatment, such as less than 125%, less than 120%, less than 115%, less than 110%, less than 105%, less than 103%, less than 102%, or less than 101% of that of the composition prior to the secondary heat treatment.

In some embodiments, less than 60% by volume of the protein particles in the heat-treated liquid composition have a particle size of from 1 to 5 μm, such as less than about 58%, less than about 56%, less than about 55%, less than about 54%, less than about 53%, less than about 52%, less than about 51%, less than about 50%, less than about 49%, less than about 48%, less than about 47%, less than about 46%, or about 45%, and useful ranges may be selected between any of these values (for example, from 45% to 60%, from 45% to 58%, from 45% to 56%, from 45% to 54%, or from 45% to 52%).

In some embodiments, the proportion by volume of protein particles in the liquid composition having a particle size of at least 5 μm does not substantially increase following a secondary heat treatment (such as sterilisation and/or pasteurisation). For example, in some embodiments, following a secondary heat treatment, the proportion by volume of protein particles in the liquid composition having a particle size of at least 5 μm is less than 130% of that of the composition prior to the secondary heat treatment, such as less than 125%, less than 120%, less than 115%, less than 110%, less than 105%, less than 103%, less than 102%, or less than 101% of that of the composition prior to the secondary heat treatment.

In some embodiments, less than about 10% by volume of the protein particles in the heat-treated liquid composition have a particle size of at least 5 μm, such as less than about 9%, less than about 8%, less than about 7%, less than about 6%, less than about 5%, less than about 4%, less than about 3%, less than about 2%, less than about 1%, or about 0%, and useful ranges may be selected between any of these values (for example, from 0% to 10%, from 0% to 8%, from 0% to 6%, from 0% to 4%, from 0% to 2%, from 1% to 10%, from 1% to 8%, from 1% to 6%, from 1% to 4%, or from 1% to 2%).

In some embodiments, the D [4,3] of the protein particles in the liquid composition does not substantially increase following a secondary heat treatment (such as sterilisation and/or pasteurisation). In some embodiments, following a secondary heat treatment, the D [4,3] is less than 170% of that of the composition prior to the secondary heat treatment, such as less than 160%, less than 150%, less than 140%, less than 130%, less than 120%, less than 110%, less than 105%, less than 103%, less than 102%, or less than 101% of that of the composition prior to the secondary heat treatment.

In some embodiments, the D [4,3] of the protein particles in the heat-treated liquid composition is less than about 20 μm, such as less than about 15, less than about 10, less than about 5, less than about 4, less than about 3, less than about 2.5, less than about 2, less than about 1.5, less than about 1 μm, or about 0.9 μm.

In some embodiments, the viscosity of the heat-treated liquid composition is less than about 400 mPa·s at 20 °C at a shear rate of 100 s⁻¹, such as less than about 350, less than about 300, less than about 250, less than about 200, less than about 180, less than about 160, less than about 140, less than about 120, less than about 100, less than about 80, less than about 60, less than about 50, less than about 40, less than about 30, less than about 20, less than about 15, less than about 10, or less than about 5 mPa·s at 20 °C at a shear rate of 100 s⁻¹.

In some embodiments, when the liquid composition is a neutral high protein beverage, the viscosity is less than about 200 mPa·s at 20 °C at a shear rate of 100 s⁻¹. In some embodiments, when the liquid composition is an acidic high protein beverage (for example a drinking yoghurt), the viscosity is less than about 400 mPa·s at 20 °C at a shear rate of 100 s⁻¹.

In some embodiments, following a secondary heat treatment (such as sterilisation and/or pasteurisation), the proportion of protein particles in the liquid composition having a particle size of 0.1 to 1 μm is at least about 80% of that of the composition prior to the secondary heat treatment, and the proportion of protein particles in the liquid composition having a particle size of 1 to 5 μm is less than about 105% of that of the composition prior to the secondary heat treatment. In some embodiments, at least about 40% of the protein particles in the heat treated liquid composition have a particle size of 0.1 to 1 μm, less than about 55% of the protein particles in the heat treated liquid composition have a particle size of 1 to 5 μm, and less than about 3% of the protein particles in the heat treated liquid composition have a particle size of at least 5 μm.

The lethal effect of high temperatures on microorganisms is dependent on both temperature and holding time, and the reduction in time required to kill the same number of microorganisms as temperature is increased is well known. The time taken to reduce initial microbial numbers, at a specified temperature, by a particular amount, is commonly referred to as an “F value.” The F₀ value is the equivalent time in minutes for the specified temperature that gives the same thermal lethality as at 121 °C. As is known in the relevant art, acidic products generally require a lower F₀ value to achieve commercial sterility than products processed at neutral pH.

In certain embodiments, the liquid composition includes non-whey and/or non-dairy protein in addition to the heat stable protein composition of the invention. Exemplary sources of non-whey protein include, but are not limited to, skim milk powder (SMP), whole milk powder, milk protein concentrate (MPC), milk protein isolate (MPI), and micellar casein concentrate (MCC). As another example, additional casein may be included in the form of sodium caseinate or potassium caseinate or calcium caseinate or magnesium caseinate to the liquid composition.

In certain embodiments, the liquid composition comprises one or more, two or more, or three or more non-dairy proteins. Suitable non-dairy proteins for inclusion in the liquid composition include algal proteins, fungal proteins (e.g., mycoprotein), plant proteins, and animal proteins, and hydrolysed forms thereof. In some such embodiments, the liquid composition comprises soy protein, rice protein, and/or pea protein.

Additionally, the liquid composition may comprise whey protein from two or more sources. For example, the liquid composition may comprise a mixture of WPC and WPI, one or both of which has been heat-denatured. As another example, the liquid composition may comprise a mixture of WPCs made in different ways or having different properties.

In addition to the methods disclosed herein, exemplary methods for preparing a heat-denatured whey protein composition suitable for use in a liquid composition are provided in PCT International Application PCT/NZ2007/000059 (published as WO2007/108709) and PCT/NZ2010/000072 (published as WO2010/120199) and PCT International Application PCT/IB2012/056103 (published as WO2013/065014), each incorporated by reference herein in their entirety.

In certain embodiments, one or more of the protein ingredients, for example the heat stable protein composition, or the liquid composition may be treated to reduce lactose content. In some such embodiments, the heat stable protein composition or the liquid composition is treated with an enzyme such as beta-galactosidase or subjected to filtration to remove lactose. Suitable enzyme treatments and filtration protocols to reduce lactose content will be apparent to those skilled in the art.

In certain embodiments, the liquid composition comprises less than about 10% (w/w) lactose by weight of the liquid composition, such as less than about 9%, less than about 8%, less than about 7%, less than about 6%, less than about 5%, less than about 4%, less than about 3%, less than about 2%, less than about 1%, or less than about 0.1% (w/w) lactose, and useful ranges may be selected between any of these values (for example, from 0.1% to 10%, from 0.1% to 8%, from 0.1% to 6%, from 0.1% to 4%, from 0.1% to 2%, 1% to 10%, from 1% to 8%, from 1% to 6%, from 1% to 4%, or from 1% to 2%). In some such embodiments, the liquid composition has a lactose content of at most 10% (w/w) by weight of the liquid composition, at most 8% (w/w), at most 6% (w/w), or at most 4% (w/w).

In a further aspect, the invention provides a method for preparing a liquid composition, the method comprising contacting:
a) a heat stable protein composition of the invention, and
b) one or more additional ingredients.

In various embodiments, the one or more additional ingredients comprise one or more additional sources of protein, one or more lipids, one or more carbohydrates, one or more vitamins, one or more minerals, one or more food additives comprising one or more emulsifiers, one or more food additives comprising one or more stabilisers, or any combination of any two or more of these. In some embodiments, the mineral component comprises a monovalent cation, and/or a divalent metal cation.

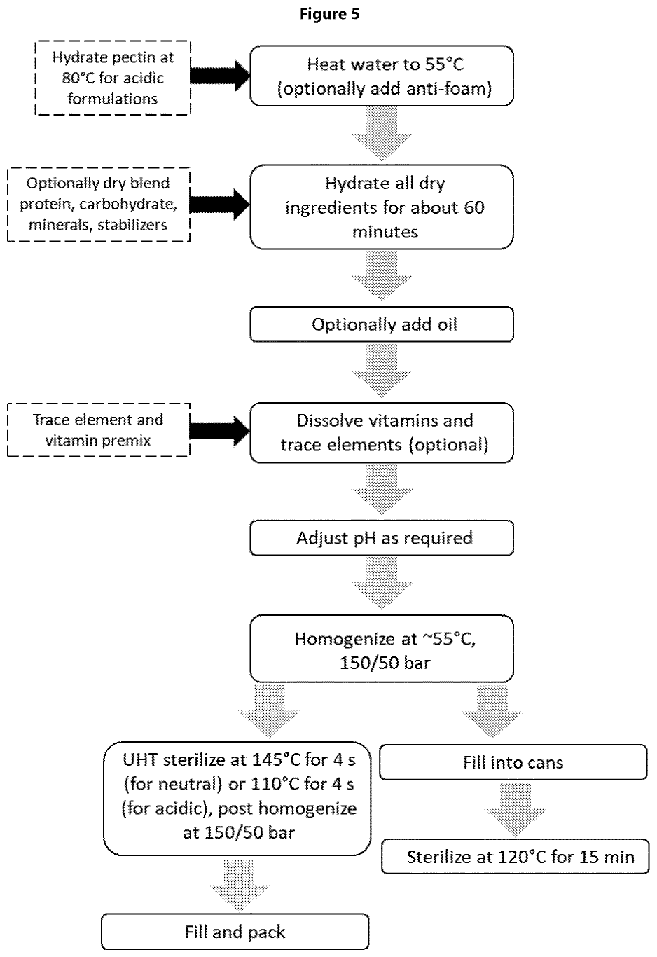

As will be apparent, the exact method will vary depending on the high protein beverage to be produced. Such variations will be immediately apparent to the skilled person. One exemplary method of producing a high protein beverage is shown in FIG. 5.

As shown in FIG. 5, in one embodiment (for example, when the liquid composition is an acidic beverage) the one or more additional ingredients may comprise pectin. In such embodiments, the method may comprise hydrating the pectin in an aqueous solution at an elevated temperature for a time period sufficient to hydrate the pectin. In one embodiment, the method comprises hydrating pectin at about 80 °C.

In some embodiments, the one or more additional ingredients comprises dry ingredients (such as powders), for example a protein component, a carbohydrate component, a mineral component, an acidity regulator, a stabiliser, and/or an emulsifier. In some embodiments, the heat stable protein composition is a dry ingredient (such as a powder). In some embodiments, the method comprises contacting and/or blending two more dry ingredients, such as the heat stable protein composition and one or more additional ingredients.

In some embodiments, the heat stable protein composition and/or the one or more dry ingredients are hydrated in an aqueous solution, for example water. In some embodiments, the method comprises a rehydration step, comprising hydrating the heat stable protein composition and/or the one or more dry ingredients in an aqueous solution (for example, water) for a time period sufficient to hydrate the heat stable protein composition and/or the one or more dry ingredients.

The requirements of rehydrating dry ingredients will vary depending on the dry ingredients used. Such variations will be immediately apparent to the skilled person. In some embodiments, the heat stable protein composition and/or the one or more dry ingredients are hydrated for about 60 minutes. The rehydration step may also comprise stirring the aqueous solution, which will assist the rehydrating. In some embodiments, antifoam is used to reduce or prevent foaming during the rehydration step. For example, in some embodiments, the rehydration step comprises adding antifoam to the aqueous solution before or during rehydration.

In some embodiments, the aqueous solution used to hydrate the heat stable protein composition and/or the one or more dry ingredients is at an elevated temperature, for example about 55 °C. In some embodiments, the rehydration step comprises heating an aqueous solution (such as water) to an elevated temperature (for example, about 55 °C) prior to or during the rehydrating.

One or more lipid components may be added before, during, or after a rehydration step. Alternatively, if a rehydration step is not used (for example, when the heat stable protein composition is in the form of an aqueous solution), one or more lipid components may be added to the heat stable protein composition.

In some embodiments, the one or more additional ingredients comprises one or more vitamins and/or one or more minerals. In some embodiments, the method comprises contacting the heat stable protein composition and a vitamin and/or a mineral. The amount of vitamins and/or minerals to be used in the liquid composition may be those typical of meal replacement products known to those skilled in the art. The micro-nutritional requirements of various sub-groups of the population are also known. The recommended daily requirements of vitamins and minerals can be specified for various population subgroups. See, e.g., Dietary Reference Intakes (DRIs): Recommended Dietary Allowances and Adequate Intakes, United States National Academy of Sciences, Institute of Medicine, Food and Nutrition Board (2010).

In some embodiments, the method comprises a pH adjustment step. In other embodiments, pH adjustment may not be required. The pH adjustment may be by adding a food-safe acid or base to achieve a desired pH. Acidity regulators may also be used to control pH. The desired pH will vary depending on the liquid composition to be produced. In one embodiment, the pH is a neutral pH (for example, from about 6.5 to about 7.5). In another embodiment, the pH is an acidic pH (for example, from about 2 to about 4.8). In one embodiment, the method comprises adjusting the pH to about 6.8, for example by adding KOH.

In some embodiments, the method comprises a shearing step. For example, the liquid composition may be sheared with ultraturrex at 7,000 rpm for 3 minutes.

In some embodiments, the method comprises a homogenisation step. For example, the liquid composition may be passed through a two-stage homogeniser once at 200/50 bar.

In some embodiments, the method comprises a cooling step. For example, the liquid composition may be cooled using an ice bath.

In some embodiments, the method comprises a secondary heat treatment step, such as a UHT step, a pasteurisation step, a sterilisation step, or a retort processing step. For example, in some embodiments the method comprises UHT treatment followed by optional post-homogenisation, followed by aseptic packaging. In one embodiment (such as for neutral compositions) the method comprises UHT treatment at about 145 °C for about 4 s. In another embodiment (such as for acidic compositions) the method comprises UHT treatment at about 110 °C for about 4 s. In other embodiments, the method comprises filling containers (such as cans) with the liquid composition, followed by sterilising. In one embodiment, the sterilisation is at about 120 °C for about 15 minutes.

Other steps for preparing and packaging a liquid composition (such as a high protein beverage) will depend on the composition to be produced and will be known to a skilled worker.

Some exemplary methods for producing liquid compositions in the form of neutral and acidic high protein beverages are described below.

### Neutral High Protein Beverages

The required protein, carbohydrates, minerals and stabilizers are dry blended and hydrated in water heated to 55 °C for 60 minutes, which has anti-foam added, if required. Oil is added to the mixture. The pH is adjusted to about pH 6.8±0.1 using 5% KOH. The mixture is homogenized at 55 °C, 150/50 bar. The beverages may be sterilized in one of two ways:
(1) The homogenized mixture is filled into retort cans and heated treated at 120 °C for 15 minutes.
(2) The homogenized mixture is UHT sterilized at 145 °C for 4 seconds followed by homogenization at 150/50 bar. The product is aseptically packed.

### Acidic High Protein Beverages

The same process is followed according to that of the neutral beverages; however, a pectin solution is prepared at 80 °C and added to the water, prior to the addition of the protein, carbohydrates, minerals and stabilizers. The pH is adjusted to pH 4.0=0.1 with 15% hydrochloric acid. The UHT sterilization is performed at 110 °C for 4 seconds followed by homogenization at 150/50 bar. The product is aseptically packed.

### 9.3 Additional Ingredients

The nutritional composition, food product, and/or liquid composition of the invention may also contain one or more additional ingredients described herein. The method for preparing a nutritional composition, and/or the method for preparing a liquid composition may comprise contacting a heat stable protein composition of the invention and one or more additional ingredients described herein.

In various embodiments, the one or more additional ingredients may comprise a lipid, a carbohydrate, an additional protein, a flavour, a vitamin, a mineral, a milk product, water, a food additive, a polyol, a colour, a fruit preparation, or any combination of any two or more of these ingredients.

In various embodiments the lipid may be plant lipid or animal lipid, including dairy lipid. Plant oils are often exemplary because of their ease of formulation and lower saturated fatty acid content. Exemplary plant oils include canola (rapeseed) oil, corn oil, sunflower oil, olive, soybean oil, hydrogenated vegetable oil, or sn-2 palmitoyl triacylglycerols.

In various embodiments, the dairy lipid may be cream, butter, ghee, anhydrous milk fat (AMF), buttermilk, a hydrolysate thereof, combinations of hydrolysed and/or non-hydrolysed compositions, a hard milk fat extract from one or more stages of milk fat fractionation (including hard (H), soft-hard (SH), and soft-soft-hard (SSH) extracts), a soft milk fat extract from one or more stages of milk fat fractionation (including soft(S), soft-soft (SS), and soft-soft-soft (SSS) extracts), a combination of hard milk fat extracts, a combination of soft milk fat extracts, a combination of hard milk fat extracts and soft milk fat extracts, or any combination of any two or more thereof. These compositions may be obtained from whole milk or colostrum, and any derivatives of whole milk or colostrum, including cream, cultured cream, and whey cream (milk lipid obtained from whey, including acid whey or cheese whey, preferably cheese whey). Cultured cream is cream from whole milk or colostrum that has been fermented with acid-producing microorganisms, preferably lactic acid bacteria.

In various embodiments, the plant oil may be coconut oil, corn oil, cottonseed oil, canola oil, rapeseed oil, olive oil, palm oil, peanut oil, ground nut oil, safflower oil, sesame oil, soybean oil, sunflower oil, hazelnut oil, almond oil, cashew oil, macadamia oil, pecan oil, pistachio oil, walnut oil, oils from melon and gourd seeds, pumpkin seed oil, apricot oil, argan oil, avocado oil, flax oil, flax seed oil, grape seed oil, hemp oil, linseed oil, rice bran oil, wheat germ oil, or any combination of any two or more thereof. In some embodiments the plant oil may be hydrogenated coconut oil.

In various embodiments, the carbohydrate may comprise monosaccharides, disaccharides, oligosaccharides and polysaccharides and mixtures thereof, including glucose, maltose, trehalose, sugar, sucrose, and sucralose. A number of these are commercially available as starch, modified starch, maltodextrin (3-20 dextrose equivalents (DE)) or corn syrup for the longer chain carbohydrates (>20 DE). Non-digestible carbohydrates may also be included, for example, fructooligosaccharides, inulin, and galactooligosaccharides. In various embodiments the carbohydrate may comprise a polyol, for example, a polyol selected from the group comprising glycerol (glycerine), maltitol, erythritol, sorbitol and any combination of any two or more thereof.

In various embodiments, the additional protein may be a dairy protein or a non-dairy protein. In various embodiments, the additional protein may be milk, whey, casein, caseinate, egg, egg white, egg yolk, vegetable, plant, alfalfa, clover, pea, bean, kidney bean, soybean, lentil, lupin, cocoa, carob, nut, peanut, rye, cereal, whole wheat, rice, hemp, wheat gluten, fungal, or algal protein, a protein concentrate thereof, a protein isolate thereof, a hydrolysate thereof, or any combination of any two or more thereof.

In various embodiments, the additional protein may be a protein powder. The protein powder may be of any of the protein sources described. The protein powder may be non-agglomerated, agglomerated, roll-compacted, freeze dried, drum dried, spray dried or foam spray dried protein powder. In various embodiments the protein powder comprises a whey protein concentrate (WPC) or a whey protein isolate (WPI). In various embodiments the protein powder comprises whole milk powder, skim milk powder, or a milk protein concentrate (MPC).

In various embodiments the one or more additional ingredients may comprise flavours, including but not limited to sweeteners, natural flavours, nature identical flavours, artificial flavours, herbs, and spices.

In various embodiments the one or more additional ingredients may comprise nuts and/or seeds.

In various embodiments the one or more additional ingredients may comprise vitamins. Vitamins may include fat-soluble or water-soluble vitamins. Suitable vitamins include but are not limited to vitamin C, vitamin A, vitamin E, vitamin B12, vitamin K, riboflavin, niacin, vitamin D, vitamin B6, folic acid, pyridoxine, thiamine, pantothenic acid, and biotin. The form of the vitamin may include salts of the vitamin, derivatives of the vitamin, compounds having the same or similar activity of a vitamin, and metabolites of a vitamin.

In various embodiments the one or more additional ingredients may comprise minerals, including, but not limited to chloride, sodium, calcium, iron, chromium, copper, iodine, zinc, magnesium, phosphorus, potassium and chromium. Suitable forms of any of the foregoing minerals include soluble mineral salts, slightly soluble mineral salts, insoluble mineral salts, chelated minerals, mineral complexes, non-reactive minerals such as carbonyl minerals, and reduced minerals, and combinations thereof.

In various embodiments the nutritional composition, food product, and/or liquid composition may comprise at least about 10, 20, 25, 30, 40, 50, 60, 70, 75, 80, 90 or 100% of the recommended daily intake (RDI) of vitamins and minerals as set by European (FSMP) or USDRA regulations in, for example, a 100 mL, 250 mL, 500 mL or 1 litre portion.

In various embodiments, the one or more additional ingredients may comprise a dairy product. In some embodiments, the dairy product may be selected from powdered milk protein concentrate, skim milk powder, whole milk powder, whey protein concentrate, whey protein isolate, caseinates, milk fat, cream, rennet casein, cheese, or cream cheese. In various embodiments, the one or more additional ingredients may comprise other milk products such as powdered milk protein concentrate, skim milk powder, whole milk powder, whey protein concentrate, whey protein isolate, caseinates, milk fat, or cream.

In various embodiments the one or more additional ingredients may comprise a food or beverage additive, including but not limited to rennet, antifoams, stabilisers, emulsifiers, preservatives, fibre, probiotics, antioxidants, flavour enhancers, colours, acidity regulators, or emulsifying salts. In various embodiments the one or more additional ingredients may comprise a food additive, including but not limited to rennet, antifoams, stabilisers, emulsifiers, preservatives, fibre, probiotics, antioxidants, flavour enhancers, colours, acidity regulators. A useful preservative is potassium sorbate in acidified products.

In various embodiments, the one or more additional ingredients may comprise a polyol. In some embodiments, the polyol may be selected from arabitol, erythritol, glycerol, isomalt, isomaltulose, lactitol, maltitol, mannitol, sorbitol, xylitol, and hydrogenated starch hydrolysates.

In certain embodiments, the one or more additional ingredients may comprise a stabilizer or an emulsifier. Suitable emulsifiers include lecithins, mono and diglycerides, polyglycerol esters, milk phospholipids, citric acid esters (CITREMs), polysorbate 60, glyceryl monostearate, and DATEMs. Suitable stabilizers include, but are not limited to, carrageenan, gellan gum, pectin, guar gum, locust bean gum, carboxymethyl cellulose, alginates, agar, oat gum, tragacanth gum, acacia gum, xanthan gum, karaya gum, tara gum, starch, and modified starch and microcrystalline cellulose, gelatin, or combinations thereof. Those of skill in the art will recognize that many different gum forms, in addition to those listed above are suitable for use in the liquid compositions disclosed herein.

In various embodiments, the one or more additional ingredients may comprise salts or acidity regulators, such as sodium chloride, potassium chloride, ethylenediaminetetraacetic (EDTA) salts, lactic acid, acetic acid, citric acid, potassium hydroxide, phosphate salts such as dipotassium phosphate and disodium phosphate, citrate salts such as disodium citrate, dipotassium citrate, or tripotassium citrate. In some embodiments the citrate salts may be selected from the group comprising disodium citrate, dipotassium citrate, tripotassium citrate and trisodium citrate. In some embodiments the phosphate salts may be selected from the group consisting of dipotassium phosphate, disodium phosphate, orthophosphates, diphosphates, and polyphosphates.

In various embodiments, the one or more additional ingredients may comprise a source of amino acids, amino acid precursors or amino acid metabolites or any combination of any two or more thereof, preferably free amino acids, amino acid precursors or amino acid metabolites.

Methods of contacting the heat stable protein composition and the one or more additional ingredients to produce a nutritional composition, food product, or liquid composition will depend on the nutritional composition, food product, or liquid composition to be formed. These methods will be known to a skilled worker.

The following non-limiting examples are provided to illustrate the present invention and in no way limit the scope thereof.

### EXAMPLES

### 1. Example 1—General Procedures

### 1.1 Measurement of Denaturation

The method used herein relies on HPLC (Elgar et al (2000) J Chromatography A, 878, 183-196). Two samples are used—one sample of the denatured composition to be tested (the denatured sample), and one sample of the composition prior to the heat-treatment step (the undenatured sample).

Step 1: remove casein and insoluble whey protein aggregates. The pH of both samples is reduced to 4.6 to precipitate the caseins. The samples are then centrifuged to remove the precipitated caseins and the insoluble whey protein aggregates.

Step 2: reverse phase HPLC. The residual soluble denaturable whey protein in the denatured sample is determined using reversed phase HPLC (Elgar et al., 2000) as 2 (bovine serum albumin+α-lactalbumin+β-lactoglobulin+lactoferrin+immunoglobulins) and can be expressed as grams protein/100 grams total solids.

The total soluble denaturable whey protein in the undenatured sample is determined by the same method, using the undenatured sample from Step 1.

Step 3: calculate % denatured whey protein. First, the values for residual soluble denaturable whey protein and total soluble denaturable whey protein are normalised using the relative levels of glycomacropeptide (GMP) in each sample, to account for any potential changes in concentration during processing. If the samples do not contain GMP (for example, when the whey protein source is acid whey), the values are instead normalised using the total solids content of the two samples prior to step 1.

The total amount of denatured whey protein as a percentage of the total amount of denaturable whey protein can then be calculated using the following formula:

$$( 1 - \frac{( residual soluble denaturable whey protein )}{( total soluble denaturable whey protein )} ) \times 100.$$

### 1.2 Measurement of Covalent Aggregation of β-Lactoglobulin

The percentage by weight of β-lactoglobulin that is covalently aggregated was determined using the 2100 Agilent Bioanalyzer System (Agilent, USA), which utilizes microfluidic SDS electrophoretic technology, using the method of Anema (2009, International Dairy J, 19 (4), 198-204), with modifications as described below.

The proportions of residual non-denatured β-lactoglobulin, covalently aggregated β-lactoglobulin and non-covalently aggregated β-lactoglobulin were determined by dissolving the denatured whey protein composition in buffers that dissociate different bonds and determining the change in soluble protein after a centrifugation step.

To determine the residual non-denatured β-lactoglobulin content, samples before and after heating were dissolved or diluted to 10% (w/w) protein in water. A 300 mg aliquot of this sample was dissolved in 1.2 mL acetate buffer (0.2M, pH 4.35).

To determine the non-covalently aggregated β-lactoglobulin content, a 0.1M phosphate buffer (pH=6.7) prepared from 0.0281 mol of NaH₂PO₄·2H₂O and 0.0218 mol of Na₂HPO₄; urea was added to a final concentration of 8M and sodium dodecyl sulfate (SDS) was added to a final concentration of 2% (w/v). A 300 mg aliquot of sample was dissolved in 1.2 mL of the phosphate/urea/SDS buffer (PSU buffer).

The prepared samples were shaken using a test tube shaker for 1 hour.

The samples were centrifuged at 20,000×g for 1 hour at 25 °C.

A 100 μL aliquot of the supernatant was carefully taken from each sample and prepared according to Anema and run using the Bioanalyzer System. The area under the curve for the β-lactoglobulin peaks was automatically integrated by the software (2100 Bioanalyzer Expert Software package). The peak area was used to calculate the type of bonding based on the sample preparation as described above.

Acetate buffer used in this experiment precipitates any denatured whey protein or residual casein in solution. The unheated sample is expected to have low levels of denatured protein. The heated sample is expected to have high levels of denaturation. The residual non-denatured β-lactoglobulin in the heated sample was calculated as a percentage of the soluble β-lactoglobulin in the unheated (feedstock) solution.

$$Residual non - denatured β LG = \frac{\begin{matrix}Peak area soluble β LG in heated \\ solution in pH 4.35 acetic buffer\end{matrix}}{\begin{matrix}Peak area soluble β LG in \\ unheated ( feedstock ) solution\end{matrix}} \times 100 \%$$

Urea is able to break hydrophobic bonds and SDS is able to break non-covalent bonds such as hydrogen and hydrophobic bonds. The heated sample that is added to the phosphate buffer containing urea and SDS will cause the solubilization of non-covalent bonds and therefore allows the calculation of the non-covalently aggregated β-lactoglobulin as a percentage of the soluble β-lactoglobulin in the unheated (feedstock) solution, taking into account the residual non-denatured β-lactoglobulin.

$$Non - covalently aggregated β LG = \frac{\begin{matrix}( Peak area of soluble β LG in PSU buffer ) - \\ \begin{matrix}( Peak area soluble β LG in heated \\ solution in pH 4.35 acetic buffer )\end{matrix}\end{matrix}}{Peak area soluble β LG in unheated ( feedstock ) solution} \times 100 \%$$

The covalently aggregated β-lactoglobulin as a percentage of the soluble β-lactoglobulin in the unheated (feedstock) solution can therefore be calculated as the remainder of the β-lactoglobulin that was not solubilized by the PSU buffer, after subtracting the residual non-denatured β-lactoglobulin.

Covalently aggregated β LG=100%−Residual non-denatured β LG−Non-covalently aggregated β LG

### 1.3 Measurement of Particle Size

When the composition to be measured was a powder, it was reconstituted in water before measuring particle size. A 10% (w/w) protein concentration solution was prepared by combining the protein composition and deionised water at ambient temperature (~20 °C) using a magnetic stirrer. The protein powder(s) were gradually added into the water under a vortex mixing condition with a care to avoid any foaming. Once all the powder was dispersed, hydration was continued for 30 minutes with continuous stirring. The solutions were homogenized at 150/50 bar and tested for particle size as described below.

Particle size was determined using a Malvern Mastersizer 2000 or 3000 (Malvern Instruments Ltd, Worcs, UK). Deionized water (refractive index (RI)=1.33) was used to disperse a sample and the refractive index of 1.46 is used for the dispersed phase. Drops of sample were added until obscuration values of 10-15% were obtained. Particle sizes are reported as the percentage (%) of particles, by volume, that are in the size range being tested. The % volume of particles in a defined size range was determined by taking the sum of the relevant size classes of the raw data reported by the Mastersizer software.

### 1.4 Primary Particle Growth Test

Protein compositions, or liquid compositions comprising the protein compositions, can be tested for heat stability by a primary particle growth test as described herein.

A primary particle growth test comprises subjecting an aqueous solution comprising the protein composition to a secondary heat treatment at an elevated temperature for a holding time, then immediately cooling the solution. This can be achieved, for example, by preparing an aqueous solution comprising the protein composition at pH 6.8, placing a 5 mL aliquot in an 8 mL glass vial, and placing the vial in a rocking unit that is inserted into a silicone oil bath at an elevated temperature for a holding time, and then immediately cooling in ice water. Particle size analysis is carried out as described in section 1.3. Alternatively, or additionally, other parameters can be measured such as viscosity.

In some embodiments, the aqueous solution comprising the protein composition has a protein content of 10%, 14%, 15%, 18%, or 20% (w/w). In one embodiment, the elevated temperature is 90 °C and the holding time is 10 minutes. In another embodiment, the elevated temperature is 120 °C and the holding time is 4 minutes. In another embodiment, the elevated temperature is 140 °C and the holding time is 2 minutes.

For example, in some embodiments the primary particle growth test comprises heating a 14% (w/w) protein content aqueous solution comprising the protein composition to 120 °C for 10 minutes. In some embodiments, the primary particle growth test comprises heating a 10%, 15%, or 18% (w/w) protein content aqueous solution comprising the protein composition to 90 °C for 10 minutes. In some embodiments, the primary particle growth test comprises heating a 10%, 15%, or 18% (w/w) protein content aqueous solution comprising the protein composition to 120 °C for 4 minutes. In some embodiments, the primary particle growth test comprises heating a 10% or 15% (w/w) protein content aqueous solution comprising the protein composition to 140 °C for 2 minutes.

### 1.5 Measurement of Heat Coagulation Time (HCT)

The heat coagulation time (HCT) can be determined by the following method.

A 10% protein (w/w) solution is prepared from a powdered protein composition using ambient temperature (~20 °C) deionized water with a magnetic stirrer. The powder is gradually added into the water under a vortex mixing condition with a care to avoid any foaming. Once all the powder has been dispersed, hydration is continued for 30 minutes with continuous stirring. The solution is homogenized at 150/50 bar. A 1 ml aliquot of protein solution (at pH 6.8) is placed in a glass vial which is clipped onto a platform and subjected to secondary heat treatment by placing in a silicone oil bath thermostatically controlled at 140 °C with a gentle rocking rate.

The length of time, in minutes, that elapses between placing the container in the oil bath and onset of visible aggregate formation is defined as the heat coagulation time (Singh H & Creamer LK (1992), Determination of heat stability, In: Advanced Dairy Chemistry e.d. Fox PF Elsevier).

### 1.6 Measurement of Viscosity

The viscosity of the compositions was measured at 20 °C using a rheometer such as an Anton Paar instrument using a cup and bob assembly at a shear rate of 10 0 s⁻¹, unless otherwise indicated. It will be appreciated that other methods to measure or estimate viscosity are well known in the art and may be employed where appropriate.

### 2. Example 2

This example describes the preparation of the heat stable protein compositions of the invention.

### 2.1 Preparation of Protein Compositions

Cheese whey protein concentrate powder was used as the whey protein source and sodium caseinate powder was used as the casein source. The composition of these ingredients is shown in Table 1.

TABLE 1
Ingredient powder compositions.

| | Cheese whey protein | Sodium caseinate |
|---|---|---|
| Composition | concentrate (WPC) | (NaCas) |
| Total solids (g/100 g) | 96 | 96 |
| Protein (g/100 g) | 79.5 | 93 |
| Moisture (g/100 g) | 4.0 | 4.0 |
| Whey protein (g/100 g) | 79.5 | — |
| β-lg (%) | 50.4 | — |
| GMP (%) | 23.1 | — |
| α-lac (%) | 18.3 | — |
| PP5 (%) | 3.1 | — |
| IgG (%) | 3.7 | — |
| BSA (%) | 1.5 | — |
| Casein protein (g/100 g) | — | 93 |
| αs1-casein (%) | — | 40 |
| αs2-casein (%) | — | 10 |
| β-casein (%) | — | 40 |
| κ-casein (%) | — | 10 |

The cheese whey protein concentrate and sodium caseinate ingredient powders were recombined as detailed in Table 2 by adding the powders to water at 50 °C and stirring slowly for 60 minutes using an overhead stirrer to produce an aqueous composition comprising 30% total solids by weight.

The compositions were homogenized at 200/50 bar to fully hydrate the powders. Samples 3, 4, 5 and 6 were diluted to 10% total solids or 20.15% total solids after homogenization, as shown in Table 2.

The pH was adjusted using NaOH, KOH or HCl to a final pH shown in Table 2.

The composition was then heated using a two-stage heater. The feed composition was pre-heated to 55 °C in the first stage (tube length 28.8 4 m, tube internal diameter 4.5 mm) and subsequently heated to 85 °C in the second stage (15.84 m, tube internal diameter 4.5 mm), followed by a holding tube (capillary tubes were located either side of the holding tube). The feed flow rate was 0.5 L/min and the residence time of the product in the second stage at the target temperature of 85 °C was 10-15 seconds. The maximum pressure that the heater was run at was 42 bar.

Sample 1 was a composition of the invention. Samples 2-6 were comparative compositions. Sample 2 lacks casein.

TABLE 2
Compositions during primary heat treatment.

| Sample | 1 | 2 | 3 | 4 | 5 | 6 |
|---|---|---|---|---|---|---|
| Water (g/100 g) | 68.75 | 67.53 | 89.5 | 89.5 | 79 | 79 |
| Cheese WPC 80 powder (g/100 g) | 26.3 | 32.47 | 8.6 | 8.6 | 17.33 | 17.33 |
| NaCas powder (g/100 g) | 4.98 | 0 | 1.8 | 1.8 | 3.66 | 3.66 |
| Total solid during primary heat | 30 | 31.2 | 10 | 10 | 20.15 | 20.15 |
| treatment (g/100 g) | | | | | | |
| Total protein (g/100 g) | 25.5 | 25.8 | 8.52 | 8.52 | 17.2 | 17.2 |
| β-Ig (g/100 g) | 10.53 | 13.0 | 3.45 | 3.45 | 6.94 | 6.94 |
| GMP (g/100 g) | 4.8 | 5.95 | 1.58 | 1.58 | 3.18 | 3.18 |
| Total whey protein (g/100 g) | 20.9 | 25.8 | 6.84 | 6.84 | 13.78 | 13.78 |
| Total casein (g/100 g) | 4.63 | 0 | 1.68 | 1.68 | 3.4 | 3.4 |
| β-Ig:casein | 2.27:1 | N/A | 2.05:1 | 2.05:1 | 2.04:1 | 2.04:1 |
| Whey:casein | 4.51:1 | N/A | 4.07:1 | 4.07:1 | 4.05:1 | 4.05:1 |
| PH | 6.3 | 6.26 | 6.0 | 7.0 | 6.0 | 7.0 |

The properties of the protein compositions are provided in Table 3 below.

TABLE 3
Properties of protein compositions.

| Sample | 1 | 2 | 3 | 4 | 5 | 6 |
|---|---|---|---|---|---|---|
| Appearance after primary | Homogenous, | Homogenous, | Homogenous, | Homogenous, | Homogenous, | Gelled |
| heat treatment | fluid liquid | fluid liquid | fluid liquid | fluid liquid | fluid liquid | upon |
| | | | | | | storage |
| Total denatured whey | 76.4 | 88.7 | 63.5 | 54 | 65.6 | 52.3 |
| protein relative to total | | | | | | |
| denaturable whey protein | | | | | | |
| (%)¹ | | | | | | |
| % by volume of protein | 72 | 0 | 39 | 60 | 67 | 0 |
| particles having a particle | | | | | | |
| size of 0.1-1 μm² | | | | | | |
| % by volume of protein | 27 | 70.7 | 11 | 1.1 | 16 | 34.15 |
| particles having a particle | | | | | | |
| size of 1-5 μm² | | | | | | |
| % by volume of protein | 1 | 29.3 | 3.6 | 9.4 | 2.0 | 65.8 |
| particles having a particle | | | | | | |
| size of >5 μm² | | | | | | |
| D [4,3] | 1.07 | 5.85 | 0.80 | 1.53 | 0.85 | 9.04 |
| % by weight of denatured β- | 65 | 61 | 21 | 6 | 19 | 3 |
| Ig that is covalently | | | | | | |
| aggregated³ | | | | | | |
| % by weight of denatured β- | 33 | 37 | 78 | 76 | 79 | 75 |
| Ig that is non-covalently | | | | | | |
| aggregated³ | | | | | | |

¹measured according to Example 1.1.
²measured according to Example 1.3.
³measured according to Example 1.2.

### 2.2 Preparation of Dried Powders

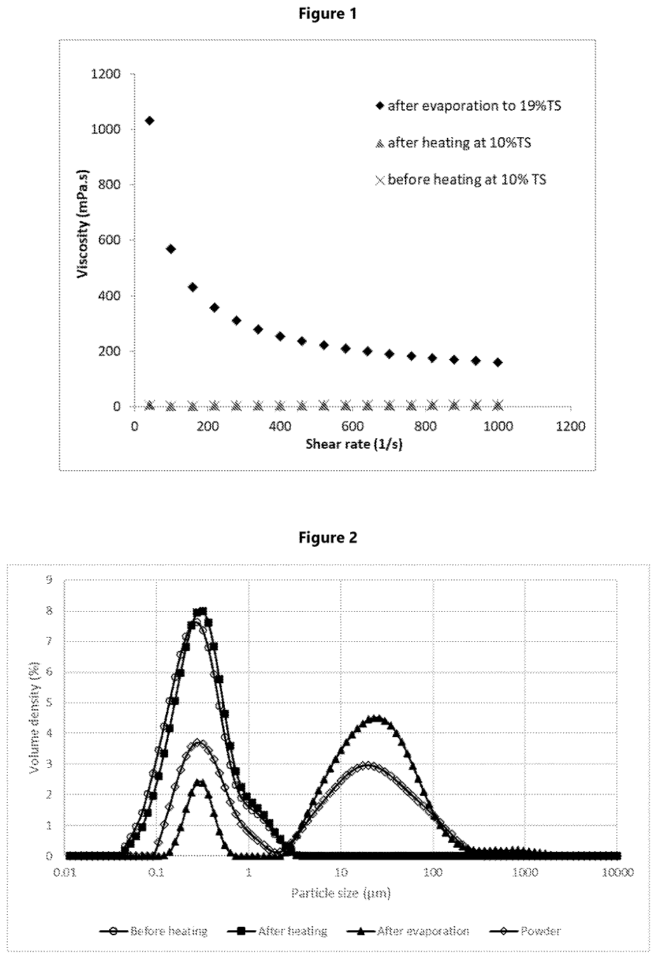

The protein composition of sample 4 was further concentrated through evaporation, in preparation for subsequent spray drying (a dispersion at 10% total solids needs to be concentrated prior to spray drying as the efficiency during drying would be too low). Although sample 4 had formed particles largely less than 1 micron, when it was concentrated through evaporation there was a significant increase in the viscosity of the evaporated product and fouling in the evaporator was observed. The product that was obtained after the evaporation only reached 19% total solids. The viscosity of the evaporated product is shown in FIG. 1. Although the product had a low viscosity (with a Newtonian flow) after initial heating at 10% total solids, the viscosity increased significantly after evaporation.

The evaporated product was spray-dried to a powder and reconstituted in water at 10% total solids. There was a significant change in the particle size distribution as shown in FIG. 2. This indicates that the particle dispersion prepared with casein at low total solids (and therefore at low whey protein concentration) is not stable to further processing such as evaporation or a secondary heat treatment.

Since evaporation caused an undesirable change in the particle properties of sample 4, all heated solutions were freeze-dried into powder instead without concentrating.

### 2.3 Heat Stability Testing of Liquid Compositions Comprising the Protein Compositions

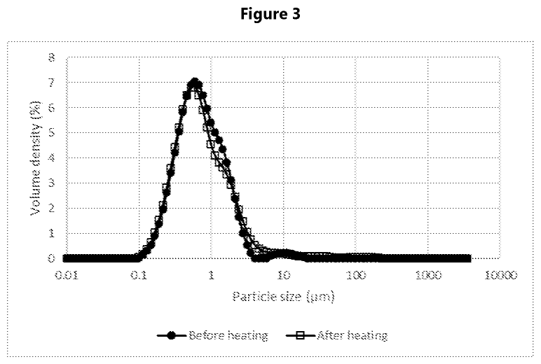

Freeze dried powders were recombined to provide 14% w/w liquid compositions by reconstituting the powders in water and adjusting the pH to 6.8. 5 ml samples were subjected to a primary particle growth test as described in section 1.4 of Example 1. Briefly, the solutions were placed in glass vials and subjected to secondary heat treatment by immersion in an oil bath set at 120 °C for 10 mins. The vials were then taken out and immediately cooled to room temperature using ice water. The particle size and viscosity of the heated product was measured. The results are shown in Table 4. The particle size distribution for sample 1 before and after heating is shown in FIG. 3. The particle size distribution of sample 1 was substantially monomodal and exhibited substantially no change after a secondary heat treatment.

TABLE 4
Heat stability of liquid compositions comprising the protein compositions.

| Sample | 1 | 2 | 3 | 4 | 5 | 6 |
|---|---|---|---|---|---|---|
| Appearance | Fluid, | Fluid, | Thick | Paste- | Thick | Paste- |
| after | homogenous | homogenous | liquid | like | liquid | like |
| reconstituting | liquid | liquid | | texture | | texture |
| Appearance | Fluid, | Gelled | Gelled | Gelled | Gelled | Gelled |
| after | homogenous | | | | | |
| secondary | liquid | | | | | |
| heat | | | | | | |
| treatment | | | | | | |
| Viscosity | 25 mPa · s | N/A | N/A | N/A | N/A | N/A |
| after | | | | | | |
| secondary | | | | | | |
| heat | | | | | | |
| treatment | | | | | | |
| (@100 s−1) | | | | | | |
| D [4,3] | 0.3 | N/A | N/A | N/A | N/A | N/A |
| before | | | | | | |
| secondary | | | | | | |
| heat | | | | | | |
| treatment | | | | | | |
| D [4,3] after | 0.3 | N/A | N/A | N/A | N/A | N/A |
| secondary | | | | | | |
| heat | | | | | | |
| treatment | | | | | | |

Various β-lactoglobulin: casein ratios were also tested. A ratio of 1.2:1 with 9 g/100 g β-lactoglobulin resulted in a composition that was too thick for further processing. A ratio of 1.6:1 with 9 g/100 g β-lactoglobulin produced a composition providing similar properties to sample 1.

### 3. Example 3

This example describes the use of the heat stable protein composition of the invention in heat-treated, high protein liquid compositions.

### 3.1 Preparation of Heat Stable Protein Compositions

Heat stable protein compositions were prepared as described for sample 1 in section 2.1, except that a total solids content of 32% w/w was used. The composition during primary heat treatment is shown in Table 5.

TABLE 5
Protein composition during primary heat treatment.

| Sample | 7 |
|---|---|
| Water (g/100 g) | 66.8 |
| Cheese WPC 80 powder (g/100 g) | 28.87 |
| NaCas powder (g/100 g) | 4.31 |
| Total solids (g/100 g) | 32 |
| Total protein (g/100 g) | 27.3 |
| β-lg (g/100 g) | 11.7 |
| GMP (g/100 g) | 5.4 |
| Total whey protein (g/100 g) | 23.3 |
| Total casein (g/100 g) | 4.0 |
| β-lg:casein | 2.93:1 |
| Whey:casein | 5.83:1 |
| pH | 6.30 |

A description of the properties of the heat stable protein composition is provided in Table 6 below.

TABLE 6
Properties of the heat stable protein composition
when recombined at 24.5% total solids.

| Sample | 7 |
|---|---|
| Appearance after primary heat treatment | Homogenous, fluid liquid |
| Total denatured whey protein relative to | 78 |
| total denaturable whey protein (%)¹ | |
| % by volume of protein particles having a | 54.4 |
| particle size of 0.1-1 μm² | |
| % by volume of protein particles having a | 34.8 |
| particle size of 1-5 μm² | |
| % by volume of protein particles having a | 0 |
| particle size of >5 μm² | |
| D [4, 3] | 0.74 |
| % by weight of denatured β-lg that is | 56 |
| covalently aggregated³ | |
| % by weight of denatured β-lg that is | 40 |
| non-covalently aggregated³ | |

¹measured according to Example 1.1.
²measured according to Example 1.3.
³measured according to Example 1.2.

### 3.2 Preparation of High Protein Liquid Compositions

The heat stable protein composition (sample 7) was diluted with water to achieve liquid compositions with final protein contents of 10, 15 and 18% protein (w/w). These were adjusted to a final pH of 6.82±0.02 using a mixture of NaOH/KOH and subjected to a primary particle growth test as described in section 1.4 of Example 1. Briefly, 5 mL samples of the liquid compositions were placed in glass vials and subjected to secondary heat treatment by immersion into an oil bath at 90 °C for 10 minutes, 120 °C for 4 minutes, or 140 °C for 2 minutes. The solutions were removed from the oil bath immediately after the allotted time and cooled with ice water. The viscosity and particle size distribution were measured.

The protein content, heat treatment conditions and properties of the high protein liquid compositions are shown in Table 7.

TABLE 7
Properties of high protein liquid compositions after secondary heat treatment.

| Sample | 7a | 7b | 7c | 7d | 7e | 7f | 7g | 7h |
|---|---|---|---|---|---|---|---|---|
| Total protein (g/100 g) | 10 | 15 | 18 | 10 | 15 | 18 | 10 | 15 |
| Secondary heat treatment | 90 °C/10 | 90 °C/10 | 90 °C/10 | 120 °C/4 | 120 °C/4 | 120 °C/4 | 140 °C/2 | 140 °C/2 |
| | min | min | min | min | min | min | min | min |
| % by volume of protein particles | 53.0 | 51.0 | 50.1 | 53.4 | 50.4 | 47.8 | 53.1 | 51.5 |
| having a particle size of 0.1-1 μm¹ | | | | | | | | |
| % by volume of protein particles | 47.0 | 49.0 | 49.9 | 46.6 | 49.6 | 49.7 | 46.9 | 48.6 |
| having a particle size of 1-5 μm¹ | | | | | | | | |
| % by volume of protein particles | 0 | 0 | 0 | 0 | 0 | 2.5 | 0 | 0 |
| having a particle size of >5 μm¹ | | | | | | | | |
| D [4,3] | 0.94 | 0.98 | 1.00 | 0.93 | 0.99 | 5.37 | 0.94 | 0.97 |
| Viscosity (mPa · s) at 100 s⁻¹ | 4.74 | 15.0 | 49.5 | 4.71 | 14.3 | 45.2 | 4.73 | 14.6 |

¹measured according to Example 1.3.

### 4. Example 4

This example describes the preparation of a heat stable protein composition of the invention using a mixture of cheese whey retentate and mineral acid whey protein concentrate, and the use of that heat stable protein composition in heat treated high protein liquid nutritional compositions.

### 4.1 Preparation of Heat Stable Protein Compositions

The heat stable protein composition was prepared according to the process set out in FIG. 4, as summarised below.

The heat stable protein composition was prepared by first mixing cheese whey retentate (60% w/w of protein in final composition), mineral acid whey retentate (24% w/w of protein in final composition) and a recombined sodium caseinate solution (16% w/w of protein in final composition) to a total solids concentration of about 17% (w/w). Table 8 details the protein composition of the mineral acid whey protein concentrate.

TABLE 8
Mineral acid WPC retentate

| | Mineral acid whey |
|---|---|
| Composition | protein concentrate |
| Protein (g/100 g) | 81.0 |
| β-lg (%)* | 66.8 |
| GMP (%)* | 3.0 |
| α-lac (%)* | 15.0 |
| PP5 (%)* | 6.1 |
| IgG (%)* | 6.0 |
| BSA (%)* | 2.2 |
| Lactoferrin (%)* | 0.9 |

*% of total protein.

The pH was adjusted to pH 6.30. The mixture was evaporated to 28% total solids and subjected to a primary heat treatment as follows. The protein composition was preheated to 55 °C using a heat exchanger heated by hot water. Subsequently, the protein composition was denatured using the method described in WO2010120199. The protein composition was fed into two identical single tube high pressure steam heated shell and tube heat exchangers in series using a high-pressure pump with delivery pressure of 250-350 bar at high enough flowrate to achieve Reynolds number of ≥2100. The concentrate exited the first high pressure heater at 71-73 °C and exited the second high pressure heater at 80-8 5 °C.

A summary of the protein composition during primary heat treatment is provided in Table 9.

TABLE 9
Protein composition during primary heat treatment

| Sample | 8 |
|---|---|
| Total solids (g/100 g) | 28 |
| Total protein (g/100 g) | 22.9 |
| β-lg (g/100 g) | 10.5 |
| GMP (g/100 g) | 3.1 |
| Total whey protein (g/100 g) | 19.2 |
| Total casein (g/100 g) | 3.7 |
| β-lg:casein | 2.84:1 |
| Whey:casein | 5.19:1 |
| pH | 6.30 |

After emerging from the second heater, the heat stable protein composition passed through a holding tube and a pipe to the nozzle bank at the top of spray drier with similar tube specification as high-pressure heaters which implies the turbulent flow was maintained. The length of holding tube was selected in a manner that in conjunction with the pipe to nozzle bank provides extra 20 s of residence time for heated stream before being spray dried with <1 °C temperature loss across the pipe from exit of second high pressure heater up to the nozzle bank. This means no additional mechanical shear process was used during heating and post the heater-reactor system and prior to spray drying.

At the spray drier, the heat stable protein composition was delivered to a bank of three nozzles and was atomized into a droplet spray at a pressure greater than 160 bar. An inlet hot air temperature of ~200 °C and an outlet chamber temperature of 70-80 °C were used. The powder was further dried and then cooled in vibrating fluidized bed prior to sifting and packaging of materials to produce a powder with <5% moisture. The types and sizes of particles in the powder are shown in Table 10.

TABLE 10
Properties of the heat stable protein composition

| Sample | 8 |
|---|---|
| Total denatured whey protein relative to total | 87.50 |
| denaturable whey protein (%)¹ | |
| % by volume of protein particles having a | 52.4 |
| particle size of 0.1-1 μm² | |
| % by volume of protein particles having | 45.2 |
| a particle size of 1-5 μm² | |
| % by volume of protein particles having | 2.36 |
| a particle size of >5 μm² | |
| D [4, 3] | 1.5 |
| % by weight of denatured β-lg that is covalently | 40 |
| aggregated³ | |
| % by weight of denatured β-lg that is non-covalently | 48 |
| aggregated³ | |
| Powder composition | |
| Total protein (as is) g/100 g | 81.60 |
| Ash g/100 g | 2.87 |

¹measured according to Example 1.1.
²measured according to Example 1.3.
³measured according to Example 1.2.

### 4.2 Heat Coagulation Time (HCT)

The HCT of a 10% protein (w/w) solution prepared from the powdered heat stable protein composition was determined according to section 1.5 of Example 1, using a secondary heat treatment temperature of 14 0 °C. The HCT was determined to be 3 minutes and 22 seconds.

### 4.3 Preparation of High Protein Beverages

The heat stable protein composition was used to prepare a liquid nutritional composition in the form of a heat-treated high protein beverage formulation with final protein content of 14% protein (w/w). The beverage was prepared according to the formulation in Table 11. The beverage was prepared according to the process set out in FIG. 5, as described below. The final composition is shown in Table 12.

TABLE 11
Formulation of an exemplary high protein beverage
comprising the heat stable protein composition

| Ingredients (% w/w) | Beverage 1 |
|---|---|
| Water | 81.7 |
| Sample 8 | 17.1 |
| Cellulose gum | 0.2 |
| Tri-potassium citrate monohydrate | 0.06 |
| Sodium chloride | 0.06 |
| Lecithin | 0.05 |
| Canola oil | 0.045 |
| Gellan gum | 0.04 |
| Potassium hydroxide (5%) | 0.8 |
| Antifoam | 0.01 |

TABLE 12
Nutritional composition of high protein liquid
beverage containing sample 8 powder

| Ingredients (% w/w) | Beverage 1 |
|---|---|
| Total solids | 16.9 |
| Energy Kcal/100 g | 0.7 |
| Protein | 14.0 |
| Fat | 0.88 |
| Carbohydrates | 1.14 |
| Ash | 0.56 |

The procedure was as follows:
1. All dry ingredients i.e. sodium chloride, tri-potassium citrate monohydrate, gellan and cellulose gum, and lecithin, were pre weighed and pre-blended.
2. Reverse osmosis water required for each batch was weighed out into a stainless-steel vessel and heated to 55 °C with overhead stirrers in water bath.
3. 80% of the antifoam was added to the water.
4. The heat stable protein composition was added to the water.
5. Dry-blended powder was added slowly, over a period of 15 minutes, into the stainless-steel vessels ensuring that a vortex was created with the stirring.
6. Oil was added to each vessel.
7. The mixing speed was adjusted to achieve good mixing but no vortex.
8. The mixture was then stirred at 55 °C±2 °C for 60 minutes.
9. The mixture was sheared with ultraturrex at 7,000 rpm for 3 minutes.
10. Water was added if required to the beverage to obtain a final weight of 20 kg.
11. The remaining 20% of the antifoam was added.
12. The product weight was checked and adjusted with water if required.
13 The mixture was heated to 55 °C±1 °C and passed through a two-stage homogeniser once at 200/50 bar (250 total).
14. The product was cooled to ~20 °C±5 °C for pH measurement by placing the vessel in ice water.
15. pH was adjusted to 6.8±0.1 if necessary, using 5% KOH.
16. The mixture was UHT processed at about 146 °C for 6.5 sec and then packed aseptically. The preheating temperature was between 85 °C and achieved using a plate heat exchanger. The product was held for 30 seconds at this temperature. The final heat treatment temperature was then raised to 146 °C using direct steam injection (direct heat treatment). The first stage of cooling was to 80 °C using a flash vessel and the final cooling was to about 20-25 °C using a plate heat exchanger.
17. The product was immediately packed at about 24-25 °C into 200 mL PET bottles and capped.
18. The product was then stored at about 2 5 °C.

The high protein beverage was successfully subjected to secondary heat treatment (UHT treatment) with no evidence of fouling, indicating that the protein composition is stable in a heat-treated high protein beverage. The beverage had a viscosity of 28 mPa·s at 100 s⁻¹ after UHT treatment. The beverage had acceptable sensory properties, with milky flavour, and smooth texture without any grittiness or powderiness.

### 5. Example 5

This example describes the preparation of an exemplary high protein drinking yogurt comprising sample 8 powder using the method according to the invention.

The heat stable protein composition (sample 8), and skim milk powder (SMP) were recombined in 10 °C water to produce an aqueous composition comprising 15% by weight protein, 12% protein from the heat stable protein composition. For the batch 9.2% (w/w) SMP was recombined and topped up with 15% (w/w) heat stable protein composition. The balance to 100% was achieved with additional water. The mixture was stirred for 60 minutes. The recombined mixture was preheated to 60 °C and homogenised at 150/50 bar. The mixture was heated for 6 minutes 40 seconds at 95 °C to thermalise the mixture. The mixture was cooled to 43 °C, and 0.02% (w/w) bacterial culture was added for fermentation. The inoculated mixture was allowed to ferment overnight at 43 °C to allow the pH to reach less than pH 4.6. The yoghurt was cooled to 20 °C and smoothed. The yoghurt was packed and cooled to less than 4 °C and stored at 4 °C for subsequent testing.

The high protein drinking yoghurt was successfully manufactured. The high protein drinking yoghurt had a viscosity of 181 mPa·s at 50 s^{-1 7} days after manufacture. The proportion by volume of protein particles having a particle size of from 0.1 to 1 μm was 41.5%, the proportion by volume of protein particles having a particle size of from 1 to 5 μm was 49.5% and proportion by volume of protein particles having a particle size greater than 5 μm was 9%. The drinking yogurt made using the inventive composition showed significantly lower sedimentation compared to the high protein drinking yoghurt that was produced with the same method and protein content, using traditional microparticulated whey.

### 6. Example 6

This example describes the preparation of heat stable protein compositions using a peroxidase enzyme and oxidising agent. Two methods are described for producing heat stable protein compositions (method A and method B), and a comparative method for producing whey protein compositions without casein (method C).

### 6.1 Stock Solutions

A stock solution of whey protein concentrate at 31.8% (w/w) total solids is prepared by reconstituting uncoloured dairy cheese whey protein concentrate (having 96.00% w/w total solids, 79.5% w/w total protein, and 41.7% w/w β-lactoglobulin) in water at 50 °C and holding for 0.5 hour.

A stock solution of sodium caseinate at 11.4% (w/w) total solids is prepared by reconstituting sodium caseinate powder (having 93% w/w protein) in water at 55 °C and holding for 1 hour.

### 6.2 Method A

Method A describes the preparation of a heat stable protein composition by combining whey protein concentrate and sodium caseinate, treating with peroxidase and peroxide, and heat-treating:
1. The stock solutions of whey protein concentrate and sodium caseinate are combined at an appropriate ratio to form a combined solution with a β-lactoglobulin to casein weight ratio of 2.7:1.
2. The solution is diluted with water to achieve a total protein content of 21.5 g/100 g, a whey protein content of 18.0 g/100 g, and a β-lactoglobulin 9.46 g/100 g.
3. The solution is homogenised at 200/50 bar.
4. The pH is adjusted to pH 6.2 using a 50:50 blend of KOH and NaOH at 1M concentration.
5. The protein solution is divided into two samples, sample 1 and sample 2. Sample 1 is treated with a peroxidase enzyme and oxidising agent as described in steps a-α below; sample 2 is not treated with a peroxidase enzyme and oxidising agent.
   a. A peroxidase enzyme derived from Aspergillus niger (MaxiBright®) is added to sample 1 according to the manufacturer's directions, and mixed at 150 rpm at 4 °C.
   b. Hydrogen peroxide is added to sample 1 to achieve a concentration of 75 ppm (equivalent to 0.375 mol H₂O₂/mol of β-lactoglobulin), slowly to avoid enzyme inhibition.
   c. Sample 1 is tested using a peroxide indicator test strip (Merck MQuant® Peroxide test strip, sensitive to 0.5-25 mg/L H₂O₂) to verify that it contains no residual peroxide.
6. Both samples are pre-heated to 55 °C in a scraped surface heat exchanger.
7. Both samples are then heated to 85 °C in a steam-heated tubular heat exchanger at a flow rate of 0.5 L/min.
8. Both samples are held at 85 °C for 10-15 seconds in a holding tube.
9. The samples are cooled down and collected.

### 6.3 Method B

Method B describes the preparation of a heat stable protein composition by treating whey protein concentrate with peroxidase and peroxide, combining with sodium caseinate, and heat-treating:
1. A whey protein concentrate stock solution with 31.8% (w/w) total solids and a protein content of 26.3/100 g is used directly.
2. The solution is homogenised at 200/50 bar.
3. The pH is adjusted to pH 6.2 using a 50:50 blend of KOH and NaOH at 1M concentration.
4. A peroxidase enzyme derived from Aspergillus niger (MaxiBright®) is added to the solution according to the manufacturer's directions, and mixed at 150 rpm at 4 °C.
5. Hydrogen peroxide is added to achieve a concentration of 75 ppm (equivalent to 0.375 mol H₂O₂/mol of β-lactoglobulin protein) slowly to avoid enzyme inhibition.
6. The solution is tested using a peroxide indicator test strip (Merck MQuant® Peroxide test strip, sensitive to 0.5-25 mg/L H₂O₂) to verify that it contains no residual peroxide.
7. The whey solution is combined with the stock solution of sodium caseinate at an appropriate ratio to form a combined solution with a total protein content of 21.5 g/100 g, a whey protein content of 18.0 g/100 g, a β-lactoglobulin content of 9.46 g/100 g, and α-lactoglobulin to casein weight ratio of 2.7:1.
8. The combined solution is heat treated as described in steps 6-9 of Method A to produce a heat stable protein composition (sample 3).

### 6.4 Method C

Method C describes the preparation of comparative samples lacking casein:
1. A whey protein concentrate stock solution with 31.8% (w/w) total solids is diluted with water to achieve a total protein content of 21.5 g/100 g.
2. The whey protein solution is treated as described in steps 3-9 of Method A to produce compositions subjected to peroxidase enzyme and oxidising agent treatment (sample 4) and not subjected to peroxidase enzyme and oxidising agent treatment (sample 5).

Methods A-C are repeated using a β-lactoglobulin to casein weight ratio of 5:1 to produce samples 6-10.

### 6.5 Properties of Samples

The whey protein denaturation, covalent aggregation of β-lactoglobulin, particle size distribution, HCT, and viscosity of samples 1-5 are assessed as described in Example 1.

Samples 1-3 and 6-8 comprise denaturable whey protein of which at least about 65% (w/w) is denatured; at least about 40% (w/w) of total β-lactoglobulin in samples 1-3 is covalently aggregated; and samples 1-3 and 6-8 comprise protein particles wherein at least about 40% by volume of the protein particles have a particle size of less than 1 μm, and at least a portion of the protein particles comprise co-aggregates of denatured whey protein and casein.

Aqueous compositions comprising an amount of the samples sufficient to provide a total protein content of 15% w/w are prepared and subjected to secondary heat treatment at 120 °C for 4 minutes.

Following secondary heat treatment of aqueous compositions comprising samples 1-3 and 6-8, at least about 40% by volume of the protein particles in the aqueous composition have a particle size of from 0.1 to 1 μm; less than about 60% by volume of the protein particles in the aqueous composition have a particle size of from 1 to 5 μm; less than about 10% by volume of the protein particles in the aqueous composition have a particle size of at least 5 μm; the D [4,3] of the protein particles in the aqueous composition is less than about 5 μm; and/or the viscosity of the aqueous composition is less than about 100 mPa·s at 100 s⁻¹. The aqueous compositions comprising samples 1-3 and 6-8 show no visible sign of gelation. The HCT at 140 °C of an aqueous composition comprising an amount of samples 1-3 and 6-8 sufficient to provide a total protein content of 10% w/w is at least about 60 seconds.

Samples 5 and 10 do not have the high heat stability seen in samples 1-3 and 6-8, namely the resistance to increases in particle size and viscosity upon secondary heat treatment.

Any documents referred to herein including, but not limited to, patents, patent applications, journal articles, books, and the like, are incorporated herein by reference in their entirety. Any section headings used herein are for organizational purposes only and are not to be construed as limiting the subject matter described.

Although the invention has been described by way of example and with reference to particular embodiments, it is to be understood that modifications and/or improvements may be made without departing from the scope or spirit of the invention.

### 7. Example 7

Heat stable protein compositions and comparative samples were prepared as described in Example 6. Samples 1 and 2 were prepared by Method A as described in section 6.2; sample 3 was prepared by Method B as described in section 6.3; and comparative samples 4 and 5 were prepared by Method C as described in section 6.4.

A summary of the samples is shown in Table 12 and their properties in Table 13.

TABLE 12
Summary of samples.

| | Sample | | | | |
|---|---|---|---|---|---|
| Treatment | 1 | 2 | 3 | 4 | 5 |
| Whey protein concentrate | ✓ | ✓ | ✓ | ✓ | ✓ |
| Sodium caseinate | ✓ | ✓ | ✓ | | |
| Oxidising agent treatment | ✓ | | ✓ | ✓ | |
| Caseinate added before oxidising agent treatment | ✓ | | | | |
| Caseinate added after oxidising agent treatment | | | ✓ | | |

TABLE 13
Properties of protein compositions.

| | Sample | | | | |
|---|---|---|---|---|---|
| Property | 1 | 2 | 3 | 4 | 5 |
| Total denatured whey protein relative to total | 75 | 74 | 73 | 84 | 85 |
| denaturable whey protein (%)^{a} | | | | | |
| % by weight of denatured β-lg that is covalently | 69 | 62 | 57 | 61 | 79 |
| aggregated^{b} | | | | | |
| % by volume of protein particles having a particle | 78.4 | 71.3 | 90.2 | 78.0 | 65.7 |
| size of <1 μm^{c} | | | | | |
| % by volume of protein particles having a particle | 13.8 | 21.6 | 4.4 | 17.1 | 27.1 |
| size of 1-5 μm^{c} | | | | | |
| % by volume of protein particles having a particle | 7.8 | 7.3 | 5.4 | 5.1 | 7.3 |
| size of >5 μm^{c} | | | | | |
| D [4, 3] | 1.47 | 1.49 | 1.01 | 1.14 | 1.5 |
| HCT (s)^{d} | 1051 | 439 | 917 | 925 | 98 |

^{a}measured according to Example 1.1.
^{b}measured according to Example 1.2.
^{c}measured according to Example 1.3.
^{d}Heat coagulation time in seconds of a 10% protein solution at 140 °C

### 5 INDUSTRIAL APPLICATION

The heat stable protein compositions described herein are useful for the production of nutritional compositions with small particles (e.g. less than 1 μm) and good heat stability. Such nutritional compositions are resistant to gelation, sedimentation, aggregation, and to increases in particle size and viscosity when subjected to a secondary heat treatment such as UHT.

1. A heat stable protein composition comprising:
whey protein and casein, wherein the composition comprises β-lactoglobulin and casein in a weight ratio of from about 1.6:1 to about 5:1,
the whey protein comprises denaturable whey protein of which at least about 65% (w/w) is denatured,
at least about 40% (w/w) of total β-lactoglobulin in the composition is covalently aggregated, and
the composition comprises protein particles, wherein
at least about 40% by volume of the protein particles have a particle size of less than 1 μm, and
at least a portion of the protein particles comprise co-aggregates of denatured whey protein and casein.

2. The heat stable protein composition of claim 1, wherein the composition comprises:
a. non-micellar casein; and/or
b.
i. β-lactoglobulin and casein in a weight ratio of from about 1.8:1 to about 5:1, from about 1.8:1 to about 4:1, from about 2:1 to about 4:1, or from about 2:1 to about 3.5:1; and/or
ii. total whey protein and casein in a weight ratio of at least about 3:1, from about 3:1 to about 10:1, from about 4:1 to about 8:1, or from about 4.5:1 to about 6:1.

3. The heat stable protein composition of claim 1, wherein:
(I)
a. at least about 40% by volume of the protein particles have a particle size of from 0.1 to 1 μm,
b. less than about 55% by volume of the protein particles have a particle size of from 1 to 5 μm,
c. less than about 5% by volume of the protein particles have a particle size of at least 5 μm, or
d. any combination of any two or more of (a) to (c); and/or
(II)
a. at least about 70% w/w, or from about 80% to about 90% w/w, of total protein in the composition is whey protein,
b. at least about 35% w/w, or from about 40% to about 60% w/w, of total protein in the composition is β-lactoglobulin,
c. from about 10% to about 20% w/w of total protein in the composition is casein, or
d. any combination of any two or more of (a) to (c).

4. The heat stable protein composition of claim 1, wherein at least about 50% by weight of total β-lactoglobulin is covalently aggregated, or at least about 60% by weight of total β-lactoglobulin is covalently aggregated.

5.-6. (canceled)

7. The heat stable protein composition of claim 1, wherein an aqueous composition comprising an amount of the heat stable protein composition sufficient to provide a total protein content of 15% w/w, that has been subjected to a secondary heat treatment at 120 °C for 4 minutes, possesses any of the following properties:
a. at least about 40% by volume, at least about 45% by volume, or at least about 50% by volume of the protein particles in the aqueous composition have a particle size of from 0.1 to 1 μm,
b. less than about 60% by volume, less than about 55% by volume, or less than about 50% by volume of the protein particles in the aqueous composition have a particle size of from 1 to 5 μm,
c. less than about 10% by volume, less than about 5% by volume less than about 2% by volume, or less than about 1% by volume of the protein particles in the aqueous composition have a particle size of at least 5 μm,
d. the D [4,3] of the protein particles in the aqueous composition is less than about 5 μm, less than about 4, less than about 3, more preferably less than about 2, or less than about 1 μm,
e. the viscosity of the aqueous composition is less than about 100 mPa·s at 100 s⁻¹, than about 40 mPa·s at 100 s⁻¹, less than about 30 mPa·s at 100 s⁻¹, or less than about 20 mPa·s at 100 s⁻¹, or
f. any combination of any two or more of (a) to (e).

8. A method for preparing a heat stable protein composition, the method comprising:
a. providing an aqueous composition having a pH of from 5.5 to 6.8, comprising
i. a total whey protein content of at least about 18 g/100 g of the aqueous composition,
ii. a total β-lactoglobulin content of at least about 9 g/100 g of the aqueous composition,
iii. a total protein content of at least about 20 g/100 g of the aqueous composition, and
iv. β-lactoglobulin and casein in a weight ratio from about 1.6:1 to about 5:1, and
b. heat treating the aqueous composition to at least about 70 °C, for a time sufficient to allow protein denaturation to occur; the heat-treating comprising heating the aqueous composition under high shear stress to provide the heat stable protein composition.

9. The method of claim 8, wherein the method comprises contacting a whey protein source and a casein protein source to provide the aqueous composition of step a).

10. The method of claim 9, wherein
a. the whey protein source comprises, or consists of, a whey protein concentrate (WPC), a whey protein isolate (WPI), or a combination thereof; and/or
b. the casein protein source comprises, or consists of, a caseinate, a calcium-depleted milk protein concentrate (MPC), a total milk protein (TMP), or a combination of any two or more of these.

11. (canceled)

12. The method of claim 8, wherein the method further comprises
a. contacting the whey protein source with an oxidising agent in combination with a catalyst; and/or
b. contacting the aqueous composition with an oxidising agent in combination with a catalyst.

13. (canceled)

14. The method of claim 12, wherein
a. the oxidising agent is hydrogen peroxide or benzoyl peroxide and/or the catalyst is a peroxidase enzyme; and/or
b. the oxidising agent is present in an amount less than 300 ppm or less than 200 ppm, or the mole ratio of the oxidising agent to β-lactoglobulin is less than 2, less than 1, or from about 0.1 to about 0.85.

15.-16. (canceled)

17. The method of claim 8, wherein the method further comprises:
a. homogenising the aqueous composition;
b. adjusting the pH of the aqueous composition to a pH of from 5.5 to 6.8; and/or
c. concentrating the aqueous composition prior to step b).

18.-20. (canceled)

21. The method of claim 8, wherein
a. less than about 10% (w/w) of total denaturable whey protein in the aqueous composition prior to step b) is denatured, or less than about 5% (w/w);
b. the heat stable protein composition comprises protein particles of which at least about 40% by volume have a particle size of less than 1 μm;
c. step b) comprises heat treating the solution to a temperature of from about 70 °C to about 150 °C; and/or
d. the heat stable protein composition comprises at least about 70% w/w whey protein relative to total protein in the composition, and less than about 30% w/w casein relative to total protein in the composition
e. the heat stable protein composition is not subjected to a mechanical shear process prior to drying other than where liquid is converted into droplets to facilitate drying; and/or
f. step b) comprises heating the solution:
i. under conditions of turbulent flow with a Reynold's number of at least about 2000,
ii. under conditions of high wall shear with a wall shear rate of at least about 1000 s⁻¹, or
iii. under conditions of mechanical shear; or
g. any combination of any two or more of a) to f).

22.-29. (canceled)

30. A nutritional composition comprising the heat stable protein composition of claim 1.

31. The nutritional composition of claim 30, wherein
a. the nutritional composition comprises at least about 6%, at least about 8%, at least about 10%, at least about 12%, at least about 14%, at least about 16%, at least about 18%, or at least about 20% (w/w) total protein on a dry basis;
b. the nutritional composition comprises at least about 6%, at least about 8%, at least about 10%, at least about 12%, at least about 14%, at least about 16%, at least about 18%, or at least about 20% (w/w) denatured whey protein on a dry basis;
c. at least about 50% (w/w), or at least about 60% (w/w) of total protein in the nutritional composition is denatured whey protein;
d. at least about 50% (w/w) of total protein in the nutritional composition is provided by the heat stable protein composition;
e. at least about 40% by volume of the protein particles in the nutritional composition have a particle size of from 0.1 to 1 μm, or at least about 45%, or at least about 50%;
f. less than about 60% by volume of the protein particles in the nutritional composition have a particle size of from 1 to 5 μm, or less than about 55%, or less than about 50%;
g. less than about 10% by volume of the protein particles in the nutritional composition have a particle size of at least 5 μm, or less than about 5%, or less than about 1%; or
h. any combination of any two or more of a) to g).

32.-39. (canceled)

40. The nutritional composition of claim 30, wherein the nutritional composition is a food product selected from the group consisting of a baked food product, a bar, a set or stirred yoghurt, a set gel, and a semi-solid food product.

41. The nutritional composition of claim 40, wherein the food product is
a. a set yoghurt or a stirred yoghurt, that:
i. comprises about 6% to about 20% (w/v) total protein; and/or
ii. exhibits reduced volume weighted mean particle size compared to a control yoghurt product having the same ingredient composition and the same total protein content except that the control yoghurt product does not comprise a heat stable protein composition of claim 1;
b. a heat-treated, high protein set gel, comprising at least about 10% (w/v) or at least about 15% (w/v) total protein; or
c. a heat-treated, high protein semi-solid food product, comprising at least about 10% (w/v) or at least about 15% (w/v) total protein.

42.-45. (canceled)

46. The nutritional composition of claim 30, wherein the nutritional composition is a liquid composition, or a liquid nutritional composition.

47. The nutritional composition of claim 46, wherein the liquid composition
a. has a viscosity of less than about 400 mPa·s measured at 100 s⁻¹ at 20 °C, or less than about 200 mPa·s;
b. exhibits less than about 10% sedimentation following storage at a temperature of from about 20 °C to about 25 °C for at least 6 weeks, or less than about 10% sedimentation following storage at a temperature of from about 20 °C to about 25 °C for at least 3 months;
c. has an energy density of at least about 0.5 kcal/mL, or at least about 1.0, at least about 1.5, or at least about 2.0 kcal/mL;
d. has a viscosity of less than about 400 mPa·s, less than about 300 mPa·s, less than about 200 mPa·s, or less than about 100 mPa·s measured at 100 s⁻¹ at 20 °C; or
e. any combination of any two or more of a) to d).

48.-50. (canceled)

51. The nutritional composition of any one of claim 46, wherein the liquid composition is a heat-treated, shelf-stable liquid nutritional composition.

52. The nutritional composition of claim 46, wherein the liquid composition is
a. high protein beverage, or a medical food;
b. a drinking yoghurt;
c. an acidic beverage; or
d. a neutral beverage.

53.-63. (canceled)
